(19) United States
(12) Patent Application Publication
(10) Pub. No.: US 2025/0175294 A1
(43) Pub. Date: May 29, 2025

(54) MULTI-DIMENSIONAL CHANNEL MEASUREMENT RESOURCE CONFIGURATION

(71) Applicant: QUALCOMM INCORPORATED, San Diego, CA (US)

(72) Inventors: Qiaoyu Li, Beijing (CN); Mahmoud Taherzadeh Boroujeni, San Diego, CA (US); Hamed Pezeshki, San Diego, CA (US); Tao Luo, San Diego, CA (US)

(21) Appl. No.: 18/729,480

(22) PCT Filed: Apr. 2, 2022
(86) PCT No.: PCT/CN2022/085000

§ 371 Date: Jul. 16, 2024

(51) Int. Cl. H04L 5/00

(52) U.S. Cl. CPC H04L 5/0048; H04L 5/0091

(57) ABSTRACT

Methods, systems, and devices for wireless communications are described. In some systems, a first network entity and a second network entity may exchange multi-dimensional channel measurement resource information. The second network entity may transmit control signaling to the first network entity to indicate a channel measurement resource set including channel measurement resources associated with multiple dimensions. The channel measurement resources may be indexed according to a first set of indices in a first dimension and a second set of indices in a second dimension. Alternatively, the first network entity may map the channel measurement resources to the first set of indices and the second set of indices. Each index may indicate dimensional information in the respective dimension. The first network entity may select a receive beam to receive a reference signal via one of the channel measurement resources based on the dimensional information associated with the channel measurement resource.

### CROSS REFERENCE

The present application is a 371 national stage filing of International PCT Application No. PCT/CN2022/085000 by Li et al. entitled “MULTI-DIMENSIONAL CHANNEL MEASUREMENT RESOURCE CONFIGURATION,” filed Apr. 2, 2022, which is assigned to the assignee hereof, and which is expressly incorporated by reference in its entirety herein.

### FIELD OF TECHNOLOGY

The following relates to wireless communications, including multi-dimensional channel measurement resource configuration.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

In some systems, a UE and a network entity may perform a beam management procedure to determine a beam pair for subsequent communications between the devices. During the beam management procedure, the network entity may transmit a series of signals to the UE using a set of directional transmit beams and the UE may receive the series of signals from the network entity using a set of directional receive beams. The UE may measure a signal strength of each signals in the series and select a directional receive beam whose associated reference signal has the highest signal strength. In addition, during the beam management procedure, the UE may also estimate the channel by performing beamformed channel measurements for all possible beam pairs between the UE and the network entity.

### SUMMARY

The described techniques relate to improved methods, systems, devices, and apparatuses that support multi-dimensional channel measurement resource configuration. For example, the described techniques provide for control signaling that configures a channel measurement resource set and indicates multi-dimensional beam information for each channel measurement resource within the set. A first network entity and a second network entity may perform a beam management procedure to determine a beam pair to use for subsequent communications. The first and second network entities may represent examples of user equipments (UEs), base stations, other network nodes, or any combination thereof. To perform the beam management procedure, the second network entity may transmit reference signals to the first network entity using a set of directional beams. The reference signals may be transmitted via a set of resources, which may be referred to as a channel measurement resource set.

As described herein, the second network entity may transmit, to the first network entity and prior to performing the beam management procedure, control signaling that configures the channel measurement resource set. Each channel measurement resource in the set may be associated with two or more dimensions, such as any combination of an azimuth dimension, and elevation dimension, a time dimension, and a distance dimension, among other dimensions. In some aspects, the channel measurement resources in the set may be indexed according to a first set of indices in a first dimension, a second set of indices in a second dimension, one or more other sets of indices in other dimensions, or any combination thereof. Additionally, or alternatively, the first network entity may map the channel measurement resources to the respective sets of indices in the respective dimensions based on one or more parameters. The parameters may indicate a quantity of indices in each dimension.

For each channel measurement resource, a respective first index of the first set of indices may indicate respective first dimensional information in the first dimension, a respective second index of the second set of indices may indicate respective second dimensional information in the second dimension, and so forth. In some aspects, at least one of the first or second dimensional information may correspond to a direction of a transmit beam within one or more spatial dimensions associated with the respective channel measurement resource. The first network entity and the second network entity may select receive and transmit beams, respectively, based on the dimensional information indicated via the control signaling. The first and second network entities may exchange reference signals via the channel measurement resources using the selected beams as part of the beam management procedure.

A method is described. The method may include receiving control signaling that indicates a channel measurement resource set including a set of multiple channel measurement resources each indexed according to at least a set of multiple first indices associated with a first dimension and a set of multiple second indices associated with a second dimension different than the first dimension. In some aspects, for each channel measurement resource of the set of multiple channel measurement resources, a respective first index of the set of multiple first indices may indicate respective first dimensional information associated with the channel measurement resource in the first dimension and a respective second index of the set of multiple second indices may indicate respective second dimensional information associated with the channel measurement resource in the second dimension. In some aspects, at least one of the respective first dimensional information and the respective second dimensional information may indicate a direction of a transmit beam within one or more spatial dimensions associated with the channel measurement resource. The method may include selecting a receive beam to receive a reference signal transmitted on at least one of the set of multiple channel measurement resources, selection of the receive beam based on the respective first dimensional information and the respective second dimensional information associated with at least one of the set of multiple channel measurement resources, and receiving the reference signal using the receive beam.

An apparatus is described. The apparatus may include a processor, memory coupled with the processor, and instructions stored in the memory. The instructions may be executable by the processor to cause the apparatus to receive control signaling that indicates a channel measurement resource set including a set of multiple channel measurement resources each indexed according to at least a set of multiple first indices associated with a first dimension and a set of multiple second indices associated with a second dimension different than the first dimension. In some aspects, for each channel measurement resource of the set of multiple channel measurement resources, a respective first index of the set of multiple first indices may indicate respective first dimensional information associated with the channel measurement resource in the first dimension and a respective second index of the set of multiple second indices may indicate respective second dimensional information associated with the channel measurement resource in the second dimension. In some aspects, at least one of the respective first dimensional information and the respective second dimensional information may indicate a direction of a transmit beam within one or more spatial dimensions associated with the channel measurement resource. The instructions may be further executable by the processor to cause the apparatus to select a receive beam to receive a reference signal transmitted on at least one of the set of multiple channel measurement resources, selection of the receive beam based on the respective first dimensional information and the respective second dimensional information associated with at least one of the set of multiple channel measurement resources, and receive the reference signal using the receive beam.

Another apparatus is described. The apparatus may include means for receiving control signaling that indicates a channel measurement resource set including a set of multiple channel measurement resources each indexed according to at least a set of multiple first indices associated with a first dimension and a set of multiple second indices associated with a second dimension different than the first dimension. In some aspects, for each channel measurement resource of the set of multiple channel measurement resources, a respective first index of the set of multiple first indices may indicate respective first dimensional information associated with the channel measurement resource in the first dimension and a respective second index of the set of multiple second indices may indicate respective second dimensional information associated with the channel measurement resource in the second dimension. In some aspects, at least one of the respective first dimensional information and the respective second dimensional information may indicate a direction of a transmit beam within one or more spatial dimensions associated with the channel measurement resource. The apparatus may further include means for selecting a receive beam to receive a reference signal transmitted on at least one of the set of multiple channel measurement resources, selection of the receive beam based on the respective first dimensional information and the respective second dimensional information associated with at least one of the set of multiple channel measurement resources, and means for receiving the reference signal using the receive beam.

A non-transitory computer-readable medium storing code is described. The code may include instructions executable by a processor to receive control signaling that indicates a channel measurement resource set including a set of multiple channel measurement resources each indexed according to at least a set of multiple first indices associated with a first dimension and a set of multiple second indices associated with a second dimension different than the first dimension. In some aspects, for each channel measurement resource of the set of multiple channel measurement resources, a respective first index of the set of multiple first indices may indicate respective first dimensional information associated with the channel measurement resource in the first dimension and a respective second index of the set of multiple second indices may indicate respective second dimensional information associated with the channel measurement resource in the second dimension. In some aspects, at least one of the respective first dimensional information and the respective second dimensional information may indicate a direction of a transmit beam within one or more spatial dimensions associated with the channel measurement resource. The code may include instructions further executable by the processor to select a receive beam to receive a reference signal transmitted on at least one of the set of multiple channel measurement resources, selection of the receive beam based on the respective first dimensional information and the respective second dimensional information associated with at least one of the set of multiple channel measurement resources, and receive the reference signal using the receive beam.

Some examples of the method, apparatuses, and non-transitory computer-readable medium described herein may further include operations, features, means, or instructions for determining the first dimensional information and the second dimensional information for each of the set of multiple channel measurement resources based on an indication of each channel measurement resource in a respective element of the channel measurement resource set, each element of the channel measurement resource set being mapped to a unique combination of a first index of the set of multiple first indices and a second index of the set of multiple second indices. In some aspects, a total quantity of elements indicated via the channel measurement resource set may be based on a product of a first quantity of the set of multiple first indices indicated by the channel measurement resource set and a second quantity of the plurality of second indices indicated by the channel measurement resource set.

In some examples of the method, apparatuses, and non-transitory computer-readable medium described herein, the total quantity of elements indicated via the channel measurement resource set may include a first subset of elements that includes respective indications for the set of multiple channel measurement resources and a second subset of elements that may be null.

In some examples of the method, apparatuses, and non-transitory computer-readable medium described herein, receiving the control signaling may include operations, features, means, or instructions for receiving, via the control signaling, a set of multiple channel measurement resource identifiers (IDs) in a first order, each channel measurement resource ID associated with a respective channel measurement resource of the set of multiple channel measurement resources. In some aspects, the channel measurement resource set may map each channel measurement resource ID of the set of multiple channel measurement resource IDs to a unique pair of a first index of the set of multiple first indices in the first dimension and a second index of the set of multiple second indices in the second dimension.

In some examples of the method, apparatuses, and non-transitory computer-readable medium described herein, the channel measurement resource set may map the set of multiple channel measurement resource IDs to the set of multiple first indices in a second order different than the first order and the second order may be based on an ascending or a descending order of values of the set of multiple channel measurement resource IDs.

Some examples of the method, apparatuses, and non-transitory computer-readable medium described herein may further include operations, features, means, or instructions for receiving a radio resource control (RRC) signal that indicates a first threshold quantity and a second threshold quantity, where a first quantity of the set of multiple first indices may be less than or equal to the first threshold quantity and a second quantity of the set of multiple second indices may be less than or equal to the second threshold quantity.

Some examples of the method, apparatuses, and non-transitory computer-readable medium described herein may further include operations, features, means, or instructions for determining a first threshold quantity and a second threshold quantity based on the channel measurement resource set, where a first quantity of the set of multiple first indices may be less than or equal to the first threshold quantity and a second quantity of the set of multiple second indices may be less than or equal to the second threshold quantity.

In some examples of the method, apparatuses, and non-transitory computer-readable medium described herein, the channel measurement resource may be mapped to a same first index in the first dimension as a second channel measurement resource of the set of multiple channel measurement resources and the method, apparatuses, and non-transitory computer-readable medium may include further operations, features, means, or instructions for determining that the respective first dimensional information in the first dimension may be applicable to both the channel measurement resource and the second channel measurement resource based on the channel measurement resource and the second channel measurement resource being mapped to the same first index.

In some examples of the method, apparatuses, and non-transitory computer-readable medium described herein, the channel measurement resource may be mapped to a different first index in the first dimension than a second channel measurement resource of the set of multiple channel measurement resources and the method, apparatuses, and non-transitory computer-readable medium may include further operations, features, means, or instructions for determining that the respective first dimensional information in the first dimension may be applicable to the channel measurement resource and determining that different first dimensional information in the first dimension may be applicable to a second channel measurement resource based on the channel measurement resource being mapped to the different first index than the second channel measurement resource in the first dimension.

Some examples of the method, apparatuses, and non-transitory computer-readable medium described herein may further include operations, features, means, or instructions for receiving system information that indicates a multi-dimensional channel measurement resource configuration and transmitting a message that indicates a capability of the first network entity to support the multi-dimensional channel measurement resource configuration based on the system information, where receiving the control signaling that indicates the channel measurement resource set may be based on the capability of the first network entity.

Some examples of the method, apparatuses, and non-transitory computer-readable medium described herein may further include operations, features, means, or instructions for establishing a connection via a serving cell associated with a multi-dimensional channel measurement resource configuration and transmitting a message that indicates a capability of the first network entity to support the multi-dimensional channel measurement resource configuration based on establishing the connection via the serving cell, where receiving the control signaling that indicates the channel measurement resource set may be based on the capability of the first network entity.

In some examples of the method, apparatuses, and non-transitory computer-readable medium described herein, the respective first dimensional information and the respective second dimensional information may each include one of a relative direction of a beam in an azimuthal dimension, a relative direction of a beam in an elevational dimension, a relative distance associated with the channel measurement resource, or a relative timing of the channel measurement resource in a time dimension.

In some examples of the method, apparatuses, and non-transitory computer-readable medium described herein, the set of multiple channel measurement resources includes synchronization signal block (SSB) resources, channel state information (CSI) reference signal (CSI-RS) resources, or both.

In some examples of the method, apparatuses, and non-transitory computer-readable medium described herein, receiving the control signaling may include operations, features, means, or instructions for receiving RRC signaling, where an information element (IE) of the RRC signaling indicates the channel measurement resource set.

A method is described. The method may include receiving control signaling that indicates a channel measurement resource set including a set of multiple channel measurement resources that are each associated with two or more dimensions, mapping the set of multiple channel measurement resources to at least a set of multiple first indices associated with a first dimension and a set of multiple second indices associated with a second dimension different than the first dimension based on a first parameter that indicates a first quantity of the set of multiple first indices and a second parameter that indicates a second quantity of the set of multiple second indices. In some aspects, for each channel measurement resource of the set of multiple channel measurement resources, a respective first index of the set of multiple first indices may indicate respective first dimensional information associated with the channel measurement resource in the first dimension and a respective second index of the set of multiple second indices may indicate respective second dimensional information associated with the channel measurement resource in the second dimension. In some aspects, at least one of the respective first dimensional information and the respective second dimensional information may indicate a direction of a transmit beam within one or more spatial dimensions associated with the channel measurement resource. The method may further include selecting a receive beam to receive a reference signal transmitted on at least one of the set of multiple channel measurement resources, selection of the receive beam based on the respective first dimensional information and the respective second dimensional information associated with at least one of the set of multiple channel measurement resources, and receiving the reference signal using the receive beam.

An apparatus is described. The apparatus may include a processor, memory coupled with the processor, and instructions stored in the memory. The instructions may be executable by the processor to cause the apparatus to receive control signaling that indicates a channel measurement resource set including a set of multiple channel measurement resources that are each associated with two or more dimensions, map the set of multiple channel measurement resources to at least a set of multiple first indices associated with a first dimension and a set of multiple second indices associated with a second dimension different than the first dimension based on a first parameter that indicates a first quantity of the set of multiple first indices and a second parameter that indicates a second quantity of the set of multiple second indices. In some aspects, for each channel measurement resource of the set of multiple channel measurement resources, a respective first index of the set of multiple first indices may indicate respective first dimensional information associated with the channel measurement resource in the first dimension and a respective second index of the set of multiple second indices may indicate respective second dimensional information associated with the channel measurement resource in the second dimension. In some aspects, at least one of the respective first dimensional information and the respective second dimensional information may indicate a direction of a transmit beam within one or more spatial dimensions associated with the channel measurement resource. The instructions may be further executable by the processor to cause the apparatus to select a receive beam to receive a reference signal transmitted on at least one of the set of multiple channel measurement resources, selection of the receive beam based on the respective first dimensional information and the respective second dimensional information associated with at least one of the set of multiple channel measurement resources, and receive the reference signal using the receive beam.

Another apparatus is described. The apparatus may include means for receiving control signaling that indicates a channel measurement resource set including a set of multiple channel measurement resources that are each associated with two or more dimensions, means for mapping the set of multiple channel measurement resources to at least a set of multiple first indices associated with a first dimension and a set of multiple second indices associated with a second dimension different than the first dimension based on a first parameter that indicates a first quantity of the set of multiple first indices and a second parameter that indicates a second quantity of the set of multiple second indices. In some aspects, for each channel measurement resource of the set of multiple channel measurement resources, a respective first index of the set of multiple first indices may indicate respective first dimensional information associated with the channel measurement resource in the first dimension and a respective second index of the set of multiple second indices may indicate respective second dimensional information associated with the channel measurement resource in the second dimension. In some aspects, at least one of the respective first dimensional information and the respective second dimensional information may indicate a direction of a transmit beam within one or more spatial dimensions associated with the channel measurement resource. The apparatus may further include means for selecting a receive beam to receive a reference signal transmitted on at least one of the set of multiple channel measurement resources, selection of the receive beam based on the respective first dimensional information and the respective second dimensional information associated with at least one of the set of multiple channel measurement resources, and means for receiving the reference signal using the receive beam.

A non-transitory computer-readable medium storing code is described. The code may include instructions executable by a processor to receive control signaling that indicates a channel measurement resource set including a set of multiple channel measurement resources that are each associated with two or more dimensions, map the set of multiple channel measurement resources to at least a set of multiple first indices associated with a first dimension and a set of multiple second indices associated with a second dimension different than the first dimension based on a first parameter that indicates a first quantity of the set of multiple first indices and a second parameter that indicates a second quantity of the set of multiple second indices. In some aspects, for each channel measurement resource of the set of multiple channel measurement resources, a respective first index of the set of multiple first indices may indicate respective first dimensional information associated with the channel measurement resource in the first dimension and a respective second index of the set of multiple second indices may indicate respective second dimensional information associated with the channel measurement resource in the second dimension. In some aspects, at least one of the respective first dimensional information and the respective second dimensional information may indicate a direction of a transmit beam within one or more spatial dimensions associated with the channel measurement resource. The code may include instructions further executable by the processor to select a receive beam to receive a reference signal transmitted on at least one of the set of multiple channel measurement resources, selection of the receive beam based on the respective first dimensional information and the respective second dimensional information associated with at least one of the set of multiple channel measurement resources, and receive the reference signal using the receive beam.

In some examples of the method, apparatuses, and non-transitory computer-readable medium described herein, receiving the control signaling may include operations, features, means, or instructions for receiving, via the control signaling, an indication of the first parameter and the second parameter.

Some examples of the method, apparatuses, and non-transitory computer-readable medium described herein may further include operations, features, means, or instructions for determining the first parameter and the second parameter based on the channel measurement resource set.

Some examples of the method, apparatuses, and non-transitory computer-readable medium described herein may further include operations, features, means, or instructions for determining a total quantity of the set of multiple channel measurement resources in the channel measurement resource set based on a product of the first quantity and the second quantity.

In some examples of the method, apparatuses, and non-transitory computer-readable medium described herein, the mapping may include operations, features, means, or instructions for grouping the total quantity of the set of multiple channel measurement resources into the second quantity of groups, each group including the first quantity of channel measurement resources, mapping each channel measurement resource of the first quantity of channel measurement resources in each group to a respective first index of the set of multiple first indices, and mapping the first quantity of channel measurement resources in each group to a same second index of the set of multiple second indices, where each group may be sequentially mapped to a different second index of the set of multiple second indices.

In some examples of the method, apparatuses, and non-transitory computer-readable medium described herein, the channel measurement resource set may indicate a set of multiple channel measurement resource IDs associated with the set of multiple channel measurement resources in a first order and the method, apparatuses, and non-transitory computer-readable medium may include further operations, features, means, or instructions for reordering the set of multiple channel measurement resource IDs from the first order to a second order, the second order based on an ascending or a descending order of values of the set of multiple channel measurement resource IDs. In some aspects, the mapping may be based on the second order of the set of multiple channel measurement resource IDs.

In some examples of the method, apparatuses, and non-transitory computer-readable medium described herein, the channel measurement resource may be mapped to a same first index in the first dimension as a second channel measurement resource of the set of multiple channel measurement resources and the method, apparatuses, and non-transitory computer-readable medium may include further operations, features, means, or instructions for determining that the respective first dimensional information in the first dimension may be applicable to both the channel measurement resource and the second channel measurement resource based on the channel measurement resource and the second channel measurement resource being mapped to the same first index.

In some examples of the method, apparatuses, and non-transitory computer-readable medium described herein, the channel measurement resource may be mapped to a different first index in the first dimension than a second channel measurement resource of the set of multiple channel measurement resources and the method, apparatuses, and non-transitory computer-readable medium may include further operations, features, means, or instructions for determining that the respective first dimensional information in the first dimension may be applicable to the channel measurement resource and determining that different first dimensional information in the first dimension may be applicable to a second channel measurement resource based on the channel measurement resource being mapped to the different first index than the second channel measurement resource in the first dimension.

Some examples of the method, apparatuses, and non-transitory computer-readable medium described herein may further include operations, features, means, or instructions for receiving system information that indicates a multi-dimensional channel measurement resource configuration and transmitting a message that indicates a capability of the first network entity to support the multi-dimensional channel measurement resource configuration based on the system information, where receiving the control signaling that indicates the channel measurement resource set may be based on the capability of the first network entity.

Some examples of the method, apparatuses, and non-transitory computer-readable medium described herein may further include operations, features, means, or instructions for establishing a connection via a serving cell associated with a multi-dimensional channel measurement resource configuration and transmitting a message that indicates a capability of the first network entity to support the multi-dimensional channel measurement resource configuration based on establishing the connection via the serving cell, where receiving the control signaling that indicates the channel measurement resource set may be based on the capability of the first network entity.

In some examples of the method, apparatuses, and non-transitory computer-readable medium described herein, the respective first dimensional information and the respective second dimensional information may each include one of a relative direction of a beam in an azimuthal dimension, a relative direction of a beam in an elevational dimension, a relative distance associated with the channel measurement resource, or a relative timing of the channel measurement resource in a time dimension.

A method for wireless communications at a second network entity is described. The method may include transmitting control signaling that indicates a channel measurement resource set including a set of multiple channel measurement resources each indexed according to at least a set of multiple first indices associated with a first dimension and a set of multiple second indices associated with a second dimension different than the first dimension. In some aspects, for each channel measurement resource of the set of multiple channel measurement resources, a respective first index of the set of multiple first indices may indicate respective first dimensional information associated with the channel measurement resource in the first dimension and a respective second index of the set of multiple second indices may indicate respective second dimensional information associated with the channel measurement resource in the second dimension. In some aspects, at least one of the respective first dimensional information and the respective second dimensional information may indicate a direction of a transmit beam within one or more spatial dimensions associated with the channel measurement resource. The method may further include transmitting a reference signal on at least one of the set of multiple channel measurement resources using a transmit beam that is based on the respective first dimensional information and the respective second dimensional information associated with at least one of the set of multiple channel measurement resources.

An apparatus for wireless communications at a second network entity is described. The apparatus may include a processor, memory coupled with the processor, and instructions stored in the memory. The instructions may be executable by the processor to cause the apparatus to transmit control signaling that indicates a channel measurement resource set including a set of multiple channel measurement resources each indexed according to at least a set of multiple first indices associated with a first dimension and a set of multiple second indices associated with a second dimension different than the first dimension. In some aspects, for each channel measurement resource of the set of multiple channel measurement resources, a respective first index of the set of multiple first indices may indicate respective first dimensional information associated with the channel measurement resource in the first dimension and a respective second index of the set of multiple second indices may indicate respective second dimensional information associated with the channel measurement resource in the second dimension. In some aspects, at least one of the respective first dimensional information and the respective second dimensional information may indicate a direction of a transmit beam within one or more spatial dimensions associated with the channel measurement resource. The instructions may be further executable by the processor to cause the apparatus to transmit a reference signal on at least one of the set of multiple channel measurement resources using a transmit beam that is based on the respective first dimensional information and the respective second dimensional information associated with at least one of the set of multiple channel measurement resources.

Another apparatus for wireless communications at a second network entity is described. The apparatus may include means for transmitting control signaling that indicates a channel measurement resource set including a set of multiple channel measurement resources each indexed according to at least a set of multiple first indices associated with a first dimension and a set of multiple second indices associated with a second dimension different than the first dimension. In some aspects, for each channel measurement resource of the set of multiple channel measurement resources, a respective first index of the set of multiple first indices may indicate respective first dimensional information associated with the channel measurement resource in the first dimension and a respective second index of the set of multiple second indices may indicate respective second dimensional information associated with the channel measurement resource in the second dimension. In some aspects, at least one of the respective first dimensional information and the respective second dimensional information may indicate a direction of a transmit beam within one or more spatial dimensions associated with the channel measurement resource. The apparatus may further include means for transmitting a reference signal on at least one of the set of multiple channel measurement resources using a transmit beam that is based on the respective first dimensional information and the respective second dimensional information associated with at least one of the set of multiple channel measurement resources.

A non-transitory computer-readable medium storing code for wireless communications at a second network entity is described. The code may include instructions executable by a processor to transmit control signaling that indicates a channel measurement resource set including a set of multiple channel measurement resources each indexed according to at least a set of multiple first indices associated with a first dimension and a set of multiple second indices associated with a second dimension different than the first dimension. In some aspects, for each channel measurement resource of the set of multiple channel measurement resources, a respective first index of the set of multiple first indices may indicate respective first dimensional information associated with the channel measurement resource in the first dimension and a respective second index of the set of multiple second indices may indicate respective second dimensional information associated with the channel measurement resource in the second dimension. In some aspects, at least one of the respective first dimensional information and the respective second dimensional information may indicate a direction of a transmit beam within one or more spatial dimensions associated with the channel measurement resource. The code may include instructions further executable by the processor to transmit a reference signal on at least one of the set of multiple channel measurement resources using a transmit beam that is based on the respective first dimensional information and the respective second dimensional information associated with at least one of the set of multiple channel measurement resources.

In some examples of the method, apparatuses, and non-transitory computer-readable medium described herein, a total quantity of entries indicated via the channel measurement resource set may be based on product of a first quantity of the set of multiple first indices indicated by the channel measurement resource set and a second quantity of the set of multiple second indices indicated by the channel measurement resource set. In some examples of the method, apparatuses, and non-transitory computer-readable medium described herein, a subset of elements of the total quantity of elements of the channel measurement resource set may each include an indication of a respective channel measurement resource ID associated with a respective channel measurement resource of the set of multiple channel measurement resources, remaining elements of the total quantity of elements of the channel measurement resource set may be null, and each element of the channel measurement resource set may be mapped to a unique combination of a first index of the set of multiple first indices and a second index of the set of multiple second indices.

In some examples of the method, apparatuses, and non-transitory computer-readable medium described herein, transmitting the control signaling may include operations, features, means, or instructions for transmitting, via the control signaling, a set of multiple channel measurement resource IDs in a first order, each channel measurement resource ID associated with a respective channel measurement resource of the set of multiple channel measurement resources. In some aspects, the channel measurement resource set may map each channel measurement resource ID of the set of multiple channel measurement resource IDs to a unique pair of a first index of the set of multiple first indices in the first dimension and a second index of the set of multiple second indices in the second dimension.

### BRIEF DESCRIPTION OF THE DRAWINGS

FIG. 1 illustrates an example of a wireless communications system that supports multi-dimensional channel measurement resource configuration in accordance with one or more aspects of the present disclosure.

FIG. 2 illustrates an example of a wireless communications system that supports multi-dimensional channel measurement resource configuration in accordance with one or more aspects of the present disclosure.

FIGS. 3A and 3B illustrate examples of a side view of an antenna panel and a top view of an antenna panel that supports multi-dimensional channel measurement resource configuration in accordance with one or more aspects of the present disclosure.

FIGS. 4-6 illustrates an example of multi-dimensional channel measurement resource configurations that support multi-dimensional channel measurement resource configuration in accordance with one or more aspects of the present disclosure.

FIG. 7 illustrates an example of a process flow that supports multi-dimensional channel measurement resource configuration in accordance with one or more aspects of the present disclosure.

FIGS. 8 and 9 show block diagrams of devices that support multi-dimensional channel measurement resource configuration in accordance with one or more aspects of the present disclosure.

FIG. 10 shows a block diagram of a communications manager that supports multi-dimensional channel measurement resource configuration in accordance with one or more aspects of the present disclosure.

FIG. 11 shows a diagram of a system including a UE that supports multi-dimensional channel measurement resource configuration in accordance with one or more aspects of the present disclosure.

FIG. 12 shows a diagram of a system including a network entity that supports multi-dimensional channel measurement resource configuration in accordance with one or more aspects of the present disclosure.

FIGS. 13 through 19 show flowcharts illustrating methods that support multi-dimensional channel measurement resource configuration in accordance with one or more aspects of the present disclosure.

### DETAILED DESCRIPTION

In some wireless communications systems, two or more wireless devices may perform a beam management procedure to select a beam to use for subsequent communications. The wireless devices may be referred to as network entities, and may represent examples of a network entity, a base station, a user equipment (UE), some other network node or device, or any combination thereof. In some aspects, a network entity may transmit a radio resource control (RRC) configuration to a UE to indicate or configure a set of resources for channel measurements (e.g., synchronization signal block (SSB) resources or channel state information (CSI) reference signal (CSI-RS) resources), which may be referred to as channel measurement resources. The network entity may transmit one or more reference signals to the UE via the indicated resources using a set of transmit beams. The UE may measure the reference signals to select a receive beam and to generate measurement reports for the beam management procedure. In some cases, the network entity may transmit additional signaling that indicates an absolute direction of a transmit beam for each channel measurement resource. For example, the network entity may indicate an azimuth direction, an elevation direction, or both for each channel measurement resource. However, indicating absolute beam directions may increase overhead and impose some security risks associated with disclosing a beamforming codebook of the network entity.

Techniques described herein provide for a modified or enhanced configuration of a channel measurement resource set that may indicate multi-dimensional information associated with the channel measurement resources in the set. Such a configuration may be referred to as a multi-dimensional channel measurement resource set configuration herein and may provide for reduced overhead and improved security associated with beam management procedures. To configure the multi-dimensional channel measurement resource set, a network entity may transmit, to a UE or some other wireless device, control signaling (e.g., an RRC configuration message) that configures a set of channel measurement resources that may be indexed by multiple sets of indices each associated with a different dimension. For example, each set of indices may indicate relative dimensional information in a respective dimension. The dimensional information may include a relative direction or angle of a beam in an azimuth dimension, a relative direction or angle of a beam in an elevation dimension, relative time information associated with the resource, a relative range or distance of a beam used to transmit the respective resource, or any combination thereof. The UE may assume that two channel measurement resources corresponding to a same index in a certain dimension may correspond to the same dimensional information in that dimension and that two channel measurement resources corresponding to different indices in a certain dimension may correspond to different dimensional information in that dimension.

In some aspects, the multi-dimensional channel measurement resource configuration may assign a respective first index to each channel measurement resource in a first dimension and separately assign a respective second index to each channel measurement resource in a second dimension (e.g., and one or more other indices for each other dimension). Alternatively, the multi-dimensional channel measurement resource configuration may assign a unique pair of a first index in the first dimension and a second index in the second dimension to each channel measurement resource, where a maximum quantity of indices in each dimension may be configured. In such cases, some unique pairs of indices may be null (e.g., may not point to a channel measurement resource).

In some other aspects, the multi-dimensional channel measurement resource configuration may indicate a set of channel measurement resources and the UE may map the channel measurement resources to multiple dimensions based on the configuration and one or more parameters. The UE may receive control signaling indicating the parameters, or the parameters may be configured per resource set. Each parameter may indicate a quantity of indices in a respective dimension (e.g., a size of each dimension). The UE may group the channel measurement resources indicated by the multi-dimensional channel measurement resource configuration into groups including a first quantity of resources associated with a first quantity of indices in a first dimension. A second quantity of the groups may be the same as a second quantity of indices in a second dimension. The UE may assign each resource in a group to a respective index in the first dimension, and the UE may assign each group to a respective index in a second dimension based on the configuration.

The network entity and the UE may each select a transmit beam and a receive beam, respectively, from a set of potential beams based on the relative dimensional information indicated for a respective channel measurement resource via the multi-dimensional channel measurement resource configuration. The network entity may transmit reference signals to the UE using the selected transmit beam via the respective channel measurement resource. The UE may receive one or more reference signals using the selected receive beam and may transmit a measurement report to the network entity based on measuring the reference signals. A UE and a network entity as described herein may thereby perform a beam management procedure using a multi-dimensional channel measurement resource configuration, which may improve reliability, improve security, reduce latency, and reduce overhead associated with a beam management procedure. In some aspects, the described multi-dimensional channel measurement resource configuration may be used for communications between any type of network entities, including UEs, base stations, network nodes, or any combination thereof.

Aspects of the disclosure are initially described in the context of wireless communications systems. Additional aspects are described with reference to antenna panels, multi-dimensional channel measurement resource configurations, and a process flow. Aspects of the disclosure are further illustrated by and described with reference to apparatus diagrams, system diagrams, and flowcharts that relate to multi-dimensional channel measurement resource configuration.

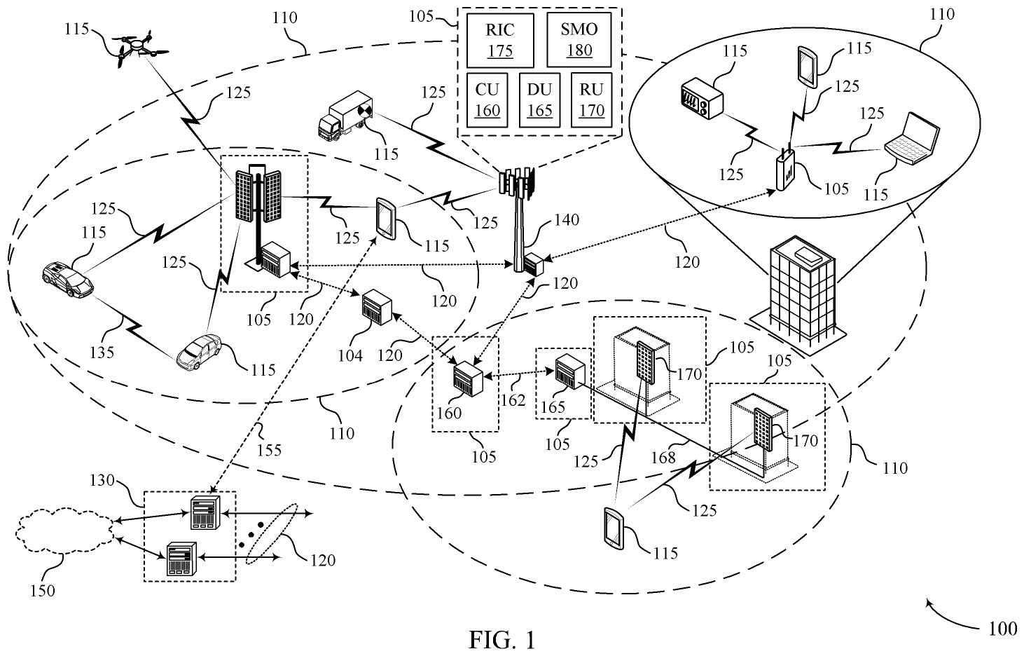

FIG. 1 illustrates an example of a wireless communications system 100 that supports multi-dimensional channel measurement resource configuration in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another over a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 through a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 175 is flexible and may support different functionalities depending upon which functions (e.g., network layer functions, protocol layer functions, baseband functions, RF functions, and any combinations thereof) are performed at a CU 160, a DU 165, or an RU 175. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication over such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 over an interface (e.g., a backhaul link). IAB donor and IAB nodes 104 may communicate over an F1 interface according to a protocol that defines signaling messages (e.g., an F1 AP protocol). Additionally, or alternatively, the CU 160 may communicate with the core network over an interface, which may be an example of a portion of backhaul link, and may communicate with other CUs 160 (e.g., a CU 160 associated with an alternative IAB donor) over an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, and referred to as a child IAB node associated with an IAB donor. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, and may directly signal transmissions to a UE 115. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling over an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support multi-dimensional channel measurement resource configuration as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) over one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be positioned according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications over a particular carrier bandwidth or may be configurable to support communications over one of a set of carrier bandwidths. In some examples, the wireless communications system 100 may include network entities 105 or UEs 115 that support concurrent communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both) such that the more resource elements that a device receives and the higher the order of the modulation scheme, the higher the data rate may be for the device. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., over a carrier) and may be associated with an identifier for distinguishing neighboring cells (e.g., a physical cell identifier (PCID), a virtual cell identifier (VCID), or others). In some examples, a cell may also refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be able to communicate directly with other UEs 115 over a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by or scheduled by the network entity 105. In some examples, one or more UEs 115 in such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without the involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, which may be referred to as clusters, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. While operating in unlicensed RF spectrum bands, devices such as the network entities 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located in diverse geographic locations. A network entity 105 may have an antenna array with a set of rows and columns of antenna ports that the network entity 105 may use to support beamforming of communications with a UE 115. Likewise, a UE 115 may have one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a CSI-RS, an SSB, a sounding reference signal (SRS), or some other type of reference signal), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate over logical channels. A MAC layer may perform priority handling and multiplexing of logical channels into transport channels. The MAC layer may also use error detection techniques, error correction techniques, or both to support retransmissions at the MAC layer to improve link efficiency. In the control plane, the RRC protocol layer may provide establishment, configuration, and maintenance of an RRC connection between a UE 115 and a network entity 105 or a core network 130 supporting radio bearers for user plane data. At the PHY layer, transport channels may be mapped to physical channels.

The UEs 115 and the network entities 105 may support retransmissions of data to increase the likelihood that data is received successfully. Hybrid automatic repeat request (HARQ) feedback is one technique for increasing the likelihood that data is received correctly over a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In some other examples, the device may provide HARQ feedback in a subsequent slot, or according to some other time interval.

In some examples of the wireless communications system 100, a first network entity 105 and a second network entity 105 may perform a beam management procedure to determine a beam pair to use for subsequent communications. The first and second network entities 105 may each represent an example of a UE 115, a base station 140, a CU 160, a DU 165, an RU 170, other network nodes, or any combination thereof. To perform the beam management procedure, the second network entity 105 may transmit reference signals to the first network entity 105 using a set of directional beams. The reference signals may be transmitted via a set of resources, which may be referred to as a channel measurement resource set.

As described herein, the second network entity 105 may transmit, to the first network entity 105 and prior to performing the beam management procedure, control signaling that configures the channel measurement resource set. Each channel measurement resource in the set may be associated with two or more dimensions, such as any combination of an azimuth dimension, and elevation dimension, a time dimension, and a distance dimension, among other dimensions. In some aspects, the channel measurement resources in the set may be indexed according to a first set of indices in a first dimension, a second set of indices in a second dimension, one or more other sets of indices in other dimensions, or any combination thereof. Additionally, or alternatively, the first network entity 105 may map the channel measurement resources to the respective sets of indices in the respective dimensions based on one or more parameters. The parameters may indicate a quantity of indices in each dimension.

For each channel measurement resource, a respective first index of the first set of indices may indicate respective first dimensional information in the first dimension, a respective second index of the second set of indices may indicate respective second dimensional information in the second dimension, and so forth. In some aspects, at least one of the first or second dimensional information may correspond to a direction of a transmit beam within one or more spatial dimensions associated with the respective channel measurement resource. The first network entity 105 and the second network entity 105 may select receive and transmit beams, respectively, based on the dimensional information indicated via the control signaling. The first and second network entities 105 may exchange reference signals via the channel measurement resources using the selected beams as part of the beam management procedure.

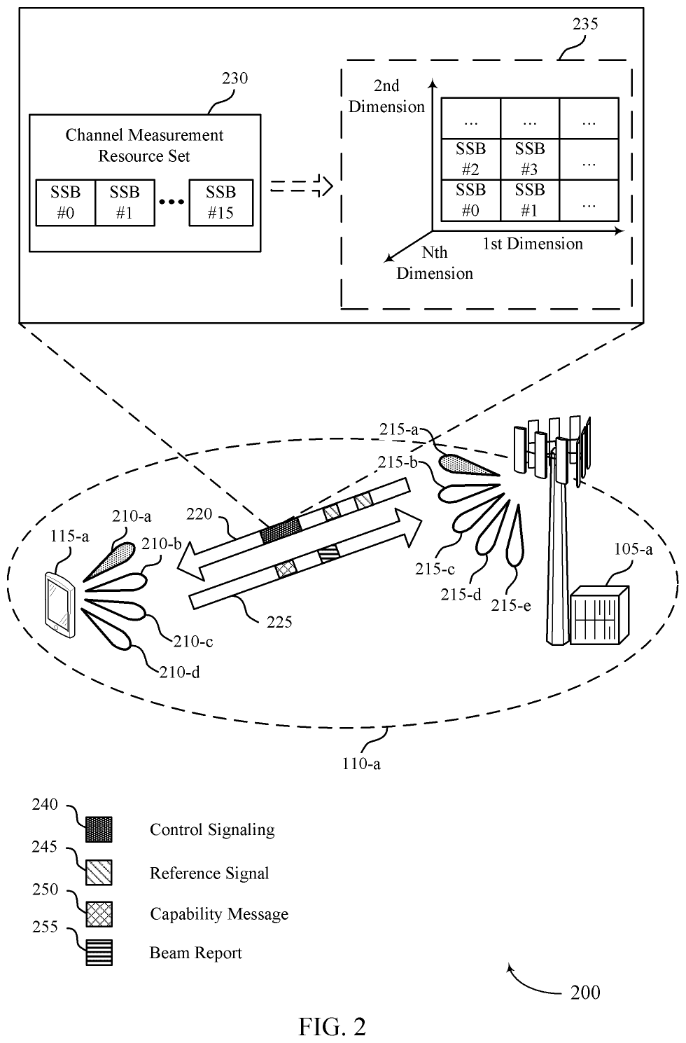

FIG. 2 illustrates an example of a wireless communications system 200 that supports a multi-dimensional channel measurement resource configuration in accordance with one or more aspects of the present disclosure. The wireless communications system 200 may implement or be implemented by aspects of the wireless communications system 100 as described with reference to FIG. 1. For example, the wireless communications system 200 illustrates communications between a UE 115-a and a network entity 105-a, which may represent examples of corresponding devices as described with reference to FIG. 1. The network entity 105-a may communicate with the UE 115-a within a geographic coverage area 110-a and via a downlink communication link 220 and an uplink communication link 225 (e.g., Uu links). In some aspects, the network entity 105-a and the UE 115-a may exchange multi-dimensional information 235 for a channel measurement resource set 230.

In some aspects, the network entity 105-a and the UE 115-a may communicate with one another using directional beams. In one example, the network entity 105-a may be an example of a transmitting device and the UE 115-a may be example of a receiving device. The network entity 105-a may transmit signals to the UE 115-a using a directional beam 215 and the UE 115-a may receive the signals from the network entity 105-a using a directional beam 210. In another example, the UE 115-a may be an example of the transmitting device and the network entity 105-a may be example of the receiving device. The UE 115-a may transmit signals to the network entity 105-a using a directional beam 210 and the network entity 105-a may receive the signals from the UE 115-a using a directional beam 215. Each directional beam 210 and 215 may be associated with a respective direction or other dimensional information in one or more dimensions. For example, a directional beam 210 may be associated with an angular direction in an azimuth dimension, and angular direction in an elevation dimension, a range or distance in a distance dimension, a timing in a time domain dimension, or any combination thereof.

The network entity 105-a and the UE 115-a may undergo a beam management procedure in an effort to discover a beam pair (e.g., a best transmit directional beam and a corresponding receive directional beam) for communication between the devices. The beam management procedure may be performed upon initial access. For example, if the UE 115-a establishes a connection with the network entity 105-a, the UE 115-a and the network entity 105-a may perform a beam management procedure to identify a beam pair to use for subsequent communications. In some aspects, the UE 115-a and the network entity 105-a may perform the beam management procedure during a connected mode to support continued communications. Additionally, or alternatively, the beam management procedure may be performed in the event that a beam failure or a radio link failure occurs. For example, if the UE 115-a, the network entity 105-a, or both detect a beam failure or a radio link failure (e.g., based on a block error rate (BLER) satisfying a threshold, or some other condition), the UE 115-a and the network entity 105-a may perform the beam management procedure as part of a beam failure recovery to identify a new directional beam pair to use.

During the beam management procedure, the network entity 105-a may transmit one or more reference signals 245 (e.g., CSI CSI-RSs, SSBs, SRSs for uplink, or some other type of reference signals 245) using a set of one or more directional beams 215. For example, the network entity 105-a may transmit a first reference signal 245 using the directional beam 215-a, a second reference signal 245 using the directional beam 215-b, and one or more other reference signals 245 using one or more of the directional beams 215-c, 215-d, and 215-e (e.g., the network entity 105-a may sweep through the directional beams 215).

The UE 115-a may receive the reference signals 215 using one or more directional beams 210. The UE 115-a may sweep through the directional beams 210 in a sequential order (e.g., the directional beams 210-a, 210-b, 210-c, and 210-d), or the UE 115-a may randomly select which directional beam 210 to use for receiving the reference signals 215. The UE 115-a may measure channel measurement information associated with the reference signals 245. The UE 115-a may select a preferred directional beam 210 to use for receiving subsequent communications based on the channel measurements. The UE 115-a may transmit a beam report 255 (which may also be referred to as a measurement report) to the network entity 105-a to indicate one or more preferred directional beams 215, to indicate the measured channel information, or both. In some aspects, the preferred one or more directional beams 215 may be the directional beams 215 that are associated with a highest channel measurement or a channel measurement that is greater than a threshold (e.g., a greatest measured signal metric, such as channel quality or reference signal received power (RSRP), or some other signal metric). The selected directional beam 210 at the UE 115-a and the indicated directional beam 215 at the network entity 105-a may be referred to as a beam pair.

In some cases, the network entity 105-a may transmit control signaling 240 that indicates or configures a set of resources allocated for the reference signals 245 used to perform channel measurements during the beam management procedure, which may be referred to as a channel measurement resource set 230 herein. The control signaling 240 may be RRC signaling, for example. An information element (IE) in the control signaling 240 may convey a configuration of multiple channel measurement resources that may be used by the network entity 105-a to perform beam training. For example, the IE may indicate resources for SSBs, CSI-RSs (e.g., non-zero prefix (NZP) CSI-RSs), or some other type of reference signals 245 that may be used to perform the beam management procedure. The IE may indicate an ID or index of each of the channel measurement resources. Example IE formats for configuring a one-dimensional channel measurement resource set 230 are included in Examples 1 and 2 below for reference.

CSI-SSB-ResourceSet::= SEQUENCE{
csi-SSB-ResourceSetId CSI-SSB-ResourceSetId

| | |
|---|---|
| csi-SSB-ResourceList SEQUENCE(SIZE(1.maxNrofCSI-SSB- | (1) |

ResourcePerSet)) OF SSB-Index,
}
NZP-CSI-RS-ResourceSet::= SEQUENCE{

| | |
|---|---|
| nzp-CSI-ResourceSetId CSI-SSB-ResourceSetId | (2) |

nzp-CSI-RS-Resources SEQUENCE(SIZE(1.maxNrofNZP-CSI-RS-
ResourcePerSet)) OF NZP-CSI-RS-ResourceId,
}

The CSI-SSB-ResourceSet in Example 1 may represent an example configuration of a channel measurement resource set 230 including SSB resources. The configuration may indicate a list or set (e.g., csi-SSB-ResourceList) of indices (e.g., SSB-Index) of resources via which an SSB may be transmitted for a beam management procedure. The NZP-CSI-RS-ResourceSet in Example 2 may similarly represent an example configuration of a channel measurement resource set 230 including CSI-RS resources. The configuration may indicate a list or set (e.g., nzp-CSI-RS-Resources) of IDs (e.g., NZP-CSI-RS-ResourceId) of resources via which a CSI-RS may be transmitted for a beam management procedure. The UE 115-a may monitor for and receive one or more reference signals via the resources indicated by the IE. It is to be understood that the IEs shown in Examples 1 and 2 are not limiting, and any other field or IE in any type of control signaling 240 may be used to configure a set of resources. Additionally, or alternatively, the channel measurement resource set 230 may include any type of resources, including CSI-RS resources, SSB resources, or other types of resources for beam management procedures.

The UE 115-a, the network entity 105-a, or both may, in some aspects, utilize a machine learning model, artificial intelligence (AI), or both to assist with the beam management procedure. For example, the beam selection by the UE 115-a may, in some aspects, be based on a machine learning algorithm that includes a data collection component, a model training component, a model interference component, an actor component, or any combination thereof. The data collection component may correspond to a function that may provide input data to the model training and model interference components. In the example of beam management, the data collection component may collect or process channel measurements obtained by the UE 115-a for each channel measurement resource. In some aspects, the input data collected by the data collection component may include feedback from the actor component (e.g., a processor or other component of the UE 115-a).

The model training component may perform the machine learning model training, validation, and testing to generate model performance metrics as part of a model training procedure. The model training component may perform data preparation, which may include data pre-processing, cleaning, formatting, and transformation based on the training data from the data collection component. The model interference component may correspond to a function that may provide a machine learning model interference output (e.g., one or more predictions or decisions). The model training component and the model interference component may, in some aspects, exchange feedback to generate the respective outputs. The actor component may correspond to a function that receives outputs from the model interference component and triggers or performs corresponding actions. The actor component may correspond to one or more components within the UE 115-a that may select a receive beam, generate a beam report 255, or both.

In some cases, the UE 115-a may perform beamformed channel measurements during the beam management procedure or during a different operation to estimate an underlying raw channel. As used herein, the raw channel may refer to a communications channel between the network entity 105-a and the UE 115-a in an absence of beamforming (e.g., as observed at the antenna ports of the network entity 105-a or the UE 115-a in the absence of analog beamforming) and may alternatively be referred to as a full channel, a non-beamformed channel, or a complete channel. Hence, the raw channel (and related channel state information) may be applicable to any signaling between the network entity 105-a and the UE 115-a, including beamformed signaling using a beam pair link (e.g., whether the beam pair link includes a predefined transmit beam and predefined receive beams based on a codebook, or whether the beam pair link includes one or more customized—e.g., non-codebook-based—beams).

The raw channel may be represented by a channel matrix, where one or more dimensions of the channel matrix may be based on a total quantity of receive antenna ports of the receiving device (e.g., the UE 115-a) or antenna panel thereof, or a total quantity of transmit antenna ports of the transmitting device (e.g., the network entity 105-a) or antenna panel thereof, or both. For example, a first dimension of the channel matrix may be equal to the total quantity of receive antenna ports of the receiving device, and a second dimension of the channel matrix may be equal to the total quantity of transmit antenna ports of the transmitting device—e.g., if the receiving device has 8 receive antenna ports and the transmitting device has 64 transmit antenna ports, the channel matrix may be an 8×64 matrix and thus include 512 elements.

By estimating the raw channel, the UE 115-a may enhance channel state feedback (CSF) reporting to the network entity 105-a. Enhanced CSF may provide the network entity 105-a with greater flexibility in selecting transmit beams. That is, the network entity 105-a may select transmit beams that are not included in a DFT-based codebook beams based on CSF feedback. In order to estimate the channel, the UE 115-a or the network entity 105-a may measure all possible transmit/receive beam pairs. In one example, the network entity 105-a may be capable of forming 64 different directional transmit beams and the UE 115-a may be capable of forming 8 different directional receive beams. In such example, the total number of possible beamformed measurements or transmit/receive beam pairs may be 512. Measuring all of the transmit/receive beam pairs may increase overhead signaling and, in some examples, the channel measurements may be stale. In addition, it may prove difficult to perform raw channel estimation using a relatively low-resolution analog-to-digital converter (ADC) or digital-to-analog converter (DAC) in digital beamforming.

In some cases, the network entity 105-a may transmit an indication of a relative direction of a transmit beam for transmission of a reference signal 245 to the UE 115-a. The indication may include a directional beam 215 and an angle or angular range of the directional beam 215 for transmission of the reference signal 245. The UE 115-a may select a beam 210 to use for receiving the reference signal 245 based on the indication of the relative direction. For example, if the network entity 105-a transmits a relative direction of the directional beams 215-a (e.g., an angular range associated with the beam 215-a), the UE 115-a may utilize this information to estimate or determine a corresponding directional beam 210-a to use for reception of the reference signal 245. The relative direction may indicate a direction or angular range of a beam in an azimuth direction, an elevation direction, or both. Additionally, or alternatively, for uplink communications, the UE 115-a may indicate the relative direction information for a subsequent reference signal 245 (e.g., an SRS).

The indication of the relative direction may be transmitted via additional signaling, which may increase overhead, in some examples. For example, if the devices include a relatively large quantity of antenna elements and support a relatively large quantity of beams (e.g., massive-MIMO), the overhead associated with the relative direction indication may increase. Additionally, or alternatively, the relative direction indication may expose one or more characteristics of a beamforming codebook used by the transmitting device, which may be proprietary to a certain vendor of one or more devices.

Techniques described herein provide for a transmitting device, such as the network entity 105-a, to indicate relative beam information in multiple dimensions via a configuration of a channel measurement resource set 230. By indicating multi-dimensional information via the configuration of the channel measurement resource set 230, the network entity 105-a may reduce overhead and maintain communication reliability for beamformed communications. The control signaling 240 may include RRC signaling, or some other type of control signaling, and the channel measurement resources may include SSBs, CSI-RSs, or some other type of resources, as described with reference to Examples 1 and 2. The relative beam information indicated by the multi-dimensional channel measurement resource configuration, which may be referred to as dimensional information herein, may include a relative direction or angle of a beam in an azimuth dimension, a relative direction or angle of a beam in an elevation dimension, a relative timing of a beam in a time dimension, a relative range or distance of a beam, or any combination thereof.

As described herein, the control signaling 240 may configure the channel measurement resource set 230 and may map the channel measurement resources to multiple sets of indices, where each set of indices may correspond to a respective dimension. In some aspects, the control signaling 240 may indicate the sets of indices for each channel measurement resource in the channel measurement resource set 230. Additionally, or alternatively, the control signaling 240 may indicate parameters or thresholds for the UE 115-a to use to map the channel measurement resource set 230 to the multi-dimensional information 235 including the indices in multiple dimensions. The configuration of the channel measurement resource set 230 may thus indicate relative multi-dimensional information 235 associated with each resource in the channel measurement resource set 230.

The multi-dimensional information 235 may include the channel measurement resources of the channel measurement resource set 230 (e.g., SSBs #0 through #15, or some other quantity or type of channel measurement resources) each indexed according to a respective set of indices associated with a respective dimension. The multi-dimensional information 235 may include dimensional information for each channel measurement resource in one to N dimensions, where N may be any integer quantity greater than or equal to two. The dimensions may include, for example, an azimuth dimension, an elevation dimension, a time dimension, a distance or range dimension, or some other dimension associated with beam information. The UE 115-a and the network entity 105-a may determine relative dimensional information associated with beams used for transmitting or receiving a reference signal 245 via each channel measurement resource in the channel measurement resource set 230 based on the values of the indices the respective channel measurement resource is mapped to in each dimension.

For example, in the example of FIG. 2, the SSB #0 may be mapped to a first index in the first dimension and a first index in the second dimension. The SSB #1 may be mapped to the same first index in the second dimension. As such, the UE 115-a and the network entity 105-a may determine that the SSB #0 and the SSB #1 correspond to the same dimensional information in the second dimension. If the second dimension corresponds to an azimuth dimension, a beam used to transmit the SSB #0 and a beam used to transmit the SSB #1 may correspond to a same angle or angular range in the azimuth dimension. Similarly, the UE 115-a and the network entity 105-a may determine that the SSB #0 and the SSB #1 correspond to different dimensional information in the first dimension based on the SSBs corresponding to different indices in the first dimension. If the first dimension corresponds to a time dimension, the SSB #0 and the SSB #1 may be transmitted at different times or within different time periods.

The dimensional information indicated by the control signaling 240 may be relative dimensional information indicative of differences between adjacent resources in the channel measurement resource set 230 (e.g., instead of an absolute indication of the dimensional information). By mapping the channel measurement resource set 230 to multiple indices in multiple dimensions, the network entity 105-a may thus convey relative multi-dimensional information 235 for each channel measurement resource with reduced overhead as compared with scenarios in which the network entity 105-a may transmit an explicit signal indicative of the directional information for each beam, which may provide for more efficient communications using a relatively large quantity of beams.

The channel measurement resource set 230 indicated by the control signaling 240 as described herein may correspond to an enhanced channel measurement resource set, which may be referred to as a multi-dimensional channel measurement resource configuration (e.g., NZP-CSI-RS-ResourceSet-r19 and CSI-SSB-ResourceSet-r19). The network entity 105-a may transmit enhanced system information to the UE 115-a during initial access. The system information may, in some aspects, indicate the multi-dimensional channel measurement resource configuration. For example, the system information may indicate that one or more types of multi-dimensional channel measurement resource configurations may be supported by the network entity 105-a. The UE 115-a may transmit a capability message 250 to the network entity 105-a to indicate that the UE 115-a is capable of supporting the multi-dimensional channel measurement resource configuration. In some aspects, the network entity 105-a may request an indication of the UE capability, or the UE 115-a may transmit the capability message 250 in response to the system information.

In some other aspects, the UE 115-a may establish a connection with the network entity 105-a via a serving cell (e.g., a secondary cell (SCell), or some other type of cell) that is associated with a multi-dimensional channel measurement resource configuration. For example, the serving cell configurations may indicate support for one or more types of multi-dimensional channel measurement resource configurations. The UE 115-a may transmit the capability message 250 to the network entity 105-a to indicate that the UE 115-a is capable of supporting the multi-dimensional channel measurement resource configuration. In some aspects, the network entity 105-a may request an indication of the UE capability, or the UE 115-a may transmit the capability message 250 in response to establishing the connection via the serving cell.

If a UE 115 does not support the multi-dimensional channel measurement resource configuration, the UE 115 may not be capable of receiving the enhanced system information or serving cell configuration that indicates the support for such configurations. As such, the UE 115 may not transmit the capability message 250, and a network entity 105 in communication with the UE 115 may refrain from transmitting the multi-dimensional information 235. Additionally, or alternatively, if a network entity 105 does not support the multi-dimensional channel measurement resource configuration, the network entity 105 may refrain from transmitting the enhanced system information or indicating the multi-dimensional channel measurement resource configuration via the serving cell configuration. In such cases, a UE 115 in communication with the network entity 105 may not transmit the capability message 250 and the devices may communicate according to a single dimensional channel measurement resource configuration.

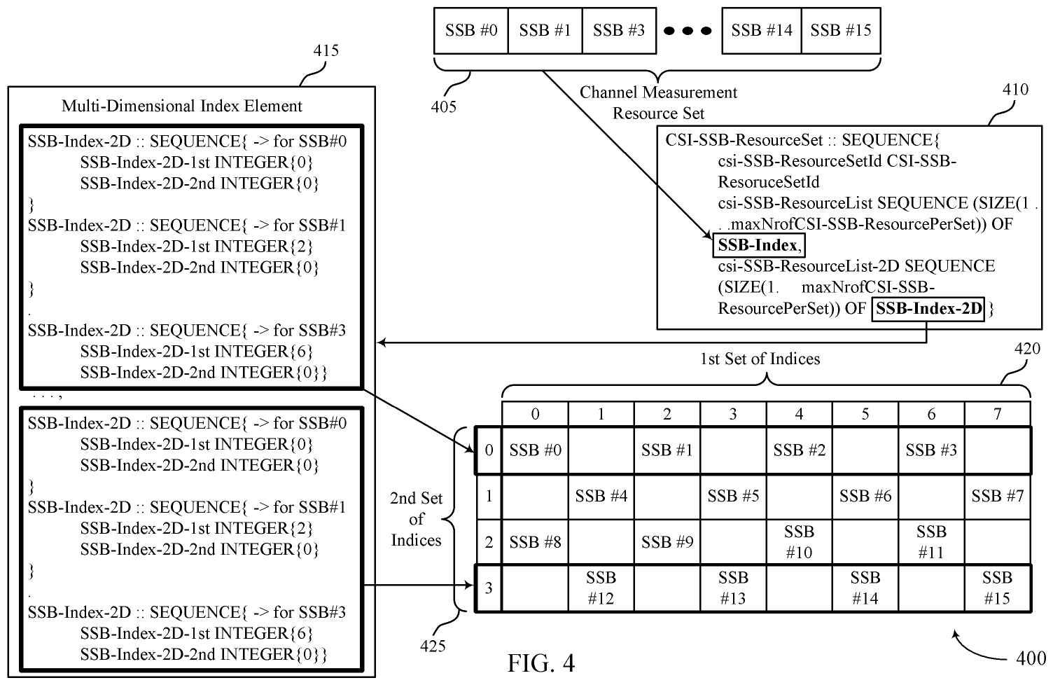

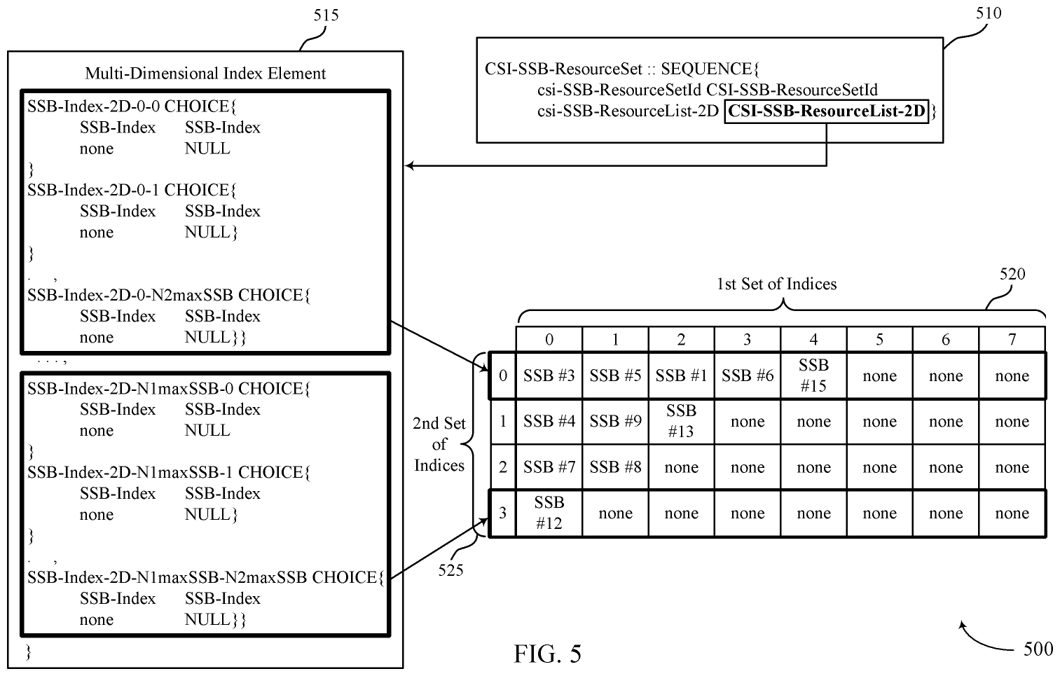

In some aspects, the control signaling 240 may indicate a respective set of indices to map the channel measurement resource set 230 to the multi-dimensional information 235. For example, the control signaling 240 may indicate, for each channel measurement resource, a respective index associated with each dimension. The control signaling 240 (e.g., an IE transmitted via RRC signaling) may, in some examples, indicate a multi-dimensional table (e.g., a conceptual table) that maps the resources to indices in each dimension, as described in further detail elsewhere herein, including with reference to FIG. 5. Additionally, or alternatively, the control signaling 240 may indicate identifiers (IDs) for the resources of the channel measurement resource set 230 in a first order and may map each channel measurement resource ID to a unique set including an index in each dimension, as described in further detail elsewhere herein, including with reference to FIG. 4.

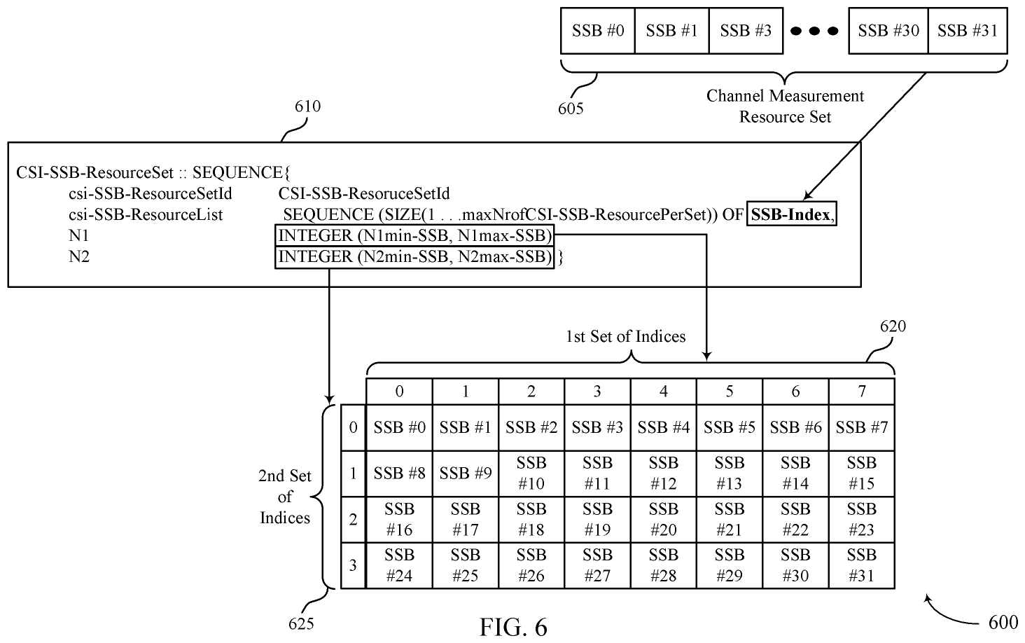

In some other aspects, the control signaling 240 may indicate IDs for the resources in the channel measurement resource set 230 in a first order and one or more parameters for mapping the channel measurement resources to the multi-dimensional information 235. The parameters may include a respective parameter indicative a quantity of indices in each dimension. In such cases, the UE 115-a may map the channel measurement resources to the multi-dimensional information 235 based on the parameters, such that the UE 115-a may determine relative dimensional information for each channel measurement resource, as described in further detail elsewhere herein, including with reference to FIG. 6.

In some aspects, the described techniques may be applied for two-dimensional information, such as a beam direction in an azimuth dimension and an elevation dimension. Additionally, or alternatively, the described techniques may be applied for three-dimensional information, four-dimensional information, or any quantity of dimensions, such as time information, distance information, or both. Such multi-dimensional information may be utilized in scenarios in which a reconfigurable intelligent array surface (RIS) or holographic-MIMO is deployed, among other scenarios. The described techniques may be applied for uplink communications, downlink communications, sidelink communications, or any combination thereof.

A network entity 105 (e.g., or other transmitting device) as described herein may thus configure a channel measurement resource set 230 that indicates relative dimensional information for one or more beams in multiple dimensions. The described techniques may reduce overhead and maintain beamforming codebook confidentiality by the transmitting device while maintaining reliable and efficient communications.

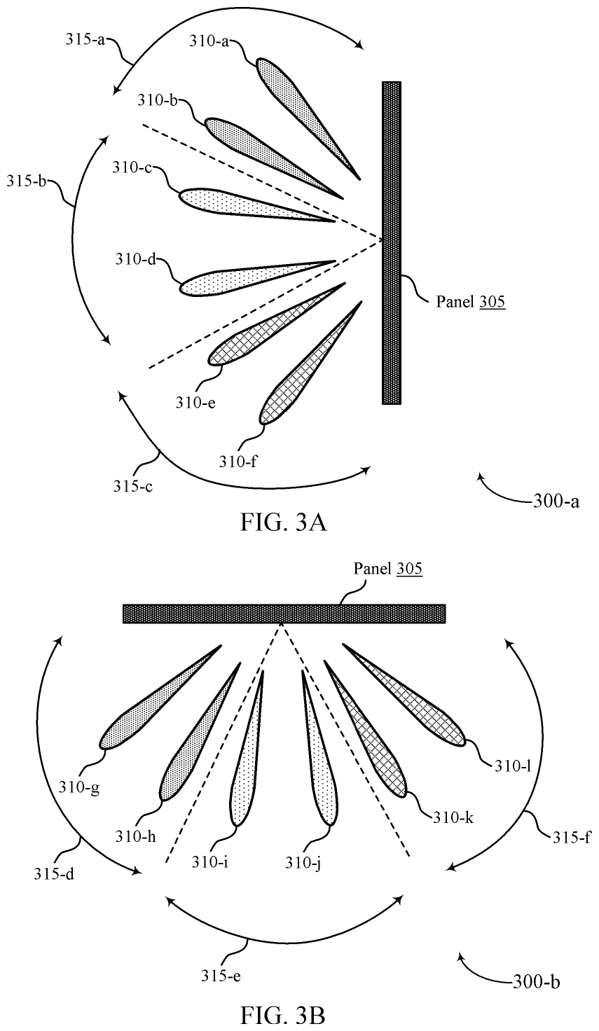

FIGS. 3A and 3B illustrate examples of a side view of an antenna panel 300-a and a top view of an antenna panel 300-b, respectively, that support a multi-dimensional channel measurement resource configuration in accordance with one or more aspects of the present disclosure. In some examples, the side view of the antenna panel 300-a and the top view of the antenna panel 300-b may implement or be implemented by aspects of the wireless communications systems 100 and 200 described with reference to FIGS. 1 and 2. For example, the panels 305 may correspond to antenna panels implemented by device, such as a UE 115 or a network entity 105 as described with reference to FIGS. 1 and 2. The panels 305 may be utilized to form directional transmit or receive beams 310.

In some examples, a transmitting device may include the panel 305. The panel 305 may provide for the transmitting device to transmit signals to a receiving device using a set of directional beams 310. Each directional beam 310 of the set may correspond to a different elevation angle as shown in FIG. 3A, a different azimuth angle as shown in FIG. 3B, or both. In some examples, the set of directional beams 310 may span a relatively large angular range (e.g., 180 degrees in azimuth or 180 degrees in elevation) and the transmitting device may divide the angular range into two or more smaller angular ranges.

For example, as shown in FIG. 3A, the transmitting device may divide the number of degrees spanned by the set of directional beams 310 into a first angular range 315-a, a second angular range 315-b, and a third angular range 315-c. In the example of FIG. 3B, the transmitting device may divide the number of degree spanned by the set of directional beams 310 into a first angular range 315-d, a second angular range 315-e, and a third angular range 315-f. Each angular range 315 may correspond to two or more directional beams 310 of the set.

For example, the first angular range 315-a illustrated in FIG. 3A may include angles corresponding to the directional beam 310-a and the directional beam 310-b. The second angular range 315-b may include angles corresponding to the directional beam 310-c and the directional beam 310-d. The third angular range 315-c may include angles associated with the directional beam 310-e and the directional beam 310-f. Similarly, in the example of FIG. 3B, the first angular range 315-d may include angles corresponding to the directional beam 310-g and the directional beam 310-h. The second angular range 315-e may include angles corresponding to the directional beam 310-i and the directional beam 310-j, and the third angular range 315-f may include angles associated with the directional beam 310-k and the directional beam 310-l.

Although the examples of FIGS. 3A and 3B show the azimuth dimension as being divided into three angular ranges 315 and the elevation dimension as also being divided into three angular ranges 315, it is to be understood that the azimuth and elevation dimensions may be divided into any quantity of angular ranges 315, and each angular range 315 may include any quantity of directional beams 310. In some examples, each dimension may include a different quantity of angular ranges 315, a different quantity of directional beams 310 per angular range 315, or both.

The elevation angle may correspond to a first spatial dimension, and the azimuth angle may correspond to a second spatial dimension, in some aspects. For example, each angular range 315, each angle at which a directional beam 310 is directed, or both may correspond to a respective direction of the directional beam 310 in a respective spatial dimension. That is, dimensional information for a directional beam 310 may include an angle or angular range 315 at which the directional beam 310 is directed in a respective spatial dimension, such as the azimuthal dimension illustrated in FIG. 3A or the elevation dimension illustrated in FIG. 3B.

In some aspects, the directional beams 310 may correspond to one or more other dimensions, which may include spatial dimensions or other types of dimensions. For example, the directional beams 310 may be transmitted or received at different times. In such cases, dimensional information for each directional beam 310 may be in a time dimension in addition to or as an alternative to a spatial dimension of the directional beam 310. Additionally, or alternatively, a directional beam 310 may be transmitted or received over different distances or ranges. For example, the directional beam 310-a may be associated with a first range (e.g., a first coverage area or distance over which the directional beam 310-a can reach) and the directional beam 310-c may be associated with a second range that is different than the first. In such cases, dimensional information for the directional beams 310 may be in a distance dimension.

As described with reference to FIG. 2, a transmitting device (e.g., a UE or a network entity) may support a multi-dimensional channel measurement resource configuration. The multi-dimensional channel measurement resource configuration may configure multiple channel measurement resources and may map each channel measurement resource to multiple indices each associated with a respective dimension. For example, a first set of indices may be associated with or indicative of relative beam directions in an azimuth dimension, a second set of indices may be associated with or indicative of relative beam directions in an elevation dimension, a third set of indices may be associated with or indicative of relative timing of beams in a time dimension, a fourth set of indices may be associated with or indicative of relative distances or ranges of beams in a distance dimension, or any combination thereof. In such cases, each index of the first set of indices may, for example, correspond to a respective angle or angular range 315 in the azimuth dimension, as illustrated in FIG. 3A, and each second index of the second set of indices may, for example, correspond to a respective angle or angular range 315 in the elevation dimension, as illustrated in FIG. 3B.

Accordingly, each channel measurement resource of the channel measurement resource set may be mapped to a particular combination of respective dimensional information in two or more dimensions. In an example, if four dimensions are indicated via the multi-dimensional channel measurement resource configuration, a channel measurement resource that is transmitted using the beam 310-a may correspond to a first index associated with the angular range 315-a in the azimuth dimension, a second index associated with, for example, the angular range 315-d in the elevation dimension, a third index associated with a first time period in the time dimension, and a fourth index associated with a first range in the distance dimension. A receiving device may determine, based on the multi-dimensional channel measurement resource configuration, that the beam 310-a will be transmitted within the angular range 315-a, within the angular range 315-d, within the first time period, and within the first range.

The dimensional information indicated via the multi-dimensional channel measurement resource configuration may be relative information. For example, for a given dimension, channel measurement resources mapped to adjacent indices may correspond to adjacent information in the respective dimension (e.g., adjacent angular ranges 315, time periods, or distances), and channel measurement resources mapped to a same index may correspond to same information in the respective dimension. Such multi-dimensional information may be utilized in scenarios in which an RIS or holographic-MIMO is deployed, among other scenarios. A transmitting device and a receiving device may thus select transmit and receive beams, respectively, to use for subsequent communications based on the relative dimensional information indicated via the multi-dimensional channel measurement resource configuration, as described in further detail elsewhere herein, including with reference to FIGS. 4-7.

FIG. 4 illustrates an example of a multi-dimensional channel measurement resource configuration 400 that supports multi-dimensional channel measurement resource configuration in accordance with one or more aspects of the present disclosure. The multi-dimensional channel measurement resource configuration 400 may implement or be implemented by aspects of the wireless communications systems 100 and 200 described with reference to FIGS. 1 and 2. For example, the multi-dimensional channel measurement resource configuration 400 illustrates an example of control signaling that maps a channel measurement resource set 405 including channel measurement resources (e.g., SSBs) to two sets of indices in two dimensions. The control signaling may be transmitted by a transmitting network entity to a receiving network entity, where each network entity may represent an example of a network entity, a UE, a base station, a CU, a DU, an RU, or any combination thereof, as described with reference to FIGS. 1-3.

In some cases, a transmitting network entity may configure a single-dimensional channel measurement resource set by transmitting control signaling (e.g., a MAC-CE, DCI, RRC signaling) that includes an IE to convey index values of resources within the channel measurement resource set. In some cases, the IE may indicate the channel measurement resource indices as a list or set in a single dimension, as described with reference to FIG. 2 and Examples 1 and 2. In such cases, the transmitting network entity may transmit additional signaling to indicate relative directional information associated with each resource in the channel measurement resource set, which may increase overhead. Techniques described herein provide for control signaling that may indicate, via a configuration of a channel measurement resource set, multi-dimensional information for each channel measurement resource of the set.

In the example of FIG. 4, a channel measurement resource set 405 may be configured to include 16 SSB resources. Each SSB resource may be associated with or assigned to a respective SSB index (e.g., SSB #0 through SSB #15). Techniques described herein provide for control signaling that may indicate, via a configuration of the channel measurement resource set 405, multi-dimensional information for each channel measurement resource of the set. For example, the IE 410 illustrated in FIG. 4 represents an example format of an IE 410 that may be used to configure the resources within the channel measurement resource set 405 with additional indices or IDs in multiple dimensions.

The transmitting network entity may transmit the control signaling including the IE 410 based on a capability of a receiving network entity to support a multi-dimensional channel measurement resource configuration, which may be indicated via a capability message, as described with reference to FIG. 2. In some aspects, the multi-dimensional channel measurement resource configuration illustrated in FIG. 4 may correspond to a first type of multi-dimensional channel measurement resource configuration, and the capability message may indicate support for the first type of the multi-dimensional channel measurement resource configuration.

Although SSB resources are illustrated in FIG. 4, it is to be understood that the described techniques may be applied for configurations of channel measurement resource sets 405 that include any type of resources, including CSI-RS resources, SRS, resources, or any other type of resources. In some aspects, the SSB indices illustrated in FIG. 4 may represent examples of CSI-RS IDs, or some other type of ID or index value. For example, an IE may configure an NZP-CSI-RS resource set, or some other type of resource set. The SSB indices may be referred to as channel measurement resource IDs herein. Additionally, or alternatively, although 16 resources are illustrated as being included in the channel measurement resource set 405, it is to be understood that any quantity of resources may be configured in the channel measurement resource set 405. In some aspects, a relatively large quantity of resources may be configured in a single set.

The IE 410 may indicate the channel measurement resource IDs for the channel measurement resources in a first order (e.g., via the csi-SSB-ResourceList), which may be referred to as a presenting order of the resources. Each channel measurement resource in the set may be associated with a respective channel measurement resource ID. The IE 410 may additionally configure each channel measurement resource ID with a first index (e.g., ID value) of a first set of indices 420 in a first dimension and a second index of a second set of indices 425 in a second dimension (e.g., via the csi-SSB-ResourceList-2D). That is, the IE 410 may map each channel measurement resource ID of the channel measurement resource set 405 to a unique pair of a first index in the first dimension and a second index in the second dimension.

The channel measurement resource IDs of the channel measurement resource set 405 may be mapped to the two-dimensional indices via an element (e.g., a variable or parameter) in the IE 410, such as the multi-dimensional index element 415, which may be referred to as an SSB-Index-2D, in some aspects. The multi-dimensional index element 415 may configure a respective pair of indices for each channel measurement resource. For a certain channel measurement resource, a choice of an index of the first set of indices 420 in the first dimension (e.g., the SSB-Index-2D-1st) may be an index value selected from a range of values between zero and a first threshold quantity of index values in the first dimension (e.g., N1max). A choice of an index of the second set of indices 425 in the second dimension (e.g., the SSB-Index-2D-2nd) may be an index value selected from a range of values between zero and a second threshold quantity of index values in the second dimension (e.g., N2max).

In some aspects, the first threshold quantity of index values in the first dimension (e.g., N1max), the second threshold quantity of index values in the second dimension (e.g., N2max), or both may be configured via control signaling (e.g., RRC configured, or indicated via other types of control signaling). That is, a transmitting device may transmit an indication of the threshold quantities to a receiving device via control signaling. Additionally, or alternatively, the first and second threshold quantities may be based on the channel measurement resource set 405. For example, a respective threshold quantity may be defined or configured for each channel measurement resource set 405 (e.g., defined in a standard or configured at the devices). In some aspects, the threshold quantities may be separately configured or defined for an SSB resource set and a CSI-RS resource set, or some other type of resource set.

A quantity of indices in the first set of indices 420 may be less than or equal to the first threshold quantity and a quantity of indices in the second set of indices 425 may be less than or equal to the second threshold quantity, such that a total quantity of elements in the multi-dimensional index element 415 may be less than or equal to a product of the first threshold quantity and the second threshold quantity. Some elements in the multi-dimensional index element 415 may be null (e.g., may not be assigned to point to a channel measurement resource). In such cases, a total quantity of channel measurement resources may be less than the total quantity of elements in the multi-dimensional index element 415.

A two-dimensional table is illustrated in FIG. 4 to show a conceptual mapping of the channel measurement resources to the first set of indices 420 in a first dimension (e.g., represented by an x-direction or horizontal direction in FIG. 4) and the second set of indices 425 in a second dimension (e.g., represented by a y-direction or vertical direction in FIG. 4). However, it is to be understood that the table is a conceptual illustration for clarity purposes, and the IE 410 transmitted via the control signaling may not include the table. Rather, the IE 410 may assign index values to each channel measurement resource, and the index values may be representative of information in multiple dimensions.

In the example of FIG. 4, the SSB #0 may be configured with an initial channel measurement resource ID of zero in the channel measurement resource set 405, and may be mapped, by the multi-dimensional index element 415 of the IE 410 to an index of zero in the first dimension and an index of zero in the second dimension. The SSB #14, for example, may be configured with an initial channel measurement resource ID of 14 in the channel measurement resource set 405, and may be mapped, by the multi-dimensional index element 415 of the IE 410 to an index of five in the first dimension and an index of three in the second dimension. As illustrated in FIG. 4, no more than one channel measurement resource may be mapped to both a same first index and a same second index at a time (e.g., each resource is mapped to a unique index pair).

In some aspects, the channel measurement resources within the channel measurement resource set 405 may be re-indexed or reordered according to an ascending or descending order of values of the corresponding channel measurement resource IDs (e.g., as indicated via an original serving cell configuration) before the multi-dimensional index element 415 configures additional indices in each dimension. For example, the channel measurement resource set 405 may be configured with channel measurement resources in a first (e.g., random) order of channel measurement resource ID values, which may be referred to as a presenting order, in some aspects. The multi-dimensional index element 415 in the IE 410 may map the channel measurement resource IDs to the first set of indices 420, the second set of indices 425, or both in a second order different than the first order. In some aspects, the second order may be based on the ascending or descending order of the values of the channel measurement IDs.

In an example, the channel measurement resource set 405 may present the SSBs in a first order, such as SSB #2, SSB #3, SSB #4, SSB #1, or some other random order (not illustrated in FIG. 4). The multi-dimensional index element 415 in the IE 410 may reorder the SSBs to a second order, such as SSB #1, SSB #2, SSB #3, SSB #4 (e.g., an ascending order) or SSB #4, SSB #3, SSB #2, SSB #1 (e.g., a descending order) before mapping the SSBs to the first set of indices 420 and the second set of indices 425.

The IE 410 may thus map a list or set of channel measurement resources to a first set of indices 420 in a first dimension and a second set of indices 425 in a second dimension. Although two dimensions are illustrated in FIG. 4, it is to be understood that the described techniques may be applied for any quantity of two or more dimensions. For example, the IE 410 may configure three sets of index values each in a respective dimension, four sets of index values, or some other quantity to map the channel measurement resource set 405 to multi-dimensional information (e.g., a conceptual multi-dimensional table). In such cases, a respective threshold quantity of indices may be configured for each dimension.

Each dimension may correspond to one of an azimuth dimension, an elevation dimension, a distance or range dimension, a time dimension, or any combination thereof. The respective dimensional information conveyed by each set of indices in each respective dimension may correspond to one of a relative direction of a beam in the azimuthal dimension, a relative direction of a beam in the elevational dimension, a relative distance associated with the channel measurement resource, or a relative timing of the channel measurement resource in the time dimension.

The receiving network entity may assume or determine, based on receiving the multi-dimensional channel measurement resource configuration via the IE 410 and a capability of the receiving network entity, relative dimensional information for beams used to transmit each channel measurement resource of the channel measurement resource set 405. For example, the receiving network entity may determine, based on an indication via the control signaling, a configuration, a rule, or any combination thereof, that the first dimension is associated with directional information indicating a direction of a transmit beam in a spatial dimension (e.g., an elevation or azimuth direction).

The receiving network entity may determine that if two different channel measurement resources are mapped to identical indices of the first set of indices 420 in the first dimension, a beam direction of the corresponding beams in the spatial dimension will also be identical. For example, a beam direction of beams corresponding to the SSB #0 and the SSB #8 may be the same based on the SSB #0 and the SSB #8 both being mapped to the same first index of zero in the first set of indices 420 in the first dimension. The receiving network entity may determine that if two different channel measurement resources are mapped to different indices of the first set of indices 620 in the first dimension, the beam directions of the corresponding beams in the spatial dimension will be different. For example, a beam direction of beams corresponding to the SSB #0 and the SSB #1 may be different based on the SSB #0 and the SSB #1 being mapped to different first index values of the first set of indices 420 in the first dimension.

The receiving network entity may determine that the other dimensions are each associated with one of a spatial dimension, a time dimension, a direction dimension, or some other dimension based on the control signaling, configuration, or rule indicated by a transmitting network entity. The receiving network entity may similarly determine whether two or more channel measurement resources correspond to the same, different, or adjacent beam direction, timing, or distance in the respective dimension based on the index values for the respective set of indices in that dimension.

In some aspects, if the indices for two different channel measurement resources are adjacent in a respective dimension, the receiving network entity may determine that the beam directions in the respective spatial dimension may also be adjacent. For example, the beams corresponding to the SSB #0 and the SSB #4 may be at adjacent angles, within adjacent angular ranges, within adjacent time periods, or within adjacent distances in the second dimension (e.g., depending on what the second dimension is) based on the SSB #0 and the SSB #4 being mapped to adjacent indices in the second set of indices 425 in the second dimension. In some aspects, a beam direction or other dimensional information in the spatial dimension may be scaled based on an ascending or descending order of the first set of indices 420.

Multi-dimensional beam information may thus be indicated to a receiving device via a configuration of a channel measurement resource set 405. The described techniques may provide for improved communication reliability, reduced overhead, and reduced latency as compared with systems in which explicit signaling is used to convey absolute or relative beam information for each channel measurement resource.

FIG. 5 illustrates an example of a multi-dimensional channel measurement resource configuration 500 that supports multi-dimensional channel measurement resource configuration in accordance with one or more aspects of the present disclosure. The multi-dimensional channel measurement resource configuration 500 may implement or be implemented by aspects of the wireless communications systems 100 and 200 described with reference to FIGS. 1 and 2 or the multi-dimensional channel measurement resource configuration 400 described with reference to FIG. 4. For example, the multi-dimensional channel measurement resource configuration 500 illustrates an example of control signaling that maps a channel measurement resource set including channel measurement resources (e.g., SSBs) to two sets of indices in two dimensions. The control signaling may be transmitted by a transmitting network entity to a receiving network entity, where each network entity may represent an example of a network entity, a UE, a base station, a CU, a DU, an RU, or any combination thereof, as described with reference to FIGS. 1-4.

In some cases, a transmitting network entity may configure a single-dimensional channel measurement resource set by transmitting control signaling (e.g., a MAC-CE, DCI, RRC signaling) that includes an IE to convey index values of resources within the channel measurement resource set, as described with reference to FIGS. 1 and 2. Techniques described herein provide for control signaling that may indicate, via a configuration of a channel measurement resource set, multi-dimensional information for each channel measurement resource of the set.

In the example of FIG. 5, the transmitting network entity may transmit control signaling, such as an RRC configuration, that includes the IE 510. The IE 510 illustrated in FIG. 5 represents an example format of an IE 510 that may be used to configure resources within a channel measurement resource set 505 with indices or IDs in multiple dimensions. The transmitting network entity may transmit the control signaling including the IE 510 based on a capability of a receiving network entity to support a multi-dimensional channel measurement resource configuration, which may be indicated via a capability message, as described with reference to FIG. 2. In some aspects, the multi-dimensional channel measurement resource configuration illustrated in FIG. 5 may correspond to a second type of multi-dimensional channel measurement resource configuration, and the capability message may indicate support for the second type of the multi-dimensional channel measurement resource configuration.

Although SSB resources are illustrated in FIG. 5, it is to be understood that the described techniques may be applied for configurations of channel measurement resource sets that include any type of resources, including CSI-RS resources, SRS, resources, or any other type of resources. In some aspects, the SSB indices illustrated in FIG. 5 may represent examples of CSI-RS IDs, or some other type of ID or index value. For example, an IE may configure an NZP-CSI-RS resource set, or some other type of resource set. The SSB indices may be referred to as channel measurement resource IDs herein. Additionally, or alternatively, although 11 resources are illustrated as being included in the channel measurement resource set in FIG. 5, it is to be understood that any quantity of resources may be configured in the channel measurement resource set.

The IE 510 may indicate or include an element (e.g., a variable or parameter), such as the multi-dimensional index element 515 (e.g., the CSI-SSB-ResourceList-2D), that may configure a sequence, set, or list of elements of the channel measurement resource set that are each mapped to a unique pair of a first index (e.g., ID value) of a first set of indices 520 in a first dimension and a second index of a second set of indices 525 in a second dimension. The first set of indices 520 may include a first quantity of indices that is less than or equal to a first threshold quantity of indices in the first dimension (e.g., N1max) and the second set of indices 525 may include a second quantity of indices that is less than or equal to a second threshold quantity of indices in the second dimension (e.g., N2max). A total quantity of elements indicated by the IE 510 may be the same as a product of the first quantity of indices in the first set of indices 520 and the second quantity of indices in the second set of indices 520.

In some aspects, the first threshold quantity of index values in the first dimension (e.g., N1max), the second threshold quantity of index values in the second dimension (e.g., N2max), or both may be configured via control signaling (e.g., RRC configured, or indicated via other types of control signaling). That is, a transmitting device may transmit an indication of the threshold quantities to a receiving device via control signaling. Additionally, or alternatively, the first and second threshold quantities may be based on the channel measurement resource set. For example, a respective threshold quantity may be defined or configured for each channel measurement resource set (e.g., defined in a standard or configured at the devices). In some aspects, the threshold quantities may be separately configured or defined for an SSB resource set and a CSI-RS resource set, or some other type of resource set.

A two-dimensional table is illustrated in FIG. 5 to show a conceptual mapping of the channel measurement resources to the first set of indices 520 in a first dimension (e.g., represented by an x-direction or horizontal direction in FIG. 5) and the second set of indices 525 in a second dimension (e.g., represented by a y-direction or vertical direction in FIG. 5). However, it is to be understood that the table is a conceptual illustration for clarity purposes, and the IE 510 transmitted via the control signaling may not include the table. Rather, the IE 510 may assign multiple index values to each element, and the index values may be representative of information in multiple dimensions.

The total quantity of elements included in the conceptual table may include a first subset of elements that each include a respective indication of a channel measurement resource (e.g., 11 elements in the example of FIG. 5). The total quantity of elements included in the conceptual table may include, in some aspects, a second subset of elements that are null (e.g., that do not point to a channel measurement resource). These elements are identified as “none” in FIG. 5. The multi-dimensional index element 515 may insert, in each element corresponding to each unique pair of indices, a choice of either a channel measurement resource ID that points to a channel measurement resource or a null pointer. That is, the channel measurement resources within the channel measurement resource set may be directly allocated to a respective conceptual grid or table of multi-dimensional information by the IE 510.

In the example of FIG. 5, the SSB #3 may be mapped to an index of zero in the first set of indices 520 and an index of zero in the second set of indices 525. For example, the channel measurement resource ID for the SSB #3 (e.g., ssb-Index) may be mapped to an element in the multi-dimensional index element 515, such as the element ssb-Index-2D-0-0, that is associated with the index pair (0,0). The SSB #12 may be mapped to an index of zero in the first set of indices 520 and an index of three in the second set of indices 525. For example, the channel measurement resource ID for the SSB #12 (e.g., ssb-Index) may be mapped to an element in the multi-dimensional index element 515, such as the element ssb-Index-2D-N1maxSSB-0, that is associated with the index pair (3,0). The fifth, sixth, and seventh indices in the first set of indices 520 may not point to any channel measurement resources (e.g., null pointers). No more than one channel measurement resource may be mapped to a same pair of indices.

The IE 510 may thus map a list or set of channel measurement resources to a first set of indices 520 in a first dimension and a second set of indices 525 in a second dimension. Although two dimensions are illustrated in FIG. 5, it is to be understood that the described techniques may be applied for any quantity of two or more dimensions. For example, the IE 510 may configure three sets of index values each in a respective dimension, four sets of index values, or some other quantity to map the channel measurement resource set 505 to multi-dimensional information (e.g., a conceptual multi-dimensional table). In such cases, a respective threshold quantity of indices may be configured for each dimension.

Each dimension may correspond to one of an azimuth dimension, an elevation dimension, a distance or range dimension, a time dimension, or any combination thereof. The respective dimensional information conveyed by each set of indices in each respective dimension may correspond to one of a relative direction of a beam in the azimuthal dimension, a relative direction of a beam in the elevational dimension, a relative distance associated with the channel measurement resource, or a relative timing of the channel measurement resource in the time dimension.

The receiving network entity may assume or determine, based on receiving the multi-dimensional channel measurement resource configuration via the IE 510 and a capability of the receiving network entity, relative dimensional information for beams used to transmit each channel measurement resource of the channel measurement resource set 505. For example, the receiving network entity may determine, based on an indication via the control signaling, a configuration, a rule, or any combination thereof, that the first dimension is associated with directional information indicating a direction of a transmit beam in a spatial dimension (e.g., an elevation or azimuth direction).

The receiving network entity may determine that if two different channel measurement resources are mapped to identical indices of the first set of indices 520 in the first dimension, a beam direction of the corresponding beams in the spatial dimension will also be identical. For example, a beam direction of beams corresponding to the SSB #3, the SSB #4, the SSB #7, and the SSB #12 may be the same based on the SSB #3, the SSB #4, the SSB #7, and the SSB #12 all being mapped to the index of zero in the first set of indices 520 in the first dimension.

The receiving network entity may determine that if two different channel measurement resources are mapped to different indices of the first set of indices 520 in the first dimension, the beam directions of the corresponding beams in the spatial dimension will be different. For example, a beam direction of beams corresponding to the SSB #3, the SSB #5, the SSB #1, the SSB #6, and the SSB #15 may be different based on the SSB #3, the SSB #5, the SSB #1, the SSB #6, and the SSB #15 being mapped to different index values of the first set of indices 520 in the first dimension. In some aspects, if the indices are adjacent, the receiving network entity may determine that the beam directions in the spatial dimension may also be adjacent. For example, the beams corresponding to the SSB #3 and the SSB #5 may be at adjacent angles or within adjacent angular ranges in the first dimension, as described with reference to FIG. 3. In some aspects, a beam direction or other dimensional information in the spatial dimension may be scaled based on an ascending or descending order of the first set of indices 520.

The receiving network entity may determine that the other dimensions are each associated with one of a spatial dimension, a time dimension, a direction dimension, or some other dimension based on the control signaling, configuration, or rule indicated by a transmitting network entity. The receiving network entity may similarly determine whether two or more channel measurement resources correspond to the same, different, or adjacent beam direction, timing, or distance in the respective dimension based on the index values for the respective set of indices in that dimension.

Multi-dimensional beam information may thus be indicated to a receiving device via a configuration of a channel measurement resource set 505. The described techniques may provide for improved communication reliability, reduced overhead, and reduced latency as compared with systems in which explicit signaling is used to convey absolute or relative beam information for each channel measurement resource.

FIG. 6 illustrates an example of a multi-dimensional channel measurement resource configuration 600 that supports multi-dimensional channel measurement resource configuration in accordance with one or more aspects of the present disclosure. The multi-dimensional channel measurement resource configuration 600 may implement or be implemented by aspects of the wireless communications systems 100 and 200 described with reference to FIGS. 1 and 2. For example, the multi-dimensional channel measurement resource configuration 600 illustrates an example of control signaling that configures a channel measurement resource set 605 including channel measurement resources (e.g., SSBs) to that are each associated with two or more dimensions. The control signaling may be transmitted by a transmitting network entity to a receiving network entity, where each network entity may represent an example of a network entity, a UE, a base station, a CU, a DU, an RU, or any combination thereof, as described with reference to FIGS. 1-5.

The transmitting network entity may transmit control signaling including an IE 610 to configure the channel measurement resource set 605. In the example of FIG. 6, the channel measurement resource set 605 may be configured to include 32 SSB resources. Each SSB resource may be associated with or assigned to a respective SSB index (e.g., SSB #0 through SSB #31). Techniques described herein provide for control signaling that may indicate, via a configuration of the channel measurement resource set 605, multi-dimensional information for each channel measurement resource of the set. For example, the IE 610 illustrated in FIG. 6 represents an example format of an IE 610 that may be used to configure the channel measurement resource set 605 and indicate parameters for mapping the channel measurement resources within the channel measurement resource set 605 to indices or IDs in multiple dimensions.

The transmitting network entity may transmit the control signaling including the IE 610 based on a capability of a receiving network entity to support a multi-dimensional channel measurement resource configuration, which may be indicated via a capability message, as described with reference to FIG. 2. In some aspects, the multi-dimensional channel measurement resource configuration illustrated in FIG. 6 may correspond to a third type of multi-dimensional channel measurement resource configuration, and the capability message may indicate support for the third type of the multi-dimensional channel measurement resource configuration.

Although SSB resources are illustrated in FIG. 6, it is to be understood that the described techniques may be applied for configurations of channel measurement resource sets 605 that include any type of resources, including CSI-RS resources, SRS, resources, or any other type of resources. In some aspects, the SSB indices illustrated in FIG. 6 may represent examples of CSI-RS IDs, or some other type of ID or index value. For example, an IE may configure an NZP-CSI-RS resource set, or some other type of resource set. The SSB indices may be referred to as channel measurement resource IDs herein. Additionally, or alternatively, although 32 resources are illustrated as being included in the channel measurement resource set 605, it is to be understood that any quantity of resources may be configured in the channel measurement resource set 605.

The IE 610 may indicate the channel measurement resource IDs for the channel measurement resources in a first order (e.g., via the CSI-SSB-ResourceList mapped to the SSB-Index in FIG. 6), which may be referred to as serially indicated indices. Each channel measurement resource in the set may be associated with a respective channel measurement resource ID. The IE 610 may additionally or alternatively indicate a first parameter (N1) and a second parameter (N2). The IE 610 may assign integer values to the first and second parameters. The value of the first parameter may indicate a first quantity of a first set of indices 620 in a first dimension (e.g., a size of the first dimension). The value of the second parameter may indicate a second quantity of a second set of indices 625 in a second dimension (e.g., a size of the second dimension).

The integer values assigned to the first and second parameters may each be selected from a respective range of values between a maximum and minimum value for each dimension (e.g., INTEGER (N1min-SSB,N1max-SSB), where N1min-SSB may represent a minimum quantity of indices in the first dimension and N1max-SSB may represent a maximum quantity of indices in the first dimension). The receiving network entity may receive a configuration of the indicatable ranges of N1 and N2 via control signaling, or the receiving network entity may determine the indicatable ranges based on the channel measurement resource set 605 (e.g., the ranges may be configured per resource set or separately defined for SSB and CSI-RS resource sets). In some aspects, the receiving network entity may determine the values of the first and second parameters based on the IE 610 or based on the channel measurement resource set 605 or both.

A receiving network entity may receive the IE 610 and map the channel measurement resources of the indicated channel measurement resource set 605 to the first set of indices 620 in the first dimension and the second set of indices 625 in the second dimension based on the first and second parameters and the configuration. In some aspects, the mapping may be done implicitly by the receiving network entity based on the multi-dimensional channel measurement resource configuration, a capability of the receiving network entity, or both. The receiving network entity may thus map a one-dimensional set of serial indicated channel measurement resource IDs to a multi-dimensional format that may be indicated in parallel. Such mapping may be referred to as serial to parallel (S2P) mapping or converting.

To map the channel measurement resources to multiple dimensions, the receiving network entity may determine a total quantity of channel measurement resources in the channel measurement resource set 605 based on the values of N1 and N2. A total quantity of the channel measurement resources may be equal to a product of N1 and N2. In the example of FIG. 6, the value of N1 may be eight, the value of N2 may be four, and the total quantity of channel measurement resources may be 32.

The receiving network entity may group the total quantity of channel measurement resources into one or more groups. A quantity of groups may be equal to the value of N2 (e.g., four groups in the example of FIG. 6), and each group may include N1 channel measurement resources (e.g., eight in the example of FIG. 6). The receiving network entity may map each channel measurement resource in each group to a respective first index of the first set of indices 620 (e.g., indices zero through seven in the example of FIG. 6). The receiving network entity may sequentially map each group to a respective second index of the second set of indices 625 in the second dimension (e.g., indices zero through four in the example of FIG. 6). Thus, each channel measurement resource may be assigned to a unique pair of a first index of the first set of indices 620 in the first dimension and a second index of the second set of indices 625 in the second dimension.

That is, the channel measurement resources within the range of zero to N1 (e.g., a first group) may be implicitly considered as having the indices zero to N1−1 within the first set of indices 620 in the first dimension and a first index (e.g., zero) within the second set of indices 625 in the second dimension. The channel measurement resources within the range of N1+1 to 2 (N1) (e.g., a second group) may be implicitly considered as having the indices zero to N1−1 within the first set of indices 620 and a second index (e.g., one) within the second set of indices 625. Similarly, the channel measurement resources within the range of (N2−1)N1+1 to N1×N2 (e.g., an N2th group) may be implicitly considered as having the indices zero to N1−1 within the first set of indices 620 and a last index corresponding to the value of N2−1 (e.g., index three in the example of FIG. 6) within the second set of indices 625.

A two-dimensional table is illustrated in FIG. 6 to show a conceptual mapping of the channel measurement resources to the first set of indices 620 in a first dimension (e.g., represented by an x-direction or horizontal direction in FIG. 6) and the second set of indices 625 in a second dimension (e.g., represented by a y-direction or vertical direction in FIG. 6) as described herein. However, it is to be understood that the table is a conceptual illustration for clarity purposes, and the receiving network entity may not generate an actual table or gird. Rather, the receiving network entity may be configured to implicitly assign index values to each channel measurement resource based on the information indicated via the IE 610, and the index values may be representative of information in multiple dimensions.

In the example of FIG. 6, the SSB #0 may be mapped to an index of zero in the first dimension and an index of zero in the second dimension. The SSB #15, for example, may be mapped to an index of seven in the first dimension and an index of one in the second dimension. As illustrated in FIG. 6, no more than one channel measurement resource may be mapped to both a same first index and a same second index at a time (e.g., each resource is mapped to a unique index pair).

The IE 610 may indicate the channel measurement resources of the channel measurement resource set 605 in a first, presenting order (e.g., an order indicated by the cis-SSB-ResourceList). The presenting order may or may not correspond to an ascending or descending order of values of the channel measurement IDs. In some aspects, the presenting order may be random. The receiving device may, in some aspects, map the channel measurement resource IDs to the first set of indices 620 and the second set of indices 625 based on the presenting order.

Additionally, or alternatively, the receiving network entity may reorder or re-index the channel measurement resources within the channel measurement resource set 605 according to an ascending or descending order of values of the corresponding channel measurement resource IDs (e.g., as indicated via an original serving cell configuration) before mapping the channel measurement resources to the first and second dimensions. For example, the receiving network entity map the channel measurement resource IDs to the first set of indices 620, the second set of indices 625, or both in a second order different than the first order presented by the IE 610. In some aspects, the second order may be based on the ascending or descending order of the values of the channel measurement IDs.

In an example, the channel measurement resource set 605 may present the SSBs in a first order, such as SSB #2, SSB #3, SSB #4, SSB #1, or some other random order (not illustrated in FIG. 6). The receiving network entity may reorder the SSBs to a second order, such as SSB #1, SSB #2, SSB #3, SSB #4 (e.g., an ascending order) or SSB #4, SSB #3, SSB #2, SSB #1 (e.g., a descending order) before mapping the SSBs to the first set of indices 620 and the second set of indices 625.

The IE 610 may thus configure a channel measurement resource set 605 and indicate parameters for a receiving network entity to map a list the channel measurement resources to a first set of indices 620 in a first dimension and a second set of indices 625 in a second dimension. Although two dimensions are illustrated in FIG. 6, it is to be understood that the described techniques may be applied for any quantity of two or more dimensions. For example, the IE 610 may indicate three parameters each associated with a respective dimension, four parameters, or some other quantity of parameters for a receiving network entity to use to map the channel measurement resource set 605 to multi-dimensional information (e.g., a conceptual multi-dimensional table). In such cases, a respective threshold quantity or range of values of the parameters may be configured for each dimension.

Each dimension may correspond to one of an azimuth dimension, an elevation dimension, a distance or range dimension, a time dimension, or any combination thereof. The respective dimensional information conveyed by each set of indices in each respective dimension may correspond to one of a relative direction of a beam in the azimuthal dimension, a relative direction of a beam in the elevational dimension, a relative distance associated with the channel measurement resource, or a relative timing of the channel measurement resource in the time dimension.

The receiving network entity may assume or determine, based on receiving the multi-dimensional channel measurement resource configuration via the IE 610 and a capability of the receiving network entity, relative dimensional information for beams used to transmit each channel measurement resource of the channel measurement resource set 605. For example, the receiving network entity may determine, based on an indication via the control signaling, a configuration, a rule, or any combination thereof, that the first dimension is associated with directional information indicating a direction of a transmit beam in a spatial dimension (e.g., an elevation or azimuth direction).

The receiving network entity may determine that if two different channel measurement resources are mapped to identical indices of the first set of indices 620 in the first dimension, a beam direction of the corresponding beams in the spatial dimension will also be identical. For example, a beam direction of beams corresponding to the SSB #0, the SSB #8, the SSB #16, and the SSB #24 may be the same based on the SSB #0, the SSB #8, the SSB #16, and the SSB #24 each being mapped to the same first index of zero in the first set of indices 620 in the first dimension.

The receiving network entity may determine that if two different channel measurement resources are mapped to different indices of the first set of indices 620 in the first dimension, the beam directions of the corresponding beams in the spatial dimension will be different. For example, a beam direction of beams corresponding to the SSB #0 through SSB #7 may be different based on the SSBs #0-#7 being mapped to different first index values of the first set of indices 620 in the first dimension. In some aspects, if the indices are adjacent, the receiving network entity may determine that the beam directions in the spatial dimension may also be adjacent. For example, the beams corresponding to the SSB #0 and the SSB #1 may be at adjacent angles or within adjacent angular ranges in the first dimension, as described with reference to FIG. 3. In some aspects, a beam direction or other dimensional information in the spatial dimension may be scaled based on an ascending or descending order of the first set of indices 620.

The receiving network entity may determine that the other dimensions are each associated with one of a spatial dimension, a time dimension, a direction dimension, or some other dimension based on the control signaling, configuration, or rule indicated by a transmitting network entity. The receiving network entity may similarly determine whether two or more channel measurement resources correspond to the same, different, or adjacent beam direction, timing, or distance in the respective dimension based on the index values for the respective set of indices in that dimension.

Multi-dimensional beam information may thus be indicated to a receiving device via a configuration of a channel measurement resource set 605. The described techniques may provide for improved communication reliability, reduced overhead, and reduced latency as compared with systems in which explicit signaling is used to convey absolute or relative beam information for each channel measurement resource.

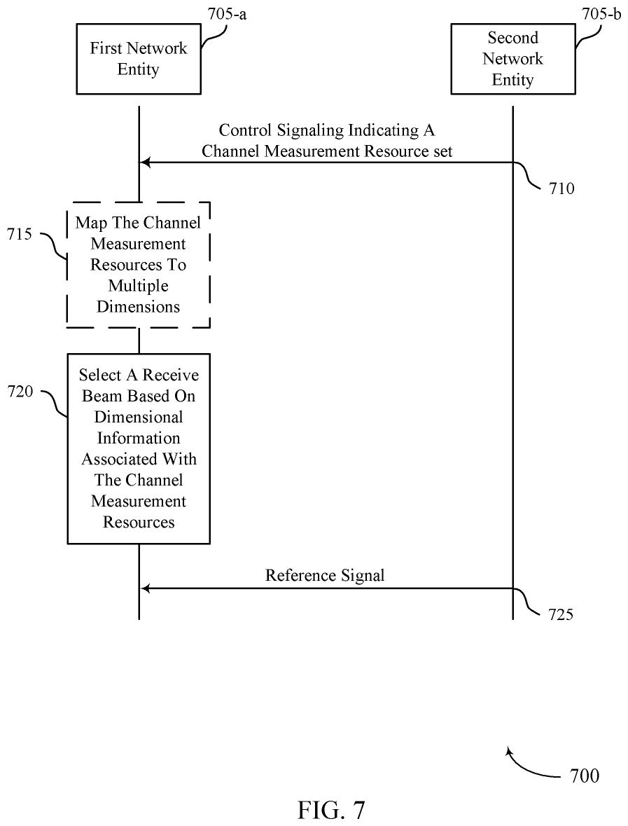

FIG. 7 illustrates an example of a process flow 700 that supports multi-dimensional channel measurement resource configuration in accordance with one or more aspects of the present disclosure. The process flow 700 may implement or be implemented by aspects of the wireless communications systems 100 and 200 or the multi-dimensional channel measurement resource configurations 400, 500, or 600. For example, the process flow 700 illustrates communications between a first network entity 705-a and a second network entity 705-b, which may represent aspects of corresponding devices or network nodes as described with reference to FIGS. 2-6. The network entities 705 may be UEs, base stations, IAB nodes, RUs, CUs, DUs, any other network node, or any combination thereof.

In the following description of the process flow 700, the operations between the first network entity 705-a and the second network entity 705-b may be performed in different orders or at different times. Some operations may also be left out of the process flow 700, or other operations may be added. Although the first network entity 705-a and the second network entity 705-b are shown performing the operations of the process flow 700, some aspects of some operations may also be performed by one or more other wireless devices.

At 710, the second network entity 705-b may transmit, to the first network entity 705-a, control signaling indicating a channel measurement resource set including channel measurement resources that are each associated with two or more dimensions. The control signaling may represent an example of the control signaling described with reference to FIGS. 2-6. For example, in some aspects, the control signaling may indicate a channel measurement resource set that includes multiple channel measurement resources each indexed according to at least a first set of indices associated with a first dimension and a second set of indices associated with a second dimension different than the first dimension, as described with reference to FIGS. 4 and 5.

At 715, in some aspects, the first network entity 705-a may map the channel measurement resources to indices in multiple dimensions. For example, if the control signaling indicates the channel measurement resource set, but does not indicate the respective sets of indices, the first network entity 705-a may map the channel measurement resources to at least a first set of indices associated with a first dimension and a second set of indices associated with a second dimension different than the first dimension, as described with reference to FIG. 6. The first network entity 705-a may perform the channel measurement resource mapping based on a first parameter that indicates a first quantity of the set of first indices (e.g., N1) and a second parameter that indicates a second quantity of the set of second indices (e.g., N2). The first and second parameters may be indicated via control signaling or the first network entity 705-a may determine the first and second parameters based on the channel measurement resource set.

Irrespective of whether the control signaling maps the channel measurement resources to the indices, or the first network entity 705-a performs the mapping, for each channel measurement resource of the channel measurement resource set, a respective first index of the first set of indices may indicate respective first dimensional information associated with the channel measurement resource in the first dimension and a respective second index of the second set of indices may indicate respective second dimensional information associated with the channel measurement resource in the second dimension.

In some aspects, at least one of the respective first dimensional information and the respective second dimensional information may correspond to a direction of a transmit beam within one or more spatial dimensions associated with the channel measurement resource. The respective first dimensional information and the respective second dimensional information may each correspond to one of a relative direction of a beam in an azimuthal dimension, a relative direction of a beam in an elevational dimension, a relative distance associated with the channel measurement resource, or a relative timing of the channel measurement resource in a time dimension. In some aspects, the control signaling may indicate channel measurement resources associated with more than two dimensions, and the resources may be mapped to more than two sets of indices accordingly, as described with reference to FIGS. 2-6.

At 720, the first network entity 705-a may select a receive beam to receive a reference signal transmitted on at least one of the channel measurement resources based on dimensional information associated with the channel measurement resources. For example, the first network entity 705-a may select the receive beam based on the respective first dimensional information and the respective second dimensional information associated with at least one of the channel measurement resources.

At 725, the second network entity 705-b may transmit the reference signal to the first network entity 705-a using a transmit beam that is based on the respective first dimensional information and the respective second dimensional information associated with at least one of the channel measurement resources. The first network entity 705-a may receive the reference signal using the selected receive beam. In some aspects, the first network entity 705-a may measure the reference signal and transmit a beam report to the second network entity 705-b as part of a beam management procedure. The first network entity 705-a and the second network entity 705-b may thereby utilize the relative dimensional information indicated via the multi-dimensional channel measurement resource set to perform a reliable and efficient beam management procedure.

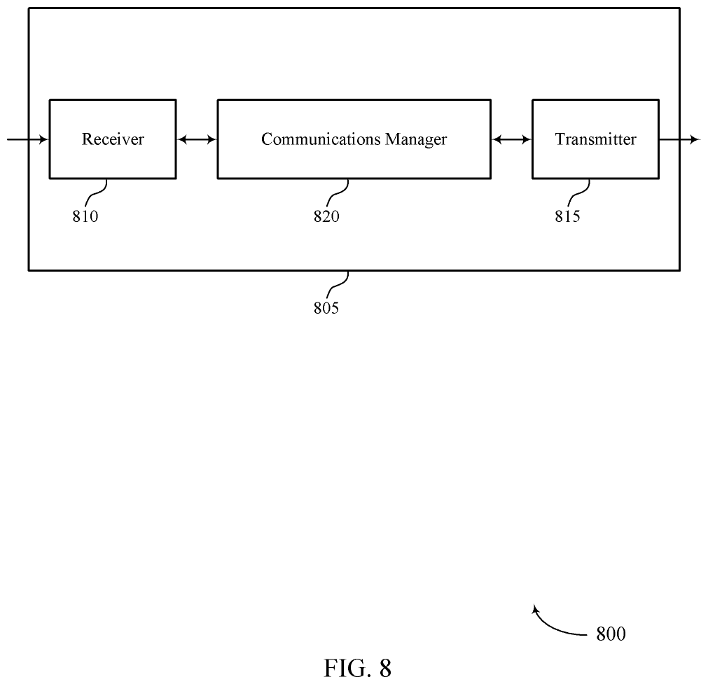

FIG. 8 shows a block diagram 800 of a device 805 that supports multi-dimensional channel measurement resource configuration in accordance with one or more aspects of the present disclosure. The device 805 may be an example of aspects of a UE 115 or a network entity 105 as described herein. The device 805 may include a receiver 810, a transmitter 815, and a communications manager 820. The device 805 may also include a processor. Each of these components may be in communication with one another (e.g., via one or more buses).

The receiver 810 may provide a means for receiving information such as packets, user data, control information, or any combination thereof associated with various information channels (e.g., control channels, data channels, information channels related to multi-dimensional channel measurement resource configuration). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to multi-dimensional channel measurement resource configuration). In some examples, the transmitter 815 may be co-located with a receiver 810 in a transceiver module. The transmitter 815 may utilize a single antenna or a set of multiple antennas.

The communications manager 820, the receiver 810, the transmitter 815, or various combinations thereof or various components thereof may be examples of means for performing various aspects of multi-dimensional channel measurement resource configuration as described herein. For example, the communications manager 820, the receiver 810, the transmitter 815, or various combinations or components thereof may support a method for performing one or more of the functions described herein.

In some examples, the communications manager 820, the receiver 810, the transmitter 815, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 820, the receiver 810, the transmitter 815, or various combinations or components thereof may be implemented in code (e.g., as communications management software or firmware) executed by a processor. If implemented in code executed by a processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

For example, the communications manager 820 may be configured as or otherwise support a means for receiving control signaling that indicates a channel measurement resource set including a set of multiple channel measurement resources each indexed according to at least a set of multiple first indices associated with a first dimension and a set of multiple second indices associated with a second dimension different than the first dimension. For each channel measurement resource of the set of multiple channel measurement resources, a respective first index of the set of multiple first indices may indicate respective first dimensional information associated with the channel measurement resource in the first dimension and a respective second index of the set of multiple second indices may indicate respective second dimensional information associated with the channel measurement resource in the second dimension. In some aspects, at least one of the respective first dimensional information and the respective second dimensional information may indicate a direction of a transmit beam within one or more spatial dimensions associated with the channel measurement resource. The communications manager 820 may be configured as or otherwise support a means for selecting a receive beam to receive a reference signal transmitted on at least one of the set of multiple channel measurement resources, selection of the receive beam based on the respective first dimensional information and the respective second dimensional information associated with at least one of the set of multiple channel measurement resources. The communications manager 820 may be configured as or otherwise support a means for receiving the reference signal using the receive beam.

In some other aspects, the communications manager 820 may be configured as or otherwise support a means for receiving control signaling that indicates a channel measurement resource set including a set of multiple channel measurement resources that are each associated with two or more dimensions. The communications manager 820 may be configured as or otherwise support a means for mapping the set of multiple channel measurement resources to at least a set of multiple first indices associated with a first dimension and a set of multiple second indices associated with a second dimension different than the first dimension based on a first parameter that indicates a first quantity of the set of multiple first indices and a second parameter that indicates a second quantity of the set of multiple second indices. In some aspects, for each channel measurement resource of the set of multiple channel measurement resources, a respective first index of the set of multiple first indices may indicate respective first dimensional information associated with the channel measurement resource in the first dimension and a respective second index of the set of multiple second indices may indicate respective second dimensional information associated with the channel measurement resource in the second dimension. In some aspects, at least one of the respective first dimensional information and the respective second dimensional information may correspond to a direction of a transmit beam within one or more spatial dimension associated with the channel measurement resource. The communications manager 820 may be configured as or otherwise support a means for selecting a receive beam to receive a reference signal transmitted on at least one of the set of multiple channel measurement resources, selection of the receive beam based on the respective first dimensional information and the respective second dimensional information associated with at least one of the set of multiple channel measurement resources. The communications manager 820 may be configured as or otherwise support a means for receiving the reference signal using the receive beam.

Additionally, or alternatively, the communications manager 820 may support wireless communications at a second network entity in accordance with examples as disclosed herein. For example, the communications manager 820 may be configured as or otherwise support a means for transmitting control signaling that indicates a channel measurement resource set including a set of multiple channel measurement resources each indexed according to at least a set of multiple first indices associated with a first dimension and a set of multiple second indices associated with a second dimension different than the first dimension. In some aspects, for each channel measurement resource of the set of multiple channel measurement resources, a respective first index of the set of multiple first indices may indicate respective first dimensional information associated with the channel measurement resource in the first dimension and a respective second index of the set of multiple second indices may indicate respective second dimensional information associated with the channel measurement resource in the second dimension. In some aspects, at least one of the respective first dimensional information and the respective second dimensional information may indicate a direction of a transmit beam within one or more spatial dimensions associated with the channel measurement resource. The communications manager 820 may be configured as or otherwise support a means for transmitting a reference signal on at least one of the set of multiple channel measurement resources using a transmit beam that is based on the respective first dimensional information and the respective second dimensional information associated with at least one of the set of multiple channel measurement resources.

By including or configuring the communications manager 820 in accordance with examples as described herein, the device 805 (e.g., a processor controlling or otherwise coupled with the receiver 810, the transmitter 815, the communications manager 820, or a combination thereof) may support techniques for reduced processing, reduced power consumption, and more efficient utilization of communication resources. For example, by configuring a multi-dimensional channel measurement resource set, a processor of the device 805 (e.g., a network entity) may reduce processing complexity, power consumption, and overhead as compared with systems in which the processor may generate and transmit an indication of absolute or relative beam information for each resource in each dimension.

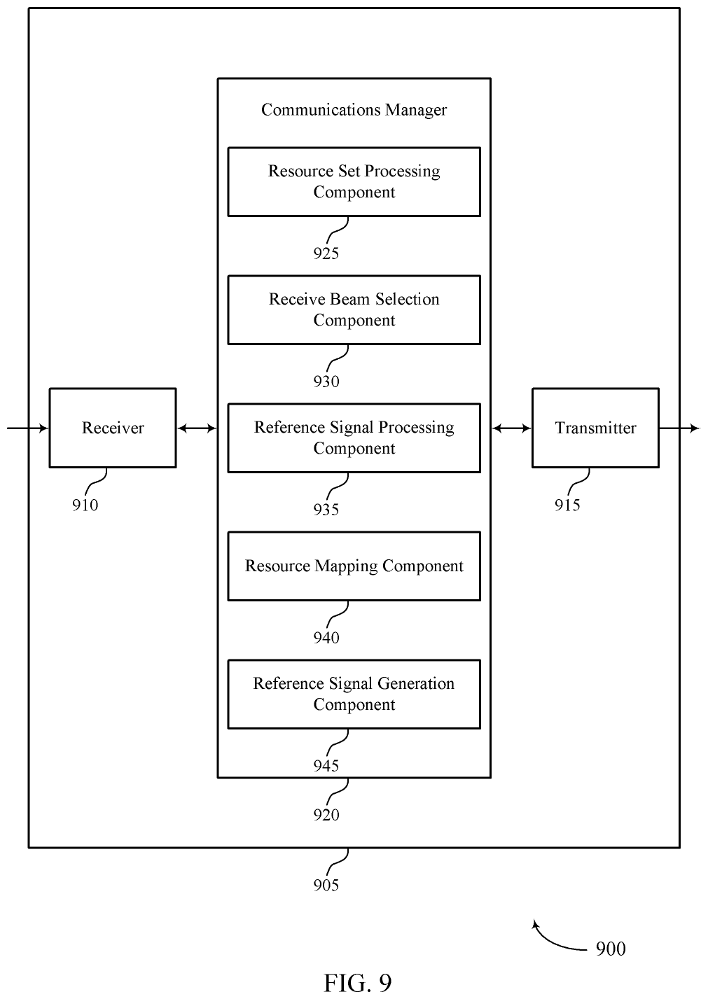

FIG. 9 shows a block diagram 900 of a device 905 that supports multi-dimensional channel measurement resource configuration in accordance with one or more aspects of the present disclosure. The device 905 may be an example of aspects of a device 805, a UE 115, or a network entity 105 as described herein. The device 905 may include a receiver 910, a transmitter 915, and a communications manager 920. The device 905 may also include a processor. Each of these components may be in communication with one another (e.g., via one or more buses).

The receiver 910 may provide a means for receiving information such as packets, user data, control information, or any combination thereof associated with various information channels (e.g., control channels, data channels, information channels related to multi-dimensional channel measurement resource configuration). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to multi-dimensional channel measurement resource configuration). In some examples, the transmitter 915 may be co-located with a receiver 910 in a transceiver module. The transmitter 915 may utilize a single antenna or a set of multiple antennas.

The device 905, or various components thereof, may be an example of means for performing various aspects of multi-dimensional channel measurement resource configuration as described herein. For example, the communications manager 920 may include a resource set processing component 925, a receive beam selection component 930, a reference signal processing component 935, a resource mapping component 940, a reference signal generation component 945, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The resource set processing component 925 may be configured as or otherwise support a means for receiving control signaling that indicates a channel measurement resource set including a set of multiple channel measurement resources each indexed according to at least a set of multiple first indices associated with a first dimension and a set of multiple second indices associated with a second dimension different than the first dimension. In some aspects, for each channel measurement resource of the set of multiple channel measurement resources, a respective first index of the set of multiple first indices may indicate respective first dimensional information associated with the channel measurement resource in the first dimension and a respective second index of the set of multiple second indices may indicate respective second dimensional information associated with the channel measurement resource in the second dimension. In some aspects, at least one of the respective first dimensional information and the respective second dimensional information may indicate a direction of a transmit beam within one or more spatial dimensions associated with the channel measurement resource. The receive beam selection component 930 may be configured as or otherwise support a means for selecting a receive beam to receive a reference signal transmitted on at least one of the set of multiple channel measurement resources, selection of the receive beam based on the respective first dimensional information and the respective second dimensional information associated with at least one of the set of multiple channel measurement resources. The reference signal processing component 935 may be configured as or otherwise support a means for receiving the reference signal using the receive beam.

The resource set processing component 925 may be configured as or otherwise support a means for receiving control signaling that indicates a channel measurement resource set including a set of multiple channel measurement resources that are each associated with two or more dimensions. The resource mapping component 940 may be configured as or otherwise support a means for mapping the set of multiple channel measurement resources to at least a set of multiple first indices associated with a first dimension and a set of multiple second indices associated with a second dimension different than the first dimension based on a first parameter that indicates a first quantity of the set of multiple first indices and a second parameter that indicates a second quantity of the set of multiple second indices. In some aspects, for each channel measurement resource of the set of multiple channel measurement resources, a respective first index of the set of multiple first indices may indicate respective first dimensional information associated with the channel measurement resource in the first dimension and a respective second index of the set of multiple second indices may indicate respective second dimensional information associated with the channel measurement resource in the second dimension. In some aspects, at least one of the respective first dimensional information and the respective second dimensional information may correspond to a direction of a transmit beam within one or more spatial dimension associated with the channel measurement resource. The receive beam selection component 930 may be configured as or otherwise support a means for selecting a receive beam to receive a reference signal transmitted on at least one of the set of multiple channel measurement resources, selection of the receive beam based on the respective first dimensional information and the respective second dimensional information associated with at least one of the set of multiple channel measurement resources. The reference signal processing component 935 may be configured as or otherwise support a means for receiving the reference signal using the receive beam.

Additionally, or alternatively, the communications manager 920 may support wireless communications at a second network entity in accordance with examples as disclosed herein. The resource set processing component 925 may be configured as or otherwise support a means for transmitting control signaling that indicates a channel measurement resource set including a set of multiple channel measurement resources each indexed according to at least a set of multiple first indices associated with a first dimension and a set of multiple second indices associated with a second dimension different than the first dimension. In some aspects, for each channel measurement resource of the set of multiple channel measurement resources, a respective first index of the set of multiple first indices may indicate respective first dimensional information associated with the channel measurement resource in the first dimension and a respective second index of the set of multiple second indices may indicate respective second dimensional information associated with the channel measurement resource in the second dimension. In some aspects, at least one of the respective first dimensional information and the respective second dimensional information may indicate a direction of a transmit beam within one or more spatial dimensions associated with the channel measurement resource. The reference signal generation component 945 may be configured as or otherwise support a means for transmitting a reference signal on at least one of the set of multiple channel measurement resources using a transmit beam that is based on the respective first dimensional information and the respective second dimensional information associated with at least one of the set of multiple channel measurement resources.

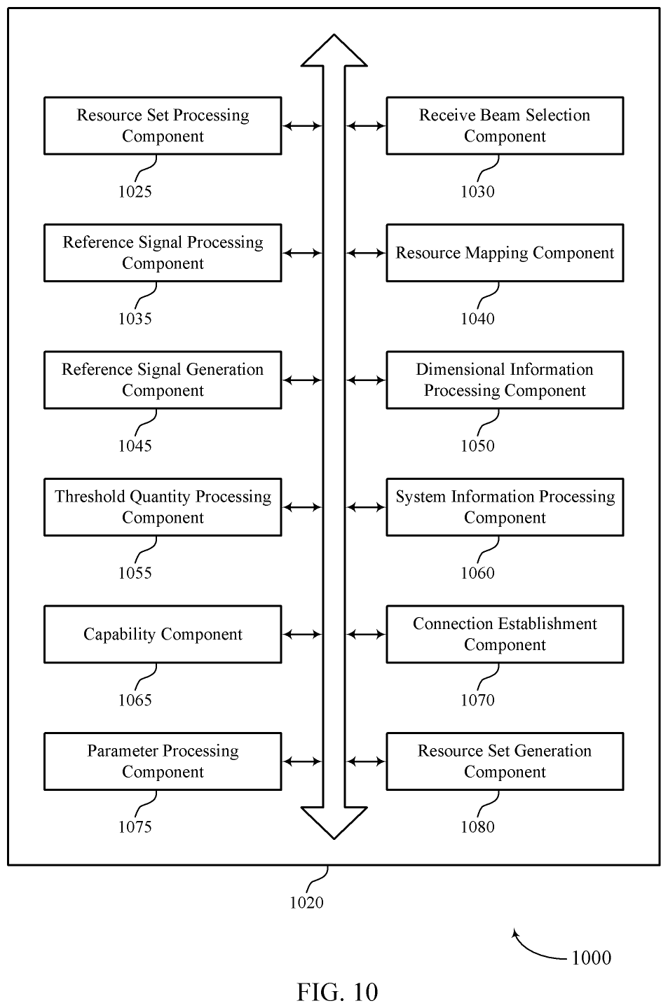

FIG. 10 shows a block diagram 1000 of a communications manager 1020 that supports multi-dimensional channel measurement resource configuration in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of multi-dimensional channel measurement resource configuration as described herein. For example, the communications manager 1020 may include a resource set processing component 1025, a receive beam selection component 1030, a reference signal processing component 1035, a resource mapping component 1040, a reference signal generation component 1045, a dimensional information processing component 1050, a threshold quantity processing component 1055, a system information processing component 1060, a capability component 1065, a connection establishment component 1070, a parameter processing component 1075, a resource set generation component 1080, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The resource set processing component 1025 may be configured as or otherwise support a means for receiving control signaling that indicates a channel measurement resource set including a set of multiple channel measurement resources each indexed according to at least a set of multiple first indices associated with a first dimension and a set of multiple second indices associated with a second dimension different than the first dimension. In some aspects, for each channel measurement resource of the set of multiple channel measurement resources, a respective first index of the set of multiple first indices may indicate respective first dimensional information associated with the channel measurement resource in the first dimension and a respective second index of the set of multiple second indices may indicate respective second dimensional information associated with the channel measurement resource in the second dimension. In some aspects, at least one of the respective first dimensional information and the respective second dimensional information may indicate a direction of a transmit beam within one or more spatial dimensions associated with the channel measurement resource. The receive beam selection component 1030 may be configured as or otherwise support a means for selecting a receive beam to receive a reference signal transmitted on at least one of the set of multiple channel measurement resources, selection of the receive beam based on the respective first dimensional information and the respective second dimensional information associated with at least one of the set of multiple channel measurement resources. The reference signal processing component 1035 may be configured as or otherwise support a means for receiving the reference signal using the receive beam.

In some examples, the dimensional information processing component 1050 may be configured as or otherwise support a means for determining the first dimensional information and the second dimensional information for each of the set of multiple channel measurement resources based on an indication of each channel measurement resource in a respective element of the channel measurement resource set, each element of the channel measurement resource set being mapped to a unique combination of a first index of the set of multiple first indices and a second index of the set of multiple second indices, a total quantity of elements indicated via the channel measurement resource set being based on a product of a first quantity of the set of multiple first indices indicated by the channel measurement resource set and a second quantity of the set of multiple second indices indicated by the channel measurement resource set.

In some examples, the total quantity of elements indicated via the channel measurement resource set may include a first subset of elements that includes respective indications for the set of multiple channel measurement resources and a second subset of elements that are null.

In some examples, to support receiving the control signaling, the resource set processing component 1025 may be configured as or otherwise support a means for receiving, via the control signaling, a set of multiple channel measurement resource IDs in a first order, each channel measurement resource ID associated with a respective channel measurement resource of the set of multiple channel measurement resources, where the channel measurement resource set may map each channel measurement resource ID of the set of multiple channel measurement resource IDs to a unique pair of a first index of the set of multiple first indices in the first dimension and a second index of the set of multiple second indices in the second dimension. In some examples, the channel measurement resource set maps the set of multiple channel measurement resource IDs to the set of multiple first indices in a second order different than the first order. In some examples, the second order is based on an ascending or a descending order of values of the set of multiple channel measurement resource IDs.

In some examples, the threshold quantity processing component 1055 may be configured as or otherwise support a means for receiving an RRC signal that indicates a first threshold quantity and a second threshold quantity, where a first quantity of the set of multiple first indices is less than or equal to the first threshold quantity and a second quantity of the set of multiple second indices is less than or equal to the second threshold quantity. In some examples, the threshold quantity processing component 1055 may be configured as or otherwise support a means for determining a first threshold quantity and a second threshold quantity based on the channel measurement resource set, where a first quantity of the set of multiple first indices is less than or equal to the first threshold quantity and a second quantity of the set of multiple second indices is less than or equal to the second threshold quantity.

In some examples, the channel measurement resource is mapped to a same first index in the first dimension as a second channel measurement resource of the set of multiple channel measurement resources, and the dimensional information processing component 1050 may be configured as or otherwise support a means for determining that the respective first dimensional information in the first dimension is applicable to both the channel measurement resource and the second channel measurement resource based on the channel measurement resource and the second channel measurement resource being mapped to the same first index.

In some examples, the channel measurement resource is mapped to a different first index in the first dimension than a second channel measurement resource of the set of multiple channel measurement resources, and the dimensional information processing component 1050 may be configured as or otherwise support a means for determining that the respective first dimensional information in the first dimension is applicable to the channel measurement resource and determining that different first dimensional information in the first dimension is applicable to a second channel measurement resource based on the channel measurement resource being mapped to the different first index than the second channel measurement resource in the first dimension.

In some examples, the system information processing component 1060 may be configured as or otherwise support a means for receiving system information that indicates a multi-dimensional channel measurement resource configuration. In some examples, the capability component 1065 may be configured as or otherwise support a means for transmitting a message that indicates a capability of the first network entity to support the multi-dimensional channel measurement resource configuration based on the system information, where receiving the control signaling that indicates the channel measurement resource set may be based on the capability of the first network entity.

In some examples, the connection establishment component 1070 may be configured as or otherwise support a means for establishing a connection via a serving cell associated with a multi-dimensional channel measurement resource configuration. In some examples, the capability component 1065 may be configured as or otherwise support a means for transmitting a message that indicates a capability of the first network entity to support the multi-dimensional channel measurement resource configuration based on establishing the connection via the serving cell, where receiving the control signaling that indicates the channel measurement resource set may be based on the capability of the first network entity.

In some examples, the respective first dimensional information and the respective second dimensional information each include one of a relative direction of a beam in an azimuthal dimension, a relative direction of a beam in an elevational dimension, a relative distance associated with the channel measurement resource, or a relative timing of the channel measurement resource in a time dimension. In some examples, the set of multiple channel measurement resources includes SSB resources, CSI-RS resources, or both. In some examples, to support receiving the control signaling, the resource set processing component 1025 may be configured as or otherwise support a means for receiving RRC signaling, where an IE of the RRC signaling indicates the channel measurement resource set.

In some examples, the resource set processing component 1025 may be configured as or otherwise support a means for receiving control signaling that indicates a channel measurement resource set including a set of multiple channel measurement resources that are each associated with two or more dimensions. The resource mapping component 1040 may be configured as or otherwise support a means for mapping the set of multiple channel measurement resources to at least a set of multiple first indices associated with a first dimension and a set of multiple second indices associated with a second dimension different than the first dimension based on a first parameter that indicates a first quantity of the set of multiple first indices and a second parameter that indicates a second quantity of the set of multiple second indices. In some aspects, for each channel measurement resource of the set of multiple channel measurement resources, a respective first index of the set of multiple first indices may indicate respective first dimensional information associated with the channel measurement resource in the first dimension and a respective second index of the set of multiple second indices may indicate respective second dimensional information associated with the channel measurement resource in the second dimension. In some aspects, at least one of the respective first dimensional information and the respective second dimensional information may indicate a direction of a transmit beam within one or more spatial dimensions associated with the channel measurement resource. In some examples, the receive beam selection component 1030 may be configured as or otherwise support a means for selecting a receive beam to receive a reference signal transmitted on at least one of the set of multiple channel measurement resources, selection of the receive beam based on the respective first dimensional information and the respective second dimensional information associated with at least one of the set of multiple channel measurement resources. In some examples, the reference signal processing component 1035 may be configured as or otherwise support a means for receiving the reference signal using the receive beam.

In some examples, to support receiving the control signaling, the parameter processing component 1075 may be configured as or otherwise support a means for receiving, via the control signaling, an indication of the first parameter and the second parameter. In some examples, the parameter processing component 1075 may be configured as or otherwise support a means for determining the first parameter and the second parameter based on the channel measurement resource set.

In some examples, the resource set processing component 1025 may be configured as or otherwise support a means for determining a total quantity of the set of multiple channel measurement resources in the channel measurement resource set based on a product of the first quantity and the second quantity.

In some examples, to support mapping, the resource mapping component 1040 may be configured as or otherwise support a means for grouping the total quantity of the set of multiple channel measurement resources into the second quantity of groups, each group including the first quantity of channel measurement resources. In some examples, to support mapping, the resource mapping component 1040 may be configured as or otherwise support a means for mapping each channel measurement resource of the first quantity of channel measurement resources in each group to a respective first index of the set of multiple first indices. In some examples, to support mapping, the resource mapping component 1040 may be configured as or otherwise support a means for mapping the first quantity of channel measurement resources in each group to a same second index of the set of multiple second indices, where each group may be sequentially mapped to a different second index of the set of multiple second indices.

In some examples, the channel measurement resource set indicates a set of multiple channel measurement resource IDs associated with the set of multiple channel measurement resources in a first order, and the resource mapping component 1040 may be configured as or otherwise support a means for reordering the set of multiple channel measurement resource IDs from the first order to a second order, the second order based on an ascending or a descending order of values of the set of multiple channel measurement resource IDs, where the mapping is based on the second order of the set of multiple channel measurement resource IDs.

In some examples, the channel measurement resource is mapped to a same first index in the first dimension as a second channel measurement resource of the set of multiple channel measurement resources, and the dimensional information processing component 1050 may be configured as or otherwise support a means for determining that the respective first dimensional information in the first dimension is applicable to both the channel measurement resource and the second channel measurement resource based on the channel measurement resource and the second channel measurement resource being mapped to the same first index.

In some examples, the channel measurement resource is mapped to a different first index in the first dimension than a second channel measurement resource of the set of multiple channel measurement resources, and the dimensional information processing component 1050 may be configured as or otherwise support a means for determining that the respective first dimensional information in the first dimension is applicable to the channel measurement resource and determining that different first dimensional information in the first dimension is applicable to a second channel measurement resource based on the channel measurement resource being mapped to the different first index than the second channel measurement resource in the first dimension.

In some examples, the system information processing component 1060 may be configured as or otherwise support a means for receiving system information that indicates a multi-dimensional channel measurement resource configuration. In some examples, the capability component 1065 may be configured as or otherwise support a means for transmitting a message that indicates a capability of the first network entity to support the multi-dimensional channel measurement resource configuration based on the system information, where receiving the control signaling that indicates the channel measurement resource set is based on the capability of the first network entity.

In some examples, the connection establishment component 1070 may be configured as or otherwise support a means for establishing a connection via a serving cell associated with a multi-dimensional channel measurement resource configuration. In some examples, the capability component 1065 may be configured as or otherwise support a means for transmitting a message that indicates a capability of the first network entity to support the multi-dimensional channel measurement resource configuration based on establishing the connection via the serving cell, where receiving the control signaling that indicates the channel measurement resource set is based on the capability of the first network entity.

In some examples, the respective first dimensional information and the respective second dimensional information each include one of a relative direction of a beam in an azimuthal dimension, a relative direction of a beam in an elevational dimension, a relative distance associated with the channel measurement resource, or a relative timing of the channel measurement resource in a time dimension.

Additionally, or alternatively, the communications manager 1020 may support wireless communications at a second network entity in accordance with examples as disclosed herein. In some examples, the resource set processing component 1025 may be configured as or otherwise support a means for transmitting control signaling that indicates a channel measurement resource set including a set of multiple channel measurement resources each indexed according to at least a set of multiple first indices associated with a first dimension and a set of multiple second indices associated with a second dimension different than the first dimension. In some aspects, for each channel measurement resource of the set of multiple channel measurement resources, a respective first index of the set of multiple first indices may indicate respective first dimensional information associated with the channel measurement resource in the first dimension and a respective second index of the set of multiple second indices may indicate respective second dimensional information associated with the channel measurement resource in the second dimension. In some aspects, at least one of the respective first dimensional information and the respective second dimensional information may indicate a direction of a transmit beam within one or more spatial dimensions associated with the channel measurement resource. The reference signal generation component 1045 may be configured as or otherwise support a means for transmitting a reference signal on at least one of the set of multiple channel measurement resources using a transmit beam that is based on the respective first dimensional information and the respective second dimensional information associated with at least one of the set of multiple channel measurement resources.

In some examples, a total quantity of entries indicated via the channel measurement resource set may be based on product of a first quantity of the set of multiple first indices indicated by the channel measurement resource set and a second quantity of the set of multiple second indices indicated by the channel measurement resource set. In some examples, a subset of elements of the total quantity of elements of the channel measurement resource set may each include an indication of a respective channel measurement resource ID associated with a respective channel measurement resource of the set of multiple channel measurement resources. In some examples, remaining elements of the total quantity of elements of the channel measurement resource set may be null. In some examples, each element of the channel measurement resource set may be mapped to a unique combination of a first index of the set of multiple first indices and a second index of the set of multiple second indices.

In some examples, to support transmitting the control signaling, the resource set generation component 1080 may be configured as or otherwise support a means for transmitting, via the control signaling, a set of multiple channel measurement resource IDs in a first order, each channel measurement resource ID associated with a respective channel measurement resource of the set of multiple channel measurement resources, where the channel measurement resource set maps each channel measurement resource ID of the set of multiple channel measurement resource IDs to a unique pair of a first index of the set of multiple first indices in the first dimension and a second index of the set of multiple second indices in the second dimension.

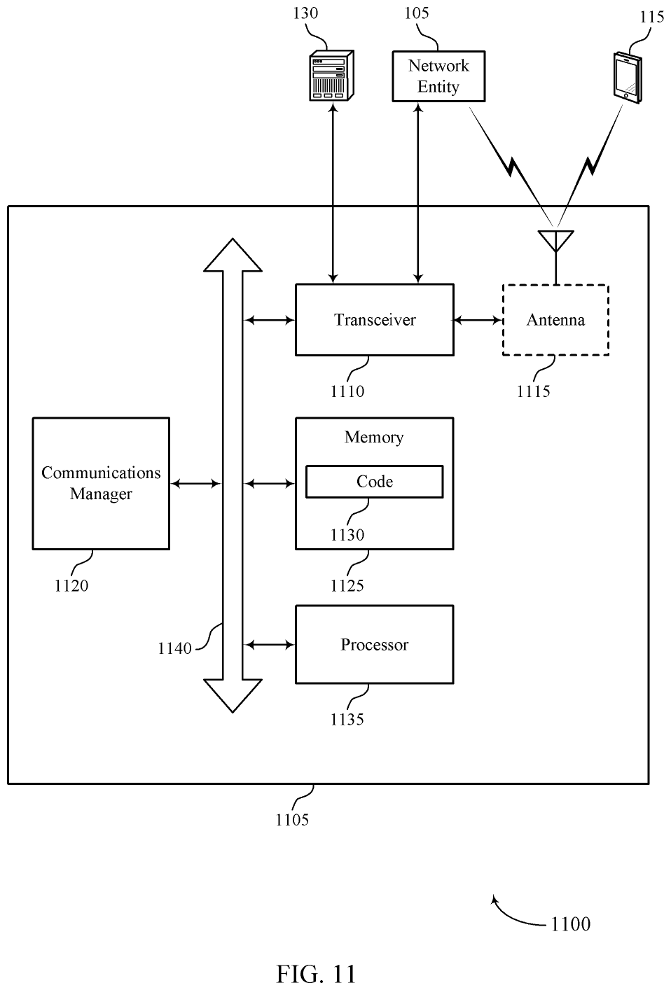

FIG. 11 shows a diagram of a system 1100 including a device 1105 that supports multi-dimensional channel measurement resource configuration in accordance with one or more aspects of the present disclosure. The device 1105 may be an example of or include the components of a device 805, a device 905, or a network entity 105 as described herein. The device 1105 may communicate with one or more network entities 105, one or more UEs 115, or any combination thereof, which may include communications over one or more wired interfaces, over one or more wireless interfaces, or any combination thereof. The device 1105 may include components that support outputting and obtaining communications, such as a communications manager 1120, a transceiver 1110, an antenna 1115, a memory 1125, code 1130, and a processor 1135. These components may be in electronic communication or otherwise coupled (e.g., operatively, communicatively, functionally, electronically, electrically) via one or more buses (e.g., a bus 1140).

The transceiver 1110 may support bi-directional communications via wired links, wireless links, or both as described herein. In some examples, the transceiver 1110 may include a wired transceiver and may communicate bi-directionally with another wired transceiver. Additionally, or alternatively, in some examples, the transceiver 1110 may include a wireless transceiver and may communicate bi-directionally with another wireless transceiver. In some examples, the device 1105 may include one or more antennas 1115, which may be capable of transmitting or receiving wireless transmissions (e.g., concurrently). The transceiver 1110 may also include a modem to modulate signals, to provide the modulated signals for transmission (e.g., by one or more antennas 1115, by a wired transmitter), to receive modulated signals (e.g., from one or more antennas 1115, from a wired receiver), and to demodulate signals. The transceiver 1110, or the transceiver 1110 and one or more antennas 1115 or wired interfaces, where applicable, may be an example of a transmitter 815, a transmitter 915, a receiver 810, a receiver 910, or any combination thereof or component thereof, as described herein. In some examples, the transceiver may be operable to support communications via one or more communications links (e.g., a communication link 125, a backhaul communication link 120, a midhaul communication link 162, a fronthaul communication link 168).

The memory 1125 may include random access memory (RAM) and read-only memory (ROM). The memory 1125 may store computer-readable, computer-executable code 1130 including instructions that, when executed by the processor 1135, cause the device 1105 to perform various functions described herein. The code 1130 may be stored in a non-transitory computer-readable medium such as system memory or another type of memory. In some cases, the code 1130 may not be directly executable by the processor 1135 but may cause a computer (e.g., when compiled and executed) to perform functions described herein. In some cases, the memory 1125 may contain, among other things, a basic input/output (I/O) system (BIOS) which may control basic hardware or software operation such as the interaction with peripheral components or devices.

The processor 1135 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1135 may be configured to operate a memory array using a memory controller. In some other cases, a memory controller may be integrated into the processor 1135. The processor 1135 may be configured to execute computer-readable instructions stored in a memory (e.g., the memory 1125) to cause the device 1105 to perform various functions (e.g., functions or tasks supporting multi-dimensional channel measurement resource configuration). For example, the device 1105 or a component of the device 1105 may include a processor 1135 and memory 1125 coupled with the processor 1135, the processor 1135 and memory 1125 configured to perform various functions described herein. The processor 1135 may be an example of a cloud-computing platform (e.g., one or more physical nodes and supporting software such as operating systems, virtual machines, or container instances) that may host the functions (e.g., by executing code 1130) to perform the functions of the device 1105.

In some examples, a bus 1140 may support communications of (e.g., within) a protocol layer of a protocol stack. In some examples, a bus 1140 may support communications associated with a logical channel of a protocol stack (e.g., between protocol layers of a protocol stack), which may include communications performed within a component of the device 1105, or between different components of the device 1105 that may be co-located or located in different locations (e.g., where the device 1105 may refer to a system in which one or more of the communications manager 1120, the transceiver 1110, the memory 1125, the code 1130, and the processor 1135 may be located in one of the different components or divided between different components).

In some examples, the communications manager 1120 may manage aspects of communications with a core network 130 (e.g., via one or more wired or wireless backhaul links). For example, the communications manager 1120 may manage the transfer of data communications for client devices, such as one or more UEs 115. In some examples, the communications manager 1120 may manage communications with other network entities 105, and may include a controller or scheduler for controlling communications with UEs 115 in cooperation with other network entities 105. In some examples, the communications manager 1120 may support an X2 interface within an LTE/LTE-A wireless communications network technology to provide communication between network entities 105.

For example, the communications manager 1120 may be configured as or otherwise support a means for receiving control signaling that indicates a channel measurement resource set including a set of multiple channel measurement resources each indexed according to at least a set of multiple first indices associated with a first dimension and a set of multiple second indices associated with a second dimension different than the first dimension. In some aspects, for each channel measurement resource of the set of multiple channel measurement resources, a respective first index of the set of multiple first indices may indicate respective first dimensional information associated with the channel measurement resource in the first dimension and a respective second index of the set of multiple second indices may indicate respective second dimensional information associated with the channel measurement resource in the second dimension. In some aspects, at least one of the respective first dimensional information and the respective second dimensional information may indicate a direction of a transmit beam within one or more spatial dimensions associated with the channel measurement resource. The communications manager 1120 may be configured as or otherwise support a means for selecting a receive beam to receive a reference signal transmitted on at least one of the set of multiple channel measurement resources, selection of the receive beam based on the respective first dimensional information and the respective second dimensional information associated with at least one of the set of multiple channel measurement resources. The communications manager 1120 may be configured as or otherwise support a means for receiving the reference signal using the receive beam.

For example, the communications manager 1120 may be configured as or otherwise support a means for receiving control signaling that indicates a channel measurement resource set including a set of multiple channel measurement resources that are each associated with two or more dimensions. The communications manager 1120 may be configured as or otherwise support a means for mapping the set of multiple channel measurement resources to at least a set of multiple first indices associated with a first dimension and a set of multiple second indices associated with a second dimension different than the first dimension based on a first parameter that indicates a first quantity of the set of multiple first indices and a second parameter that indicates a second quantity of the set of multiple second indices. In some aspects, for each channel measurement resource of the set of multiple channel measurement resources, a respective first index of the set of multiple first indices may indicate respective first dimensional information associated with the channel measurement resource in the first dimension and a respective second index of the set of multiple second indices may indicate respective second dimensional information associated with the channel measurement resource in the second dimension. In some aspects, at least one of the respective first dimensional information and the respective second dimensional information may indicate a direction of a transmit beam within one or more spatial dimensions associated with the channel measurement resource. The communications manager 1120 may be configured as or otherwise support a means for selecting a receive beam to receive a reference signal transmitted on at least one of the set of multiple channel measurement resources, selection of the receive beam based on the respective first dimensional information and the respective second dimensional information associated with at least one of the set of multiple channel measurement resources. The communications manager 1120 may be configured as or otherwise support a means for receiving the reference signal using the receive beam.

Additionally, or alternatively, the communications manager 1120 may support wireless communications at a second network entity in accordance with examples as disclosed herein. For example, the communications manager 1120 may be configured as or otherwise support a means for transmitting control signaling that indicates a channel measurement resource set including a set of multiple channel measurement resources each indexed according to at least a set of multiple first indices associated with a first dimension and a set of multiple second indices associated with a second dimension different than the first dimension. In some aspects, for each channel measurement resource of the set of multiple channel measurement resources, a respective first index of the set of multiple first indices may indicate respective first dimensional information associated with the channel measurement resource in the first dimension and a respective second index of the set of multiple second indices may indicate respective second dimensional information associated with the channel measurement resource in the second dimension. In some aspects, at least one of the respective first dimensional information and the respective second dimensional information may indicate a direction of a transmit beam within one or more spatial dimensions associated with the channel measurement resource. The communications manager 1120 may be configured as or otherwise support a means for transmitting a reference signal on at least one of the set of multiple channel measurement resources using a transmit beam that is based on the respective first dimensional information and the respective second dimensional information associated with at least one of the set of multiple channel measurement resources.

By including or configuring the communications manager 1120 in accordance with examples as described herein, the device 1105 may support techniques for improved communication reliability, reduced latency, reduced power consumption, more efficient utilization of communication resources, improved coordination between devices, and improved utilization of processing capability. For example, the device 1105 may transmit or receive a multi-dimensional channel measurement resource configuration that may map a channel measurement resource set to dimensional information. By indicating or receiving an indication of relative beam information via the channel measurement resource set configuration, the device 1105 may refrain from transmitting or receiving additional signaling to indicate the beam information, which may reduce processing, power consumption, and overhead. Additionally, or alternatively, the device 1105 may perform more efficient and reliable beam management procedures based on the relative beam information indicated via the configuration.

In some examples, the communications manager 1120 may be configured to perform various operations (e.g., receiving, obtaining, monitoring, outputting, transmitting) using or otherwise in cooperation with the transceiver 1110, the one or more antennas 1115 (e.g., where applicable), or any combination thereof. Although the communications manager 1120 is illustrated as a separate component, in some examples, one or more functions described with reference to the communications manager 1120 may be supported by or performed by the processor 1135, the memory 1125, the code 1130, the transceiver 1110, or any combination thereof. For example, the code 1130 may include instructions executable by the processor 1135 to cause the device 1105 to perform various aspects of multi-dimensional channel measurement resource configuration as described herein, or the processor 1135 and the memory 1125 may be otherwise configured to perform or support such operations.

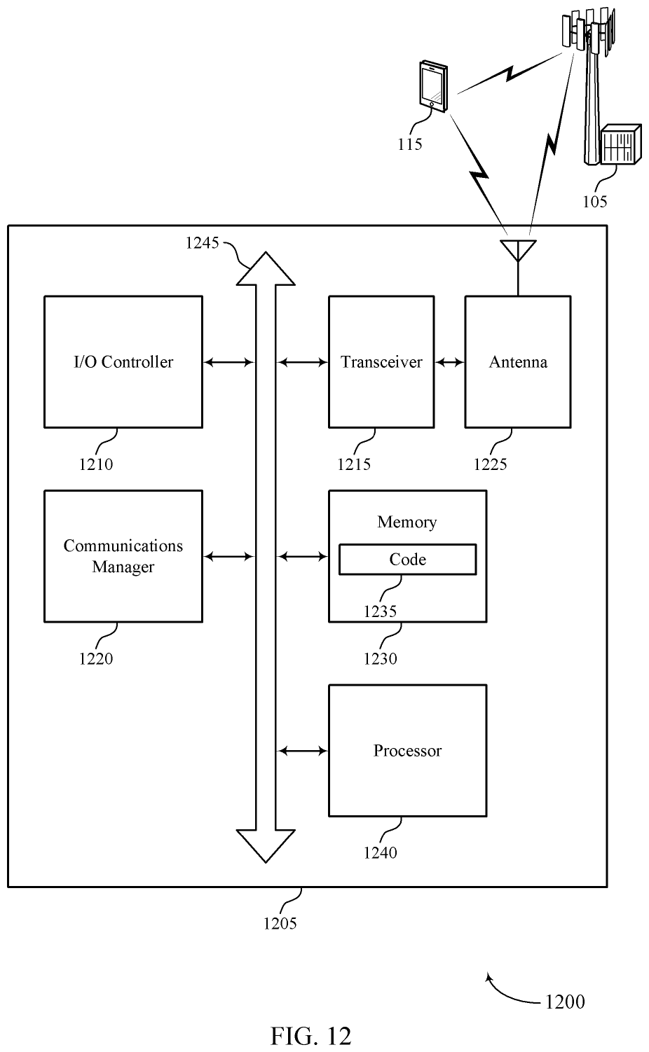

FIG. 12 shows a diagram of a system 1200 including a device 1205 that supports multi-dimensional channel measurement resource configuration in accordance with one or more aspects of the present disclosure. The device 1205 may be an example of or include the components of a device 805, a device 905, or a UE 115 as described herein. The device 1205 may communicate (e.g., wirelessly) with one or more network entities 105, one or more UEs 115, or any combination thereof. The device 1205 may include components for bi-directional voice and data communications including components for transmitting and receiving communications, such as a communications manager 1220, an I/O controller 1210, a transceiver 1215, an antenna 1225, a memory 1230, code 1235, and a processor 1240. These components may be in electronic communication or otherwise coupled (e.g., operatively, communicatively, functionally, electronically, electrically) via one or more buses (e.g., a bus 1245).

The I/O controller 1210 may manage input and output signals for the device 1205. The I/O controller 1210 may also manage peripherals not integrated into the device 1205. In some cases, the I/O controller 1210 may represent a physical connection or port to an external peripheral. In some cases, the I/O controller 1210 may utilize an operating system such as iOS®, ANDROID®, MS-DOS®, MS-WINDOWS®, OS/2®, UNIX®, LINUX®, or another known operating system. Additionally, or alternatively, the I/O controller 1210 may represent or interact with a modem, a keyboard, a mouse, a touchscreen, or a similar device. In some cases, the I/O controller 1210 may be implemented as part of a processor, such as the processor 1240. In some cases, a user may interact with the device 1205 via the I/O controller 1210 or via hardware components controlled by the I/O controller 1210.

In some cases, the device 1205 may include a single antenna 1225. However, in some other cases, the device 1205 may have more than one antenna 1225, which may be capable of concurrently transmitting or receiving multiple wireless transmissions. The transceiver 1215 may communicate bi-directionally, via the one or more antennas 1225, wired, or wireless links as described herein. For example, the transceiver 1215 may represent a wireless transceiver and may communicate bi-directionally with another wireless transceiver. The transceiver 1215 may also include a modem to modulate the packets, to provide the modulated packets to one or more antennas 1225 for transmission, and to demodulate packets received from the one or more antennas 1225. The transceiver 1215, or the transceiver 1215 and one or more antennas 1225, may be an example of a transmitter 815, a transmitter 915, a receiver 810, a receiver 910, or any combination thereof or component thereof, as described herein.

The memory 1230 may include RAM and ROM. The memory 1230 may store computer-readable, computer-executable code 1235 including instructions that, when executed by the processor 1240, cause the device 1205 to perform various functions described herein. The code 1235 may be stored in a non-transitory computer-readable medium such as system memory or another type of memory. In some cases, the code 1235 may not be directly executable by the processor 1240 but may cause a computer (e.g., when compiled and executed) to perform functions described herein. In some cases, the memory 1230 may contain, among other things, a BIOS which may control basic hardware or software operation such as the interaction with peripheral components or devices.

The processor 1240 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1240 may be configured to operate a memory array using a memory controller. In some other cases, a memory controller may be integrated into the processor 1240. The processor 1240 may be configured to execute computer-readable instructions stored in a memory (e.g., the memory 1230) to cause the device 1205 to perform various functions (e.g., functions or tasks supporting multi-dimensional channel measurement resource configuration). For example, the device 1205 or a component of the device 1205 may include a processor 1240 and memory 1230 coupled with or to the processor 1240, the processor 1240 and memory 1230 configured to perform various functions described herein.

For example, the communications manager 1220 may be configured as or otherwise support a means for receiving control signaling that indicates a channel measurement resource set including a set of multiple channel measurement resources each indexed according to at least a set of multiple first indices associated with a first dimension and a set of multiple second indices associated with a second dimension different than the first dimension. In some aspects, for each channel measurement resource of the set of multiple channel measurement resources, a respective first index of the set of multiple first indices may indicate respective first dimensional information associated with the channel measurement resource in the first dimension and a respective second index of the set of multiple second indices may indicate respective second dimensional information associated with the channel measurement resource in the second dimension. In some aspects, at least one of the respective first dimensional information and the respective second dimensional information may indicate a direction of a transmit beam within one or more spatial dimensions associated with the channel measurement resource. The communications manager 1220 may be configured as or otherwise support a means for selecting a receive beam to receive a reference signal transmitted on at least one of the set of multiple channel measurement resources, selection of the receive beam based on the respective first dimensional information and the respective second dimensional information associated with at least one of the set of multiple channel measurement resources. The communications manager 1220 may be configured as or otherwise support a means for receiving the reference signal using the receive beam.

For example, the communications manager 1220 may be configured as or otherwise support a means for receiving control signaling that indicates a channel measurement resource set including a set of multiple channel measurement resources that are each associated with two or more dimensions. The communications manager 1220 may be configured as or otherwise support a means for mapping the set of multiple channel measurement resources to at least a set of multiple first indices associated with a first dimension and a set of multiple second indices associated with a second dimension different than the first dimension based on a first parameter that indicates a first quantity of the set of multiple first indices and a second parameter that indicates a second quantity of the set of multiple second indices. In some aspects, for each channel measurement resource of the set of multiple channel measurement resources, a respective first index of the set of multiple first indices may indicate respective first dimensional information associated with the channel measurement resource in the first dimension and a respective second index of the set of multiple second indices may indicate respective second dimensional information associated with the channel measurement resource in the second dimension. In some aspects, at least one of the respective first dimensional information and the respective second dimensional information may indicate a direction of a transmit beam within one or more spatial dimensions associated with the channel measurement resource. The communications manager 1220 may be configured as or otherwise support a means for selecting a receive beam to receive a reference signal transmitted on at least one of the set of multiple channel measurement resources, selection of the receive beam based on the respective first dimensional information and the respective second dimensional information associated with at least one of the set of multiple channel measurement resources. The communications manager 1220 may be configured as or otherwise support a means for receiving the reference signal using the receive beam.

Additionally, or alternatively, the communications manager 1220 may support wireless communications at a second network entity in accordance with examples as disclosed herein. For example, the communications manager 1220 may be configured as or otherwise support a means for transmitting control signaling that indicates a channel measurement resource set including a set of multiple channel measurement resources each indexed according to at least a set of multiple first indices associated with a first dimension and a set of multiple second indices associated with a second dimension different than the first dimension. In some aspects, for each channel measurement resource of the set of multiple channel measurement resources, a respective first index of the set of multiple first indices may indicate respective first dimensional information associated with the channel measurement resource in the first dimension and a respective second index of the set of multiple second indices may indicate respective second dimensional information associated with the channel measurement resource in the second dimension. In some aspects, at least one of the respective first dimensional information and the respective second dimensional information may indicate a direction of a transmit beam within one or more spatial dimensions associated with the channel measurement resource. The communications manager 1220 may be configured as or otherwise support a means for transmitting a reference signal on at least one of the set of multiple channel measurement resources using a transmit beam that is based on the respective first dimensional information and the respective second dimensional information associated with at least one of the set of multiple channel measurement resources.

By including or configuring the communications manager 1220 in accordance with examples as described herein, the device 1205 may support techniques for improved communication reliability, reduced latency, reduced power consumption, more efficient utilization of communication resources, improved coordination between devices, and improved utilization of processing capability. For example, the device 1205 may transmit or receive a multi-dimensional channel measurement resource configuration that may map a channel measurement resource set to dimensional information. By indicating or receiving an indication of relative beam information via the channel measurement resource set configuration, the device 1205 may refrain from transmitting or receiving additional signaling to indicate the beam information, which may reduce processing, power consumption, and overhead. Additionally, or alternatively, the device 1205 may perform more efficient and reliable beam management procedures based on the relative beam information indicated via the configuration.

In some examples, the communications manager 1220 may be configured to perform various operations (e.g., receiving, monitoring, transmitting) using or otherwise in cooperation with the transceiver 1215, the one or more antennas 1225, or any combination thereof. Although the communications manager 1220 is illustrated as a separate component, in some examples, one or more functions described with reference to the communications manager 1220 may be supported by or performed by the processor 1240, the memory 1230, the code 1235, or any combination thereof. For example, the code 1235 may include instructions executable by the processor 1240 to cause the device 1205 to perform various aspects of multi-dimensional channel measurement resource configuration as described herein, or the processor 1240 and the memory 1230 may be otherwise configured to perform or support such operations.

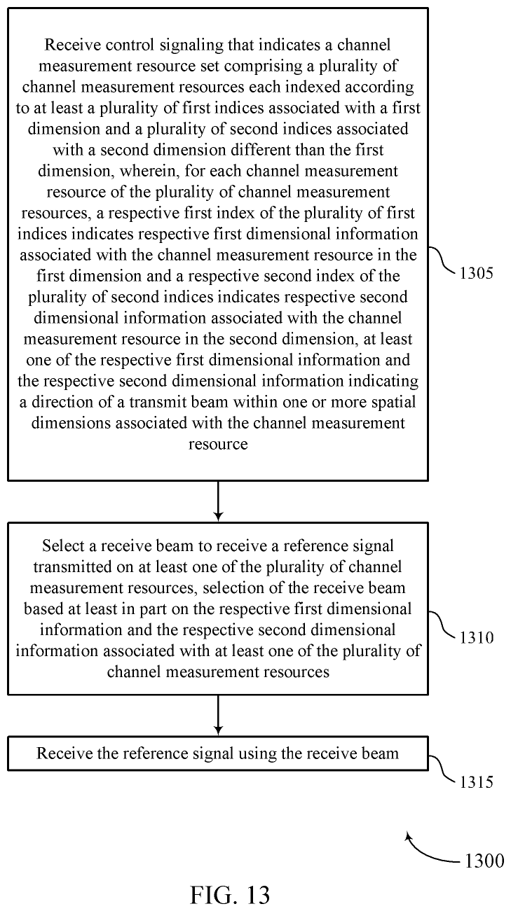

FIG. 13 shows a flowchart illustrating a method 1300 that supports multi-dimensional channel measurement resource configuration in accordance with one or more aspects of the present disclosure. The operations of the method 1300 may be implemented by a network entity or a UE or its components as described herein. For example, the operations of the method 1300 may be performed by a network entity or a UE 115 as described with reference to FIGS. 1 through 12. In some examples, a network entity or a UE may execute a set of instructions to control the functional elements of the network entity or the UE to perform the described functions. Additionally, or alternatively, the network entity or the UE may perform aspects of the described functions using special-purpose hardware.

At 1305, the method may include receiving control signaling that indicates a channel measurement resource set including a set of multiple channel measurement resources each indexed according to at least a set of multiple first indices associated with a first dimension and a set of multiple second indices associated with a second dimension different than the first dimension. In some aspects, for each channel measurement resource of the set of multiple channel measurement resources, a respective first index of the set of multiple first indices may indicate respective first dimensional information associated with the channel measurement resource in the first dimension and a respective second index of the set of multiple second indices may indicate respective second dimensional information associated with the channel measurement resource in the second dimension. In some aspects, at least one of the respective first dimensional information and the respective second dimensional information may indicate a direction of a transmit beam within one or more spatial dimensions associated with the channel measurement resource. The operations of 1305 may be performed in accordance with examples as disclosed herein. In some examples, aspects of the operations of 1305 may be performed by a resource set processing component 1025 as described with reference to FIG. 10.

At 1310, the method may include selecting a receive beam to receive a reference signal transmitted on at least one of the set of multiple channel measurement resources, selection of the receive beam based on the respective first dimensional information and the respective second dimensional information associated with at least one of the set of multiple channel measurement resources. The operations of 1310 may be performed in accordance with examples as disclosed herein. In some examples, aspects of the operations of 1310 may be performed by a receive beam selection component 1030 as described with reference to FIG. 10.

At 1315, the method may include receiving the reference signal using the receive beam. The operations of 1315 may be performed in accordance with examples as disclosed herein. In some examples, aspects of the operations of 1315 may be performed by a reference signal processing component 1035 as described with reference to FIG. 10.

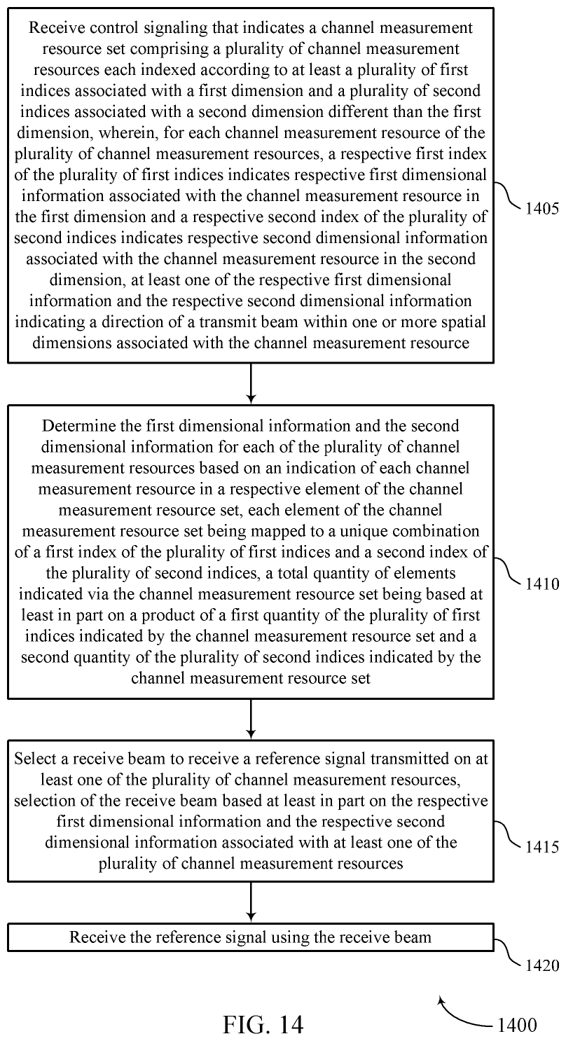

FIG. 14 shows a flowchart illustrating a method 1400 that supports multi-dimensional channel measurement resource configuration in accordance with one or more aspects of the present disclosure. The operations of the method 1400 may be implemented by a network entity or a UE or its components as described herein. For example, the operations of the method 1400 may be performed by a network entity or a UE 115 as described with reference to FIGS. 1 through 12. In some examples, a network entity or a UE may execute a set of instructions to control the functional elements of the network entity or the UE to perform the described functions. Additionally, or alternatively, the network entity or the UE may perform aspects of the described functions using special-purpose hardware.

At 1405, the method may include receiving control signaling that indicates a channel measurement resource set including a set of multiple channel measurement resources each indexed according to at least a set of multiple first indices associated with a first dimension and a set of multiple second indices associated with a second dimension different than the first dimension, where, for each channel measurement resource of the set of multiple channel measurement resources, a respective first index of the set of multiple first indices may indicate respective first dimensional information associated with the channel measurement resource in the first dimension and a respective second index of the set of multiple second indices may indicate respective second dimensional information associated with the channel measurement resource in the second dimension, at least one of the respective first dimensional information and the respective second dimensional information indicating a direction of a transmit beam within one or more spatial dimensions associated with the channel measurement resource. The operations of 1405 may be performed in accordance with examples as disclosed herein. In some examples, aspects of the operations of 1405 may be performed by a resource set processing component 1025 as described with reference to FIG. 10.

At 1410, the method may include determining the first dimensional information and the second dimensional information for each of the set of multiple channel measurement resources based on an indication of each channel measurement resource in a respective element of the channel measurement resource set, each element of the channel measurement resource set being mapped to a unique combination of a first index of the set of multiple first indices and a second index of the set of multiple second indices. In some aspects, a total quantity of elements indicated via the channel measurement resource set may be based on a product of a first quantity of the set of multiple first indices indicated by the channel measurement resource set and a second quantity of the plurality of second indices indicated by the channel measurement resource set. The operations of 1410 may be performed in accordance with examples as disclosed herein. In some examples, aspects of the operations of 1410 may be performed by a dimensional information processing component 1050 as described with reference to FIG. 10.

At 1415, the method may include selecting a receive beam to receive a reference signal transmitted on at least one of the set of multiple channel measurement resources, selection of the receive beam based on the respective first dimensional information and the respective second dimensional information associated with at least one of the set of multiple channel measurement resources. The operations of 1415 may be performed in accordance with examples as disclosed herein. In some examples, aspects of the operations of 1415 may be performed by a receive beam selection component 1030 as described with reference to FIG. 10.

At 1420, the method may include receiving the reference signal using the receive beam. The operations of 1420 may be performed in accordance with examples as disclosed herein. In some examples, aspects of the operations of 1420 may be performed by a reference signal processing component 1035 as described with reference to FIG. 10.

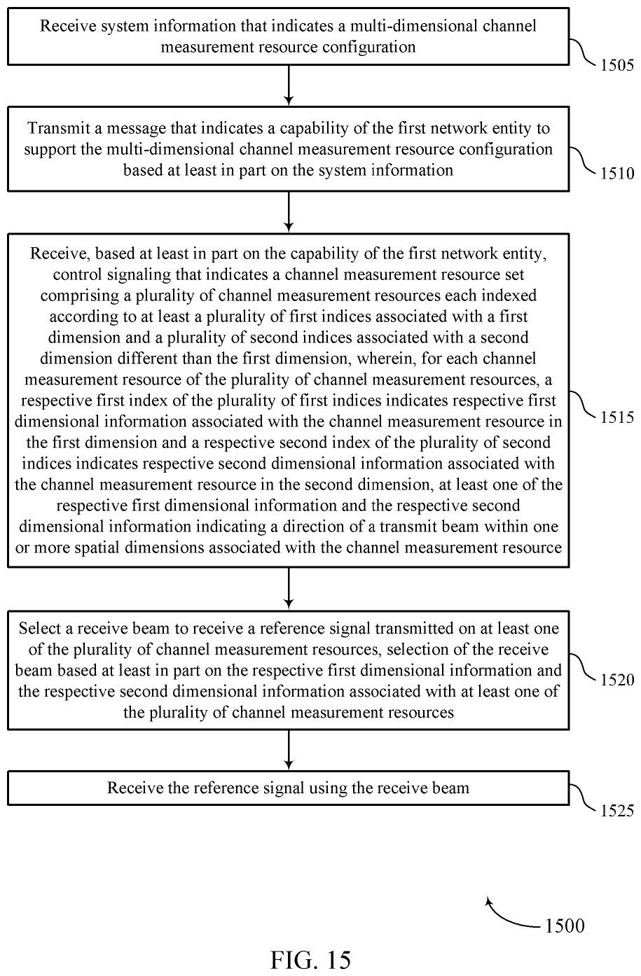

FIG. 15 shows a flowchart illustrating a method 1500 that supports multi-dimensional channel measurement resource configuration in accordance with one or more aspects of the present disclosure. The operations of the method 1500 may be implemented by a network entity or a UE or its components as described herein. For example, the operations of the method 1500 may be performed by a network entity or a UE 115 as described with reference to FIGS. 1 through 12. In some examples, a network entity or a UE may execute a set of instructions to control the functional elements of the network entity or the UE to perform the described functions. Additionally, or alternatively, the network entity or the UE may perform aspects of the described functions using special-purpose hardware.

At 1505, the method may include receiving system information that indicates a multi-dimensional channel measurement resource configuration. The operations of 1505 may be performed in accordance with examples as disclosed herein. In some examples, aspects of the operations of 1505 may be performed by a system information processing component 1060 as described with reference to FIG. 10.

At 1510, the method may include transmitting a message that indicates a capability of the first network entity to support the multi-dimensional channel measurement resource configuration based on the system information. The operations of 1510 may be performed in accordance with examples as disclosed herein. In some examples, aspects of the operations of 1510 may be performed by a capability component 1065 as described with reference to FIG. 10.

At 1515, the method may include receiving, based on the capability of the first network entity, control signaling that indicates a channel measurement resource set including a set of multiple channel measurement resources each indexed according to at least a set of multiple first indices associated with a first dimension and a set of multiple second indices associated with a second dimension different than the first dimension, where, for each channel measurement resource of the set of multiple channel measurement resources, a respective first index of the set of multiple first indices may indicate respective first dimensional information associated with the channel measurement resource in the first dimension and a respective second index of the set of multiple second may indicate indicates respective second dimensional information associated with the channel measurement resource in the second dimension, at least one of the respective first dimensional information and the respective second dimensional information indicating a direction of a transmit beam within one or more spatial dimensions associated with the channel measurement resource. The operations of 1515 may be performed in accordance with examples as disclosed herein. In some examples, aspects of the operations of 1515 may be performed by a resource set processing component 1025 as described with reference to FIG. 10.

At 1520, the method may include selecting a receive beam to receive a reference signal transmitted on at least one of the set of multiple channel measurement resources, selection of the receive beam based on the respective first dimensional information and the respective second dimensional information associated with at least one of the set of multiple channel measurement resources. The operations of 1520 may be performed in accordance with examples as disclosed herein. In some examples, aspects of the operations of 1520 may be performed by a receive beam selection component 1030 as described with reference to FIG. 10.

At 1525, the method may include receiving the reference signal using the receive beam. The operations of 1525 may be performed in accordance with examples as disclosed herein. In some examples, aspects of the operations of 1525 may be performed by a reference signal processing component 1035 as described with reference to FIG. 10.

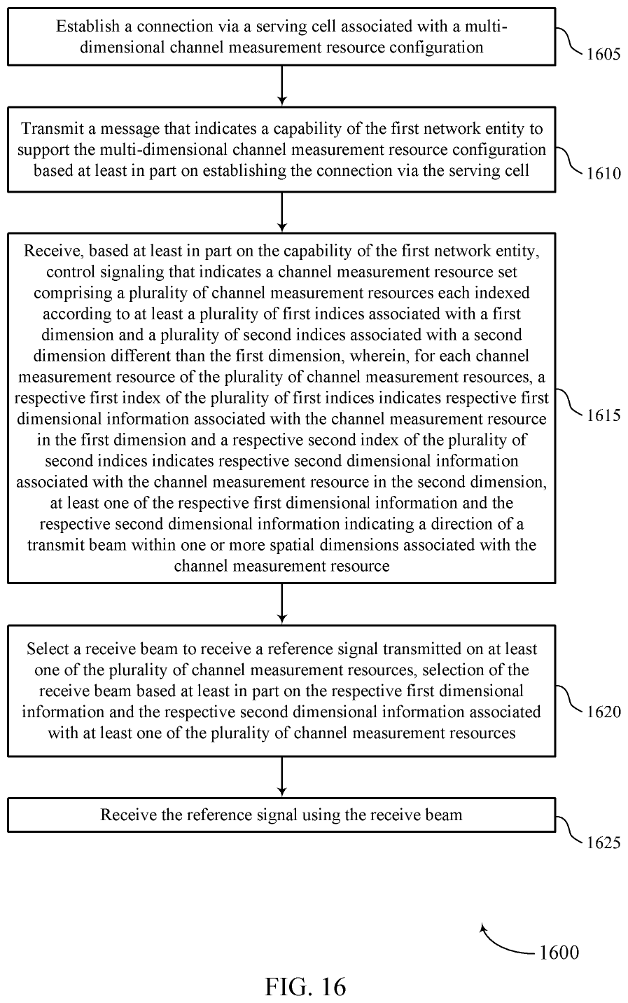

FIG. 16 shows a flowchart illustrating a method 1600 that supports multi-dimensional channel measurement resource configuration in accordance with one or more aspects of the present disclosure. The operations of the method 1600 may be implemented by a network entity or a UE or its components as described herein. For example, the operations of the method 1600 may be performed by a network entity or a UE 115 as described with reference to FIGS. 1 through 12. In some examples, a network entity or a UE may execute a set of instructions to control the functional elements of the network entity or the UE to perform the described functions. Additionally, or alternatively, the network entity or the UE may perform aspects of the described functions using special-purpose hardware.

At 1605, the method may include establishing a connection via a serving cell associated with a multi-dimensional channel measurement resource configuration. The operations of 1605 may be performed in accordance with examples as disclosed herein. In some examples, aspects of the operations of 1605 may be performed by a connection establishment component 1070 as described with reference to FIG. 10.

At 1610, the method may include transmitting a message that indicates a capability of the first network entity to support the multi-dimensional channel measurement resource configuration based on establishing the connection via the serving cell. The operations of 1610 may be performed in accordance with examples as disclosed herein. In some examples, aspects of the operations of 1610 may be performed by a capability component 1065 as described with reference to FIG. 10.

At 1615, the method may include receiving, based on the capability of the first network entity, control signaling that indicates a channel measurement resource set including a set of multiple channel measurement resources each indexed according to at least a set of multiple first indices associated with a first dimension and a set of multiple second indices associated with a second dimension different than the first dimension, where, for each channel measurement resource of the set of multiple channel measurement resources, a respective first index of the set of multiple first indices may indicate respective first dimensional information associated with the channel measurement resource in the first dimension and a respective second index of the set of multiple second indices may indicate respective second dimensional information associated with the channel measurement resource in the second dimension, at least one of the respective first dimensional information and the respective second dimensional information indicating a direction of a transmit beam within one or more spatial dimensions associated with the channel measurement resource. The operations of 1615 may be performed in accordance with examples as disclosed herein. In some examples, aspects of the operations of 1615 may be performed by a resource set processing component 1025 as described with reference to FIG. 10.

At 1620, the method may include selecting a receive beam to receive a reference signal transmitted on at least one of the set of multiple channel measurement resources, selection of the receive beam based on the respective first dimensional information and the respective second dimensional information associated with at least one of the set of multiple channel measurement resources. The operations of 1620 may be performed in accordance with examples as disclosed herein. In some examples, aspects of the operations of 1620 may be performed by a receive beam selection component 1030 as described with reference to FIG. 10.

At 1625, the method may include receiving the reference signal using the receive beam. The operations of 1625 may be performed in accordance with examples as disclosed herein. In some examples, aspects of the operations of 1625 may be performed by a reference signal processing component 1035 as described with reference to FIG. 10.

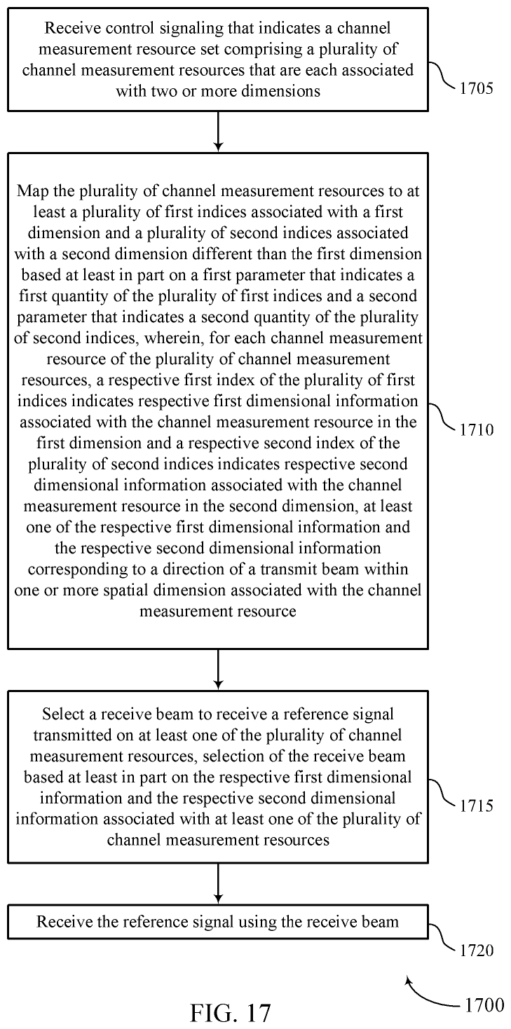

FIG. 17 shows a flowchart illustrating a method 1700 that supports multi-dimensional channel measurement resource configuration in accordance with one or more aspects of the present disclosure. The operations of the method 1700 may be implemented by a network entity or a UE or its components as described herein. For example, the operations of the method 1700 may be performed by a network entity or a UE 115 as described with reference to FIGS. 1 through 12. In some examples, a network entity or a UE may execute a set of instructions to control the functional elements of the network entity or the UE to perform the described functions. Additionally, or alternatively, the network entity or the UE may perform aspects of the described functions using special-purpose hardware.

At 1705, the method may include receiving control signaling that indicates a channel measurement resource set including a set of multiple channel measurement resources that are each associated with two or more dimensions. The operations of 1705 may be performed in accordance with examples as disclosed herein. In some examples, aspects of the operations of 1705 may be performed by a resource set processing component 1025 as described with reference to FIG. 10.

At 1710, the method may include mapping the set of multiple channel measurement resources to at least a set of multiple first indices associated with a first dimension and a set of multiple second indices associated with a second dimension different than the first dimension based on a first parameter that indicates a first quantity of the set of multiple first indices and a second parameter that indicates a second quantity of the set of multiple second indices, where, for each channel measurement resource of the set of multiple channel measurement resources, a respective first index of the set of multiple first indices may indicate respective first dimensional information associated with the channel measurement resource in the first dimension and a respective second index of the set of multiple second indices may indicate respective second dimensional information associated with the channel measurement resource in the second dimension, at least one of the respective first dimensional information and the respective second dimensional information corresponding to a direction of a transmit beam within one or more spatial dimension associated with the channel measurement resource. The operations of 1710 may be performed in accordance with examples as disclosed herein. In some examples, aspects of the operations of 1710 may be performed by a resource mapping component 1040 as described with reference to FIG. 10.

At 1715, the method may include selecting a receive beam to receive a reference signal transmitted on at least one of the set of multiple channel measurement resources, selection of the receive beam based on the respective first dimensional information and the respective second dimensional information associated with at least one of the set of multiple channel measurement resources. The operations of 1715 may be performed in accordance with examples as disclosed herein. In some examples, aspects of the operations of 1715 may be performed by a receive beam selection component 1030 as described with reference to FIG. 10.

At 1720, the method may include receiving the reference signal using the receive beam. The operations of 1720 may be performed in accordance with examples as disclosed herein. In some examples, aspects of the operations of 1720 may be performed by a reference signal processing component 1035 as described with reference to FIG. 10.

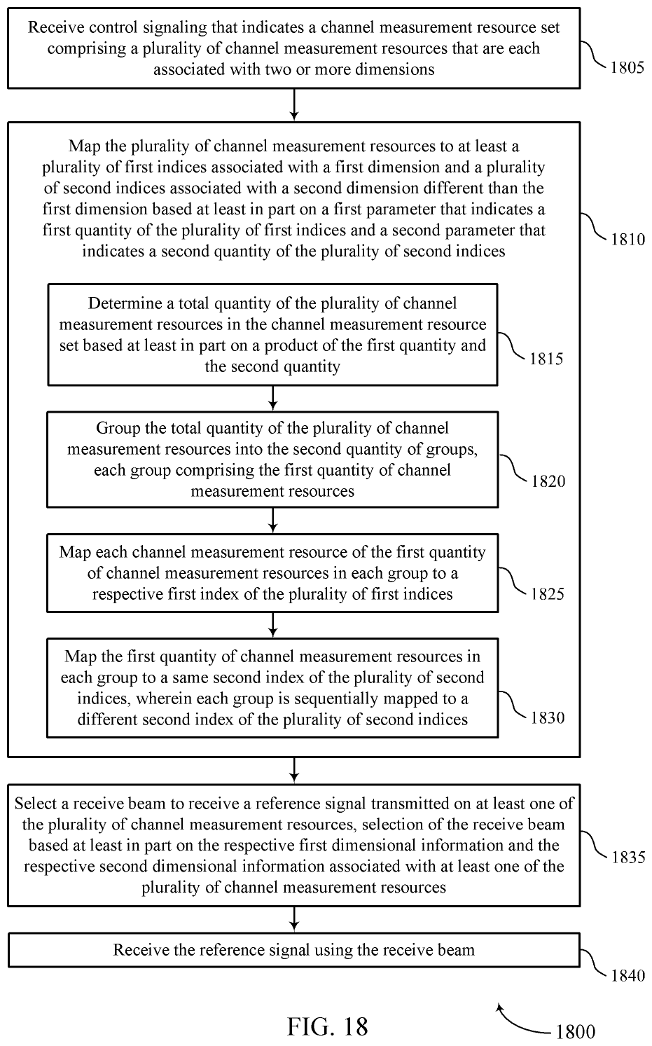

FIG. 18 shows a flowchart illustrating a method 1800 that supports multi-dimensional channel measurement resource configuration in accordance with one or more aspects of the present disclosure. The operations of the method 1800 may be implemented by a network entity or a UE or its components as described herein. For example, the operations of the method 1800 may be performed by a network entity or a UE 115 as described with reference to FIGS. 1 through 12. In some examples, a network entity or a UE may execute a set of instructions to control the functional elements of the network entity or the UE to perform the described functions. Additionally, or alternatively, the network entity or the UE may perform aspects of the described functions using special-purpose hardware.

At 1805, the method may include receiving control signaling that indicates a channel measurement resource set including a set of multiple channel measurement resources that are each associated with two or more dimensions. The operations of 1805 may be performed in accordance with examples as disclosed herein. In some examples, aspects of the operations of 1805 may be performed by a resource set processing component 1025 as described with reference to FIG. 10.

At 1810, mapping the set of multiple channel measurement resources to at least a set of multiple first indices associated with a first dimension and a set of multiple second indices associated with a second dimension different than the first dimension based on a first parameter that indicates a first quantity of the set of multiple first indices and a second parameter that indicates a second quantity of the set of multiple second indices, where, for each channel measurement resource of the set of multiple channel measurement resources, a respective first index of the set of multiple first indices may indicate respective first dimensional information associated with the channel measurement resource in the first dimension and a respective second index of the set of multiple second indices may indicate respective second dimensional information associated with the channel measurement resource in the second dimension, at least one of the respective first dimensional information and the respective second dimensional information corresponding to a direction of a transmit beam within one or more spatial dimension associated with the channel measurement resource. The operations of 1810 may be performed in accordance with examples as disclosed herein. In some examples, aspects of the operations of 1810 may be performed by a resource mapping component 1040 as described with reference to FIG. 10.

At 1815, the mapping may include determining a total quantity of the set of multiple channel measurement resources in the channel measurement resource set based on a product of the first quantity and the second quantity. The operations of 1815 may be performed in accordance with examples as disclosed herein. In some examples, aspects of the operations of 1815 may be performed by a resource mapping component 1040 as described with reference to FIG. 10.

At 1820, the mapping may include grouping the total quantity of the set of multiple channel measurement resources into the second quantity of groups, each group including the first quantity of channel measurement resources. The operations of 1820 may be performed in accordance with examples as disclosed herein. In some examples, aspects of the operations of 1820 may be performed by a resource mapping component 1040 as described with reference to FIG. 10.

At 1825, the mapping may include mapping each channel measurement resource of the first quantity of channel measurement resources in each group to a respective first index of the set of multiple first indices. The operations of 1825 may be performed in accordance with examples as disclosed herein. In some examples, aspects of the operations of 1825 may be performed by a resource mapping component 1040 as described with reference to FIG. 10.

At 1830, the mapping may include mapping the first quantity of channel measurement resources in each group to a same second index of the set of multiple second indices, where each group is sequentially mapped to a different second index of the set of multiple second indices. The operations of 1830 may be performed in accordance with examples as disclosed herein. In some examples, aspects of the operations of 1830 may be performed by a resource mapping component 1040 as described with reference to FIG. 10.

At 1835, the method may include selecting a receive beam to receive a reference signal transmitted on at least one of the set of multiple channel measurement resources, selection of the receive beam based on the respective first dimensional information and the respective second dimensional information associated with at least one of the set of multiple channel measurement resources. The operations of 1835 may be performed in accordance with examples as disclosed herein. In some examples, aspects of the operations of 1835 may be performed by a receive beam selection component 1030 as described with reference to FIG. 10.

At 1840, the method may include receiving the reference signal using the receive beam. The operations of 1840 may be performed in accordance with examples as disclosed herein. In some examples, aspects of the operations of 1840 may be performed by a reference signal processing component 1035 as described with reference to FIG. 10.

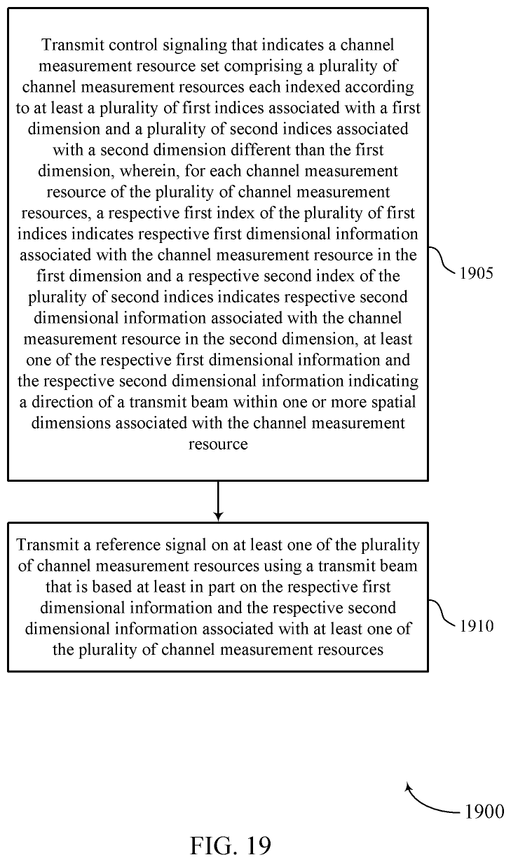

FIG. 19 shows a flowchart illustrating a method 1900 that supports multi-dimensional channel measurement resource configuration in accordance with one or more aspects of the present disclosure. The operations of the method 1900 may be implemented by a network entity or a UE or its components as described herein. For example, the operations of the method 1900 may be performed by a network entity or a UE 115 as described with reference to FIGS. 1 through 12. In some examples, a network entity or a UE may execute a set of instructions to control the functional elements of the network entity or the UE to perform the described functions. Additionally, or alternatively, the network entity or the UE may perform aspects of the described functions using special-purpose hardware.

At 1905, the method may include transmitting control signaling that indicates a channel measurement resource set including a set of multiple channel measurement resources each indexed according to at least a set of multiple first indices associated with a first dimension and a set of multiple second indices associated with a second dimension different than the first dimension, where, for each channel measurement resource of the set of multiple channel measurement resources, a respective first index of the set of multiple first indices may indicate respective first dimensional information associated with the channel measurement resource in the first dimension and a respective second index of the set of multiple second indices may indicate respective second dimensional information associated with the channel measurement resource in the second dimension, at least one of the respective first dimensional information and the respective second dimensional information indicating a direction of a transmit beam within one or more spatial dimensions associated with the channel measurement resource. The operations of 1905 may be performed in accordance with examples as disclosed herein. In some examples, aspects of the operations of 1905 may be performed by a resource set processing component 1025 as described with reference to FIG. 10.

At 1910, the method may include transmitting a reference signal on at least one of the set of multiple channel measurement resources using a transmit beam that is based on the respective first dimensional information and the respective second dimensional information associated with at least one of the set of multiple channel measurement resources. The operations of 1910 may be performed in accordance with examples as disclosed herein. In some examples, aspects of the operations of 1910 may be performed by a reference signal generation component 1045 as described with reference to FIG. 10.

The following provides an overview of aspects of the present disclosure:

Aspect 1: A method for wireless communications at a first network entity comprising: receiving control signaling that indicates a channel measurement resource set comprising a plurality of channel measurement resources each indexed according to at least a plurality of first indices associated with a first dimension and a plurality of second indices associated with a second dimension different than the first dimension, wherein, for each channel measurement resource of the plurality of channel measurement resources, a respective first index of the plurality of first indices indicates respective first dimensional information associated with the channel measurement resource in the first dimension and a respective second index of the plurality of second indices indicates respective second dimensional information associated with the channel measurement resource in the second dimension, at least one of the respective first dimensional information and the respective second dimensional information indicating a direction of a transmit beam within one or more spatial dimensions associated with the channel measurement resource; selecting a receive beam to receive a reference signal transmitted on at least one of the plurality of channel measurement resources, selection of the receive beam based at least in part on the respective first dimensional information and the respective second dimensional information associated with at least one of the plurality of channel measurement resources; and receiving the reference signal using the receive beam.

Aspect 2: The method of aspect 1, further comprising: determining the first dimensional information and the second dimensional information for each of the plurality of channel measurement resources based on an indication of each channel measurement resource in a respective element of the channel measurement resource set, each element of the channel measurement resource set being mapped to a unique combination of a first index of the plurality of first indices and a second index of the plurality of second indices, a total quantity of elements indicated via the channel measurement resource set being based at least in part on a product of a first quantity of the plurality of first indices indicated by the channel measurement resource set and a second quantity of the plurality of second indices indicated by the channel measurement resource set.

Aspect 3: The method of aspect 2, wherein the total quantity of elements indicated via the channel measurement resource set includes a first subset of elements that includes respective indications for the plurality of channel measurement resources and a second subset of elements that are null.

Aspect 4: The method of aspect 1, wherein receiving the control signaling further comprises: receiving, via the control signaling, a plurality of channel measurement resource IDs in a first order, each channel measurement resource ID associated with a respective channel measurement resource of the plurality of channel measurement resources, wherein the channel measurement resource set maps each channel measurement resource ID of the plurality of channel measurement resource IDs to a unique pair of a first index of the plurality of first indices in the first dimension and a second index of the plurality of second indices in the second dimension.

Aspect 5: The method of aspect 4, wherein: the channel measurement resource set maps the plurality of channel measurement resource IDs to the plurality of first indices in a second order different than the first order; and the second order is based at least in part on an ascending or a descending order of values of the plurality of channel measurement resource IDs.

Aspect 6: The method of any of aspects 1 through 5, further comprising: receiving an RRC signal that indicates a first threshold quantity and a second threshold quantity, wherein a first quantity of the plurality of first indices is less than or equal to the first threshold quantity and a second quantity of the plurality of second indices is less than or equal to the second threshold quantity.

Aspect 7: The method of any of aspects 1 through 5, further comprising: determining a first threshold quantity and a second threshold quantity based at least in part on the channel measurement resource set, wherein a first quantity of the plurality of first indices is less than or equal to the first threshold quantity and a second quantity of the plurality of second indices is less than or equal to the second threshold quantity.

Aspect 8: The method of any of aspects 1 through 7, wherein the channel measurement resource is mapped to a same first index in the first dimension as a second channel measurement resource of the plurality of channel measurement resources, the method further comprising: determining that the respective first dimensional information in the first dimension is applicable to both the channel measurement resource and the second channel measurement resource based at least in part on the channel measurement resource and the second channel measurement resource being mapped to the same first index.

Aspect 9: The method of any of aspects 1 through 8, wherein the channel measurement resource is mapped to a different first index in the first dimension than a second channel measurement resource of the plurality of channel measurement resources, the method further comprising: determining that the respective first dimensional information in the first dimension is applicable to the channel measurement resource; and determining that different first dimensional information in the first dimension is applicable to a second channel measurement resource based at least in part on the channel measurement resource being mapped to the different first index than the second channel measurement resource in the first dimension.

Aspect 10: The method of any of aspects 1 through 9, further comprising: receiving system information that indicates a multi-dimensional channel measurement resource configuration; and transmitting a message that indicates a capability of the first network entity to support the multi-dimensional channel measurement resource configuration based at least in part on the system information, wherein receiving the control signaling that indicates the channel measurement resource set is based at least in part on the capability of the first network entity.

Aspect 11: The method of any of aspects 1 through 9, further comprising: establishing a connection via a serving cell associated with a multi-dimensional channel measurement resource configuration; and transmitting a message that indicates a capability of the first network entity to support the multi-dimensional channel measurement resource configuration based at least in part on establishing the connection via the serving cell, wherein receiving the control signaling that indicates the channel measurement resource set is based at least in part on the capability of the first network entity.

Aspect 12: The method of any of aspects 1 through 11, wherein the respective first dimensional information and the respective second dimensional information each comprise one of a relative direction of a beam in an azimuthal dimension, a relative direction of a beam in an elevational dimension, a relative distance associated with the channel measurement resource, or a relative timing of the channel measurement resource in a time dimension.

Aspect 13: The method of any of aspects 1 through 12, wherein the plurality of channel measurement resources comprises SSB resources, CSI-RS resources, or both.

Aspect 14: The method of any of aspects 1 through 13, wherein receiving the control signaling comprises: receiving RRC signaling, wherein an IE of the RRC signaling indicates the channel measurement resource set.

Aspect 15: A method for wireless communications at a first network entity comprising: receiving control signaling that indicates a channel measurement resource set comprising a plurality of channel measurement resources that are each associated with two or more dimensions; mapping the plurality of channel measurement resources to at least a plurality of first indices associated with a first dimension and a plurality of second indices associated with a second dimension different than the first dimension based at least in part on a first parameter that indicates a first quantity of the plurality of first indices and a second parameter that indicates a second quantity of the plurality of second indices, wherein, for each channel measurement resource of the plurality of channel measurement resources, a respective first index of the plurality of first indices indicates respective first dimensional information associated with the channel measurement resource in the first dimension and a respective second index of the plurality of second indices indicates respective second dimensional information associated with the channel measurement resource in the second dimension, at least one of the respective first dimensional information and the respective second dimensional information corresponding to a direction of a transmit beam within one or more spatial dimension associated with the channel measurement resource; selecting a receive beam to receive a reference signal transmitted on at least one of the plurality of channel measurement resources, selection of the receive beam based at least in part on the respective first dimensional information and the respective second dimensional information associated with at least one of the plurality of channel measurement resources; and receiving the reference signal using the receive beam.

Aspect 16: The method of aspect 15, wherein receiving the control signaling comprises: receiving, via the control signaling, an indication of the first parameter and the second parameter.

Aspect 17: The method of aspect 15, further comprising: determining the first parameter and the second parameter based at least in part on the channel measurement resource set.

Aspect 18: The method of any of aspects 15 through 17, further comprising: determining a total quantity of the plurality of channel measurement resources in the channel measurement resource set based at least in part on a product of the first quantity and the second quantity.

Aspect 19: The method of aspect 18, wherein the mapping comprises: grouping the total quantity of the plurality of channel measurement resources into the second quantity of groups, each group comprising the first quantity of channel measurement resources; mapping each channel measurement resource of the first quantity of channel measurement resources in each group to a respective first index of the plurality of first indices; and mapping the first quantity of channel measurement resources in each group to a same second index of the plurality of second indices, wherein each group is sequentially mapped to a different second index of the plurality of second indices.

Aspect 20: The method of any of aspects 15 through 19, wherein the channel measurement resource set indicates a plurality of channel measurement resource IDs associated with the plurality of channel measurement resources in a first order, the method further comprising: reordering the plurality of channel measurement resource IDs from the first order to a second order, the second order based at least in part on an ascending or a descending order of values of the plurality of channel measurement resource IDs, wherein the mapping is based at least in part on the second order of the plurality of channel measurement resource IDs.

Aspect 21: The method of any of aspects 15 through 20, wherein the channel measurement resource is mapped to a same first index in the first dimension as a second channel measurement resource of the plurality of channel measurement resources, the method further comprising: determining that the respective first dimensional information in the first dimension is applicable to both the channel measurement resource and the second channel measurement resource based at least in part on the channel measurement resource and the second channel measurement resource being mapped to the same first index.

Aspect 22: The method of any of aspects 15 through 21, wherein the channel measurement resource is mapped to a different first index in the first dimension than a second channel measurement resource of the plurality of channel measurement resources, the method further comprising: determining that the respective first dimensional information in the first dimension is applicable to the channel measurement resource; and determining that different first dimensional information in the first dimension is applicable to a second channel measurement resource based at least in part on the channel measurement resource being mapped to the different first index than the second channel measurement resource in the first dimension.

Aspect 23: The method of any of aspects 15 through 22, further comprising: receiving system information that indicates a multi-dimensional channel measurement resource configuration; and transmitting a message that indicates a capability of the first network entity to support the multi-dimensional channel measurement resource configuration based at least in part on the system information, wherein receiving the control signaling that indicates the channel measurement resource set is based at least in part on the capability of the first network entity.

Aspect 24: The method of any of aspects 15 through 22, further comprising: establishing a connection via a serving cell associated with a multi-dimensional channel measurement resource configuration; and transmitting a message that indicates a capability of the first network entity to support the multi-dimensional channel measurement resource configuration based at least in part on establishing the connection via the serving cell, wherein receiving the control signaling that indicates the channel measurement resource set is based at least in part on the capability of the first network entity.

Aspect 25: The method of any of aspects 15 through 24, wherein the respective first dimensional information and the respective second dimensional information each comprise one of a relative direction of a beam in an azimuthal dimension, a relative direction of a beam in an elevational dimension, a relative distance associated with the channel measurement resource, or a relative timing of the channel measurement resource in a time dimension.

Aspect 26: A method for wireless communications at a second network entity, comprising: transmitting control signaling that indicates a channel measurement resource set comprising a plurality of channel measurement resources each indexed according to at least a plurality of first indices associated with a first dimension and a plurality of second indices associated with a second dimension different than the first dimension, wherein, for each channel measurement resource of the plurality of channel measurement resources, a respective first index of the plurality of first indices indicates respective first dimensional information associated with the channel measurement resource in the first dimension and a respective second index of the plurality of second indices indicates respective second dimensional information associated with the channel measurement resource in the second dimension, at least one of the respective first dimensional information and the respective second dimensional information indicating a direction of a transmit beam within one or more spatial dimensions associated with the channel measurement resource; and transmitting a reference signal on at least one of the plurality of channel measurement resources using a transmit beam that is based at least in part on the respective first dimensional information and the respective second dimensional information associated with at least one of the plurality of channel measurement resources.

Aspect 27: The method of aspect 26, wherein: a total quantity of entries indicated via the channel measurement resource set is based at least in part on product of a first quantity of the plurality of first indices indicated by the channel measurement resource set and a second quantity of the plurality of second indices indicated by the channel measurement resource set; a subset of elements of the total quantity of elements of the channel measurement resource set each comprise an indication of a respective channel measurement resource ID associated with a respective channel measurement resource of the plurality of channel measurement resources; remaining elements of the total quantity of elements of the channel measurement resource set are null; and each element of the channel measurement resource set is mapped to a unique combination of a first index of the plurality of first indices and a second index of the plurality of second indices.

Aspect 28: The method of any of aspects 26 through 27, wherein transmitting the control signaling further comprises: transmitting, via the control signaling, a plurality of channel measurement resource IDs in a first order, each channel measurement resource ID associated with a respective channel measurement resource of the plurality of channel measurement resources, wherein the channel measurement resource set maps each channel measurement resource ID of the plurality of channel measurement resource IDs to a unique pair of a first index of the plurality of first indices in the first dimension and a second index of the plurality of second indices in the second dimension.

Aspect 29: An apparatus comprising a processor; memory coupled with the processor; and instructions stored in the memory and executable by the processor to cause the apparatus to perform a method of any of aspects 1 through 14.

Aspect 30: An apparatus comprising at least one means for performing a method of any of aspects 1 through 14.

Aspect 31: A non-transitory computer-readable medium storing code the code comprising instructions executable by a processor to perform a method of any of aspects 1 through 14.

Aspect 32: An apparatus comprising a processor; memory coupled with the processor; and instructions stored in the memory and executable by the processor to cause the apparatus to perform a method of any of aspects 15 through 25.

Aspect 33: An apparatus comprising at least one means for performing a method of any of aspects 15 through 25.

Aspect 34: A non-transitory computer-readable medium storing code the code comprising instructions executable by a processor to perform a method of any of aspects 15 through 25.

Aspect 35: An apparatus for wireless communications at a second network entity, comprising a processor; memory coupled with the processor; and instructions stored in the memory and executable by the processor to cause the apparatus to perform a method of any of aspects 26 through 28.

Aspect 36: An apparatus for wireless communications at a second network entity, comprising at least one means for performing a method of any of aspects 26 through 28.

Aspect 37: A non-transitory computer-readable medium storing code for wireless communications at a second network entity, the code comprising instructions executable by a processor to perform a method of any of aspects 26 through 28.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, obtaining, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communications at a first network entity comprising:
receiving control signaling that indicates a channel measurement resource set comprising a plurality of channel measurement resources each indexed according to at least a plurality of first indices associated with a first dimension and a plurality of second indices associated with a second dimension different than the first dimension, wherein, for each channel measurement resource of the plurality of channel measurement resources, a respective first index of the plurality of first indices indicates respective first dimensional information associated with the channel measurement resource in the first dimension and a respective second index of the plurality of second indices indicates respective second dimensional information associated with the channel measurement resource in the second dimension, at least one of the respective first dimensional information and the respective second dimensional information indicating a direction of a transmit beam within one or more spatial dimensions associated with the channel measurement resource;
selecting a receive beam to receive a reference signal transmitted on at least one of the plurality of channel measurement resources, selection of the receive beam based at least in part on the respective first dimensional information and the respective second dimensional information associated with at least one of the plurality of channel measurement resources; and
receiving the reference signal using the receive beam.

2. The method of claim 1, further comprising:
determining the first dimensional information and the second dimensional information for each of the plurality of channel measurement resources based on an indication of each channel measurement resource in a respective element of the channel measurement resource set, each element of the channel measurement resource set being mapped to a unique combination of a first index of the plurality of first indices and a second index of the plurality of second indices, a total quantity of elements indicated via the channel measurement resource set being based at least in part on a product of a first quantity of the plurality of first indices indicated by the channel measurement resource set and a second quantity of the plurality of second indices indicated by the channel measurement resource set.

3. The method of claim 2, wherein the total quantity of elements indicated via the channel measurement resource set includes a first subset of elements that includes respective indications for the plurality of channel measurement resources and a second subset of elements that are null.

4. The method of claim 1, wherein receiving the control signaling further comprises:
receiving, via the control signaling, a plurality of channel measurement resource identifiers in a first order, each channel measurement resource identifier associated with a respective channel measurement resource of the plurality of channel measurement resources, wherein the channel measurement resource set maps each channel measurement resource identifier of the plurality of channel measurement resource identifiers to a unique pair of a first index of the plurality of first indices in the first dimension and a second index of the plurality of second indices in the second dimension.

5. The method of claim 4, wherein:
the channel measurement resource set maps the plurality of channel measurement resource identifiers to the plurality of first indices in a second order different than the first order; and
the second order is based at least in part on an ascending or a descending order of values of the plurality of channel measurement resource identifiers.

6. The method of claim 1, further comprising:
receiving a radio resource control signal that indicates a first threshold quantity and a second threshold quantity, wherein a first quantity of the plurality of first indices is less than or equal to the first threshold quantity and a second quantity of the plurality of second indices is less than or equal to the second threshold quantity.

7. The method of claim 1, further comprising:
determining a first threshold quantity and a second threshold quantity based at least in part on the channel measurement resource set, wherein a first quantity of the plurality of first indices is less than or equal to the first threshold quantity and a second quantity of the plurality of second indices is less than or equal to the second threshold quantity.

8. The method of claim 1, wherein the channel measurement resource is mapped to a same first index in the first dimension as a second channel measurement resource of the plurality of channel measurement resources, the method further comprising:
determining that the respective first dimensional information in the first dimension is applicable to both the channel measurement resource and the second channel measurement resource based at least in part on the channel measurement resource and the second channel measurement resource being mapped to the same first index.

9. The method of claim 1, wherein the channel measurement resource is mapped to a different first index in the first dimension than a second channel measurement resource of the plurality of channel measurement resources, the method further comprising:
determining that the respective first dimensional information in the first dimension is applicable to the channel measurement resource; and
determining that different first dimensional information in the first dimension is applicable to a second channel measurement resource based at least in part on the channel measurement resource being mapped to the different first index than the second channel measurement resource in the first dimension.

10. The method of claim 1, further comprising:
receiving system information that indicates a multi-dimensional channel measurement resource configuration; and
transmitting a message that indicates a capability of the first network entity to support the multi-dimensional channel measurement resource configuration based at least in part on the system information, wherein receiving the control signaling that indicates the channel measurement resource set is based at least in part on the capability of the first network entity.

11. The method of claim 1, further comprising:
establishing a connection via a serving cell associated with a multi-dimensional channel measurement resource configuration; and
transmitting a message that indicates a capability of the first network entity to support the multi-dimensional channel measurement resource configuration based at least in part on establishing the connection via the serving cell, wherein receiving the control signaling that indicates the channel measurement resource set is based at least in part on the capability of the first network entity.

12. The method of claim 1, wherein the respective first dimensional information and the respective second dimensional information each comprise one of a relative direction of a beam in an azimuthal dimension, a relative direction of a beam in an elevational dimension, a relative distance associated with the channel measurement resource, or a relative timing of the channel measurement resource in a time dimension.

13. The method of claim 1, wherein the plurality of channel measurement resources comprises synchronization signal block resources, channel state information reference signal resources, or both.

14. The method of claim 1, wherein receiving the control signaling comprises:
receiving radio resource control signaling, wherein an information element of the radio resource control signaling indicates the channel measurement resource set.

15. A method for wireless communications at a first network entity comprising:
receiving control signaling that indicates a channel measurement resource set comprising a plurality of channel measurement resources that are each associated with two or more dimensions;
mapping the plurality of channel measurement resources to at least a plurality of first indices associated with a first dimension and a plurality of second indices associated with a second dimension different than the first dimension based at least in part on a first parameter that indicates a first quantity of the plurality of first indices and a second parameter that indicates a second quantity of the plurality of second indices, wherein, for each channel measurement resource of the plurality of channel measurement resources, a respective first index of the plurality of first indices indicates respective first dimensional information associated with the channel measurement resource in the first dimension and a respective second index of the plurality of second indices indicates respective second dimensional information associated with the channel measurement resource in the second dimension, at least one of the respective first dimensional information and the respective second dimensional information corresponding to a direction of a transmit beam within one or more spatial dimension associated with the channel measurement resource;
selecting a receive beam to receive a reference signal transmitted on at least one of the plurality of channel measurement resources, selection of the receive beam based at least in part on the respective first dimensional information and the respective second dimensional information associated with at least one of the plurality of channel measurement resources; and
receiving the reference signal using the receive beam.

16. The method of claim 15, wherein receiving the control signaling comprises:
receiving, via the control signaling, an indication of the first parameter and the second parameter.

17. The method of claim 15, further comprising:
determining the first parameter and the second parameter based at least in part on the channel measurement resource set.

18. The method of claim 15, further comprising:
determining a total quantity of the plurality of channel measurement resources in the channel measurement resource set based at least in part on a product of the first quantity and the second quantity.

19. The method of claim 18, wherein the mapping comprises:
grouping the total quantity of the plurality of channel measurement resources into the second quantity of groups, each group comprising the first quantity of channel measurement resources;
mapping each channel measurement resource of the first quantity of channel measurement resources in each group to a respective first index of the plurality of first indices; and
mapping the first quantity of channel measurement resources in each group to a same second index of the plurality of second indices, wherein each group is sequentially mapped to a different second index of the plurality of second indices.

20. The method of claim 15, wherein the channel measurement resource set indicates a plurality of channel measurement resource identifiers associated with the plurality of channel measurement resources in a first order, the method further comprising:
reordering the plurality of channel measurement resource identifiers from the first order to a second order, the second order based at least in part on an ascending or a descending order of values of the plurality of channel measurement resource identifiers, wherein the mapping is based at least in part on the second order of the plurality of channel measurement resource identifiers.

21. The method of claim 15, wherein the channel measurement resource is mapped to a same first index in the first dimension as a second channel measurement resource of the plurality of channel measurement resources, the method further comprising:
determining that the respective first dimensional information in the first dimension is applicable to both the channel measurement resource and the second channel measurement resource based at least in part on the channel measurement resource and the second channel measurement resource being mapped to the same first index.

22. The method of claim 15, wherein the channel measurement resource is mapped to a different first index in the first dimension than a second channel measurement resource of the plurality of channel measurement resources, the method further comprising:
determining that the respective first dimensional information in the first dimension is applicable to the channel measurement resource; and
determining that different first dimensional information in the first dimension is applicable to a second channel measurement resource based at least in part on the channel measurement resource being mapped to the different first index than the second channel measurement resource in the first dimension.

23. The method of claim 15, further comprising:
receiving system information that indicates a multi-dimensional channel measurement resource configuration; and
transmitting a message that indicates a capability of the first network entity to support the multi-dimensional channel measurement resource configuration based at least in part on the system information, wherein receiving the control signaling that indicates the channel measurement resource set is based at least in part on the capability of the first network entity.

24. The method of claim 15, further comprising:
establishing a connection via a serving cell associated with a multi-dimensional channel measurement resource configuration; and
transmitting a message that indicates a capability of the first network entity to support the multi-dimensional channel measurement resource configuration based at least in part on establishing the connection via the serving cell, wherein receiving the control signaling that indicates the channel measurement resource set is based at least in part on the capability of the first network entity.

25. The method of claim 15, wherein the respective first dimensional information and the respective second dimensional information each comprise one of a relative direction of a beam in an azimuthal dimension, a relative direction of a beam in an elevational dimension, a relative distance associated with the channel measurement resource, or a relative timing of the channel measurement resource in a time dimension.

26. A method for wireless communications at a second network entity, comprising:
transmitting control signaling that indicates a channel measurement resource set comprising a plurality of channel measurement resources each indexed according to at least a plurality of first indices associated with a first dimension and a plurality of second indices associated with a second dimension different than the first dimension, wherein, for each channel measurement resource of the plurality of channel measurement resources, a respective first index of the plurality of first indices indicates respective first dimensional information associated with the channel measurement resource in the first dimension and a respective second index of the plurality of second indices indicates respective second dimensional information associated with the channel measurement resource in the second dimension, at least one of the respective first dimensional information and the respective second dimensional information indicating a direction of a transmit beam within one or more spatial dimensions associated with the channel measurement resource; and
transmitting a reference signal on at least one of the plurality of channel measurement resources using a transmit beam that is based at least in part on the respective first dimensional information and the respective second dimensional information associated with at least one of the plurality of channel measurement resources.

27. The method of claim 26, wherein:
a total quantity of entries indicated via the channel measurement resource set is based at least in part on product of a first quantity of the plurality of first indices indicated by the channel measurement resource set and a second quantity of the plurality of second indices indicated by the channel measurement resource set;
a subset of elements of the total quantity of elements of the channel measurement resource set each comprise an indication of a respective channel measurement resource identifier associated with a respective channel measurement resource of the plurality of channel measurement resources;
remaining elements of the total quantity of elements of the channel measurement resource set are null; and
each element of the channel measurement resource set is mapped to a unique combination of a first index of the plurality of first indices and a second index of the plurality of second indices.

28. The method of claim 26, wherein transmitting the control signaling further comprises:
transmitting, via the control signaling, a plurality of channel measurement resource identifiers in a first order, each channel measurement resource identifier associated with a respective channel measurement resource of the plurality of channel measurement resources, wherein the channel measurement resource set maps each channel measurement resource identifier of the plurality of channel measurement resource identifiers to a unique pair of a first index of the plurality of first indices in the first dimension and a second index of the plurality of second indices in the second dimension.

29. An apparatus, comprising:
a processor;
memory coupled with the processor; and
instructions stored in the memory and executable by the processor to cause the apparatus to:
receive control signaling that indicates a channel measurement resource set comprising a plurality of channel measurement resources each indexed according to at least a plurality of first indices associated with a first dimension and a plurality of second indices associated with a second dimension different than the first dimension, wherein, for each channel measurement resource of the plurality of channel measurement resources, a respective first index of the plurality of first indices indicates respective first dimensional information associated with the channel measurement resource in the first dimension and a respective second index of the plurality of second indices indicates respective second dimensional information associated with the channel measurement resource in the second dimension, at least one of the respective first dimensional information and the respective second dimensional information indicating a direction of a transmit beam within one or more spatial dimensions associated with the channel measurement resource;
select a receive beam to receive a reference signal transmitted on at least one of the plurality of channel measurement resources, selection of the receive beam based at least in part on the respective first dimensional information and the respective second dimensional information associated with at least one of the plurality of channel measurement resources; and
receive the reference signal using the receive beam.

30. The apparatus of claim 29, wherein the instructions are further executable by the processor to cause the apparatus to:
determine the first dimensional information and the second dimensional information for each of the plurality of channel measurement resources based on an indication of each channel measurement resource in a respective element of the channel measurement resource set, each element of the channel measurement resource set being mapped to a unique combination of a first index of the plurality of first indices and a second index of the plurality of second indices, a total quantity of elements indicated via the channel measurement resource set being based at least in part on a product of a first quantity of the plurality of first indices indicated by the channel measurement resource set and a second quantity of the plurality of second indices indicated by the channel measurement resource set.
